(19) United States
(12) Patent Application Publication
(10) Pub. No.: US 2019/0056745 A1
(43) Pub. Date: Feb. 21, 2019

(54) ELECTRIC CONVENIENCE VEHICLE (ECV) WITH CONTROL AND COMMUNICATIONS UNIT

(71) Applicants: Christopher T. Meehan, Palm Coast, FL (US); Marc M. Barber, Deltona, FL (US); Kurt D. Ring, Andover, MA (US); Colt Wright Fletcher, Orlando, FL (US); John Thomas Zaniker, Severna Park, MD (US); Eben Lewis, Oviedo, FL (US); Tomas Rodriguez, Winter Park, FL (US); Dana Ilijevski Ogden, Casselberry, FL (US); Wesley Edward Swogger, Fairfax Station, VA (US); Hal Gunner, Lake Mary, FL (US)

(72) Inventors: Christopher T. Meehan, Palm Coast, FL (US); Marc M. Barber, Deltona, FL (US); Kurt D. Ring, Andover, MA (US); Colt Wright Fletcher, Orlando, FL (US); John Thomas Zaniker, Severna Park, MD (US); Eben Lewis, Oviedo, FL (US); Tomas Rodriguez, Winter Park, FL (US); Dana Ilijevski Ogden, Casselberry, FL (US); Wesley Edward Swogger, Fairfax Station, VA (US); Hal Gunner, Lake Mary, FL (US)

(21) Appl. No.: 15/680,054

(22) Filed: Aug. 17, 2017

Related U.S. Application Data
(60) Provisional application No. 62/546,474, filed on Aug. 16, 2017.

(51) Int. Cl. G05D 1/02; B62K 5/01; B62K 5/08; B60K 28/04; B60L 8/00; B60L 11/18; B60K 31/00

(52) U.S. Cl. CPC G05D 1/0234; B62K 5/01; B62K 5/08; B60K 35/00; B60L 8/003; B60L 11/1851; B60K 31/0008; B60K 28/04

(57) ABSTRACT

One embodiment of an electronics convenience vehicle (ECV) may include a frame, a plurality of wheels configured to support and move the frame, a seat supported by said frame, a steering mechanism disposed toward a front portion of the ECV, a motor configured to cause at least one wheel to be propelled forward, propelled backward, or to remain in a fixed position, a throttle, when activated in a first position, causes said motor to propel said at least one wheel in a forward direction, when activated in a second position, causes said motor to propel said at least one wheel in a reverse direction, at least one sensor directed to detect objects in front of a direction of travel of the ECV, and a control and communications unit (CCU) disposed in front of said seat, and configured to receive said sense signals and to control operations of said motor.

### RELATED APPLICATIONS

This Application claims benefit of U.S. Provisional Application Ser. No. 62/546,474, filed Aug. 16, 2017, entitled ELECTRONIC CONVENIENCE VEHICLE (ECV) WITH CONTROL AND COMMUNICATIONS UNIT, the contents of which are hereby incorporated by reference in their entirety.

### FIELD OF THE INVENTION

The present invention relates to electronic convenience vehicles and more specifically, to electronic convenience vehicles including a user interface.

### BACKGROUND

Theme parks and other public venues, such as sports and concert venues, zoos, and other public and private venues have long been enjoyed by crowds of all ages. Other types of facilities, such as airports, hospitals, malls, retail stores, and so forth, have similar types of crowds. As understood by venues, crowds have a certain percentage of individuals who need assistance with walking due to injury, illness, age, or otherwise, and generally referred to as handicapped individuals

As has become both public policy and good business, venues provide for powered vehicles, generally referred to as electronic convenience vehicles (ECVs), that are self-propelled to enable handicapped individuals who have physical handicaps that prevent or limit walking to participate at the venue. Existing ECVs include electric powered scooters on which a handicapped individual may drive throughout the day to access different parts of a venue. Conventional ECVs are relatively simplistic, and typically include a chair mounted on a frame with wheels and a steering mechanism. A motor on the ECV is controlled to propel the ECV forward or backward by the use of a throttle, generally located on handles of the steering mechanism.

The ECVs, depending on the venue, may be rented to visitors by the facility or a third-party provider. Other facilities allow for a user to borrow ECVs while at the venue. While these ECVs are helpful to the handicapped individuals, the venues and ECV owners/operators do not receive commercial benefit during rental periods of the ECVs beyond rental rates by the handicapped individuals. Hence, ECVs that provide additional commercial benefits to the ECV owners/operators, while increasing functionality and experience to the users of the ECVs, are needed.

### SUMMARY

An electronic convenience vehicle (ECV) that improves an experience at a venue for users and improves commercial value for a venue and operator of the ECV may include a control and command unit (CCU) that improves safety for pedestrians around the ECV, reduced liability and risk of injury for users, and provides functionality that heretofore does not exist on ECVs. The functionality ranges from venue mapping and directions, rental and reservation ordering on the ECV, venue messaging between the user and venue, locking and unlocking of a lockbox on the ECV, and so on.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIGS. 1A-1K are illustrations of an illustrative electronic convenience vehicle (ECV) that includes a control and communications unit (CCU), sensors configured to sense objects in front of the ECV, and other features that provide for safety and an improved user experience within a venue;

FIGS. 2A-2D are schematics showing sensors positioned on the ECV used to sense objects in front of and around the ECV and whether or not a user is sitting on the seat;

FIGS. 3A-3F are illustrations of an illustrative ECV with various features highlighted;

FIG. 4 is an illustration of an illustrative seat of the ECV shown in FIG. 3A that identifies a number of features and functions of the seat;

FIGS. 5A-5C are illustrations of an illustrative ECV inclusive of a cover that may be mounted to the seat of FIG. 3A, and used to cover a user from sun and rain, for example, while operating the ECV;

FIGS. 6A-6C are illustrations of an illustrative basket that may be affixed behind the seat of FIG. 3A;

FIGS. 7A-7C are illustrations of an illustrative lockbox that may be affixed behind the seat of FIG. 3A;

FIGS. 8A-8C are illustrations of illustrative fixture members that may be configured to support medical devices, such as an oxygen tank;

FIGS. 9A-9E are illustrations of an illustrative chassis of the ECV shown in FIG. 3B;

FIGS. 10A-10D are illustrations of an illustrative tiller of the ECV shown in FIG. 3C;

FIG. 11 is an illustration of a top portion of the tiller of FIGS. 10A-10D;

FIG. 12 is an illustration of a top portion of the tiller of FIGS. 10A-10D showing an illustrative CCU;

FIGS. 13A-13H are illustrations of the chassis of FIG. 3E used to support the ECV;

FIGS. 14A and 14B are illustrations of an illustrative ECV showing sensing zones from sensors disposed on the ECV;

FIGS. 15A-15C are illustrative sensors disposed on portions of the ECV along with an indicator on the CCU indicating that an object is being sensed by one or more of the sensors;

FIGS. 16A and 16B are illustrations of illustrative cameras disposed on a front portion and a rear portion of the ECV for use in capturing video and/or still images that may be displayed on the CCU;

FIGS. 17A-17I are illustrations of illustrative views of ECVs with various accessories and configurations;

FIG. 18 is an illustration of an illustrative ECV showing a sensor mounted on a tiller of the ECV along with a sensing pattern created by the sensor;

FIG. 19 is an illustration of an illustrative ECV including a CCU positioned on a member of the ECV such that the user can view and operate the ECV while operating the ECV;

FIG. 20 is an illustration of an illustrative ECV that provides for standing by a user, and including multiple sensors positioned on a tiller of the ECV along with a CCU disposed on a front member, in this case centered on a steering mechanism, to enable the user to view the ECV while operating the ECB;

FIG. 21 is an illustration of an illustrative venue, in this case an amusement park, in which multiple ECVs are being utilized along with an area that ECV's may be rented;

FIGS. 22A and 22B are illustrations of an illustrative venue, in this case a hospital with multiple floors, in which ECVs are being utilized;

FIG. 23 is an illustration of illustrative network environment in which multiple ECVs that are configured to communicate over a network to remote servers on the network and a server local to a venue along with optionally direct communication between the ECVs;

FIG. 24 is an illustration of a flow diagram of a process operable by a user on a CCU disposed on an ECV;

FIG. 25 is an illustration of a flow diagram of a process operable by a user on a CCU disposed on an ECV;

FIGS. 26A-26I are illustrations of an illustrative display of a CCU disposed on an ECV that is configured to operate a user process environment as shown in FIG. 24;

FIG. 27 is an illustration of an illustrative schematic of a CCU disposed on an ECV that is operable by a user in a venue;

FIG. 28 is an illustration of an illustrative block diagram of software configured to operate on a CCU disposed on an ECV that is operable by a user in a venue and further configured to communicate with servers through networks;

FIGS. 29A-29C are illustrations of an illustrative flow chart of a rental management system operable by at least one of a CCU or alternate rental system that is configured to allow a user to rent, retrieve, reserve, or return an ECV;

FIG. 30 is an illustration of a flow diagram of a process operable by a machine that controls a sensor driven locking system of an ECV;

FIG. 31 is an illustration of a flow diagram of a process operable by a machine that turns a CCU on and off in response to a sensor on an ECV;

FIG. 32 is an illustration of a flow diagram of a process operable by a machine that regulates a driving control system of an ECV to operate in a first or second state including first and second maximum speeds in response to identifying an object in a field of view of a sensor disposed on the ECV;

FIG. 33 is an illustration of a flow diagram of a process operable by a machine that begins and ends recording an output of a camera disposed on a front end of a tiller of an ECV in response to identifying an object in a field of view of a sensor disposed on the ECV;

FIG. 34 is an illustration of a flow diagram of a process operable by a machine that autonomously guides an ECV in response to identifying a path and the ECV being placed in an autonomous mode;

FIG. 35 is an illustration of a flow diagram of a process operable by a machine that recharges at least one battery of an ECV from a solar panel disposed on the ECV;

FIG. 36 is an illustration of a flow diagram of a process operable by a machine that identifies a remote control source and, responsive to receiving a disable command from the confirmed remote control source, disables an ECV;

FIG. 37 is an illustration of a flow diagram of a process operable by a machine that that identifies an ECV is near or in a restricted area, provides a message to a user of the ECV indicating proximity to the restricted area through a display on a CCU disposed on the ECV, and disables the ECV in response to passing a threshold of time within the restricted area;

FIG. 38 is an illustration of a flow diagram of a process operable by a machine that identifies a unique identifier of a nearby ECV and disregards signals originating from the unique identifier of the nearby ECV;

FIG. 39 is an illustration of a flow diagram of a process operable by a machine that begins charging at least one battery of an ECV in response to the ECV connecting to an inductive charger;

FIG. 40 is an illustration of a flow diagram of a process operable by a machine that communicates with a network server in a cloud;

FIG. 41 is an illustration of a flow diagram of a process operable by a machine that communicates with at least one venue server through at least one network server;

FIG. 42 is an illustration of a flow diagram of a process operable by a CCU on an ECV that manages a rental management system that is configured to allow a user to rent the ECV;

FIG. 43 is an illustration of a flow diagram of a process operable by a CCU on an ECV that manages a rental management system that is configured to allow a user to make a future reservation of the ECV or a different ECV;

FIG. 44 is an illustration of a flow diagram of a process operable by a machine that displays a location of an ECV relative to surrounding geography on a map on a display of a CCU disposed on the ECV and is configured to navigate a user to a location using the map;

FIG. 45 is an illustration of a flow diagram of a process operable by a machine that communicates messages to a user through a display of a CCU disposed on an ECV that is configured to overlay the messages with venue specific character;

FIG. 46 is an illustration of a flow diagram of a process operable by a machine that displays at least one of a miniature map and compass on a display of a CCU disposed on an ECV that is configured to overlay a perimeter of the miniature map or compass with venue-centric destinations;

FIG. 47 is an illustration of a flow diagram of a process operable by a machine that compiles an output of a camera disposed on a front end of a tiller of an ECV into a transferable format beginning in response to a user initiating a user session on the ECV through a CCU disposed on the ECV;

FIG. 48 is an illustration of a flow diagram of a process operable by a machine that compiles an output of a camera disposed on a front end of a tiller of an ECV and uploaded user photos into a transferable format in response to a user initiating a user session on the ECV through a CCU disposed on the ECV;

FIG. 49 is an illustration of a flow diagram of a process operable by a machine that integrates user specific information received from a venue in which an ECV is operated into information utilized by a CCU disposed on the ECV;

FIG. 50 is an illustration of a flow diagram of a process operable by a machine that communicates information from a venue to a user of an ECV on a display of a CCU disposed on the ECV; and

FIG. 51 is an illustration of a flow diagram of a process operable by a machine that allows a user to lock and unlock a compartment disposed on an ECV.

### DETAILED DESCRIPTION OF THE DRAWINGS

A. Electronic Convenience Vehicle (ECV)

An electronics convenience vehicle (ECV) may include a frame, multiple wheels configured to support and move the frame, a seat supported by the frame, and a steering mechanism disposed toward a front portion of the ECV, and configured to enable a user to rotate direction of one or more wheels to control direction of movement of the ECV. In an embodiment, the frame may include a chassis. A motor may be configured to cause at least one wheel to be propelled forward, propelled backward, or to remain in a fixed position. A throttle, when activated in a first position, causes the motor to propel the wheel(s) in a forward direction, when activated in a second position, causes the motor to propel the wheel(s) in a reverse direction, and when in a third position, causes the motor to maintain the wheel(s) in a fixed position. One or more sensors may be directed to detect objects in front of a direction of travel of the ECV, and may be configured generate sense signals indicative of an object being sensed by the sensor(s). A control and communications unit (CCU) may be disposed in front of the seat, and configured to receive the sense signals and to control operations of said motor, said CCU further configured to communicate over a communications network. The CCU is also referred to as an electronic digital dash (EDD).

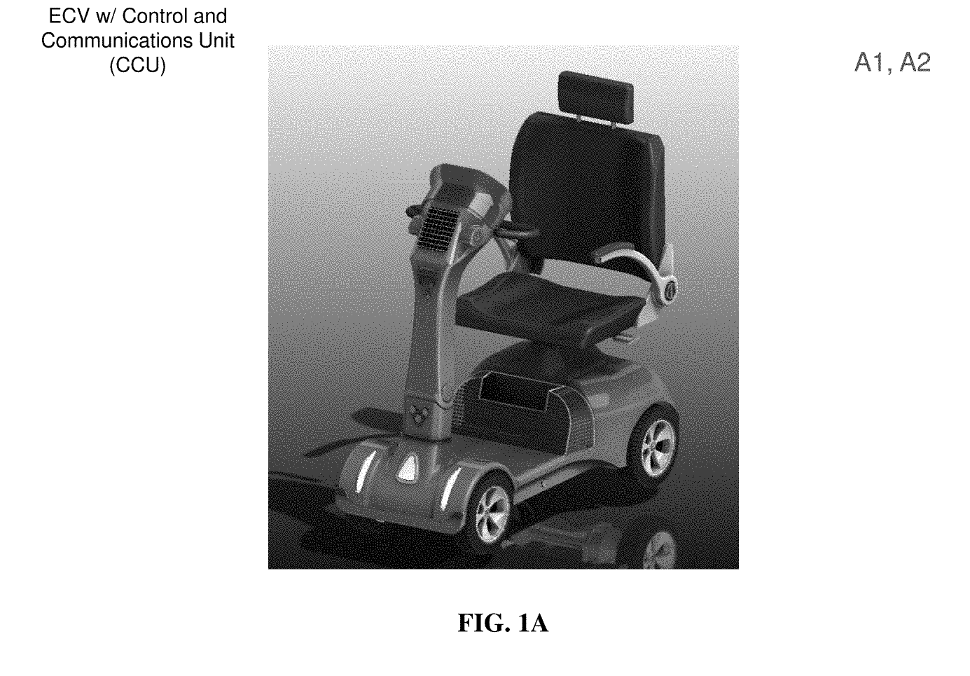

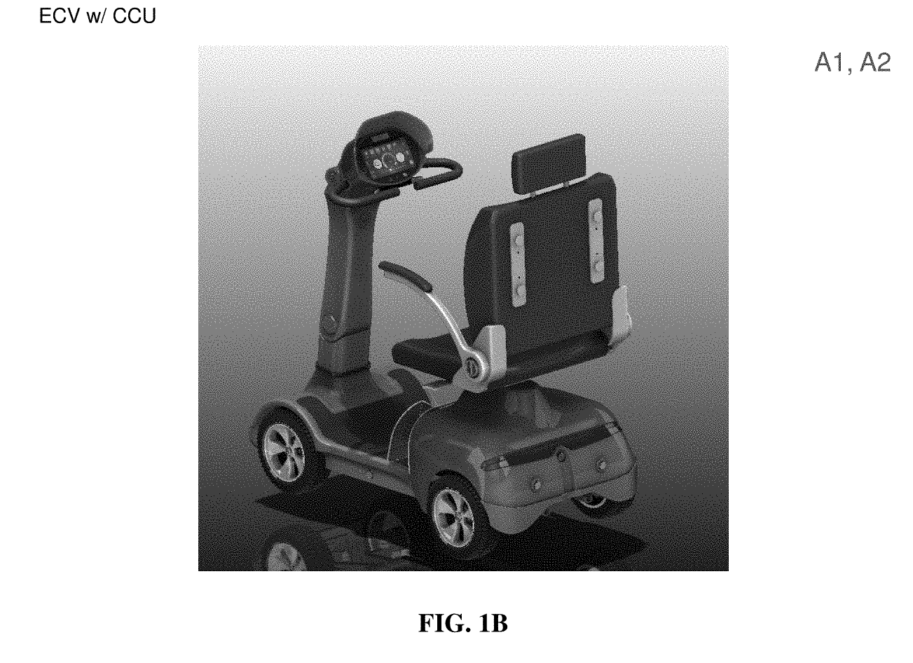

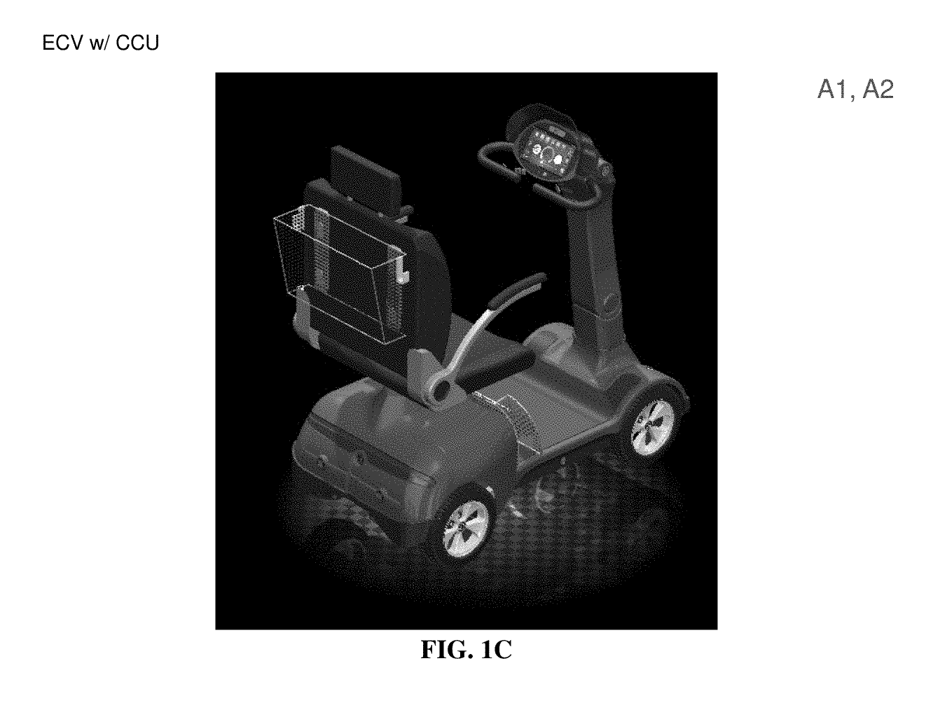

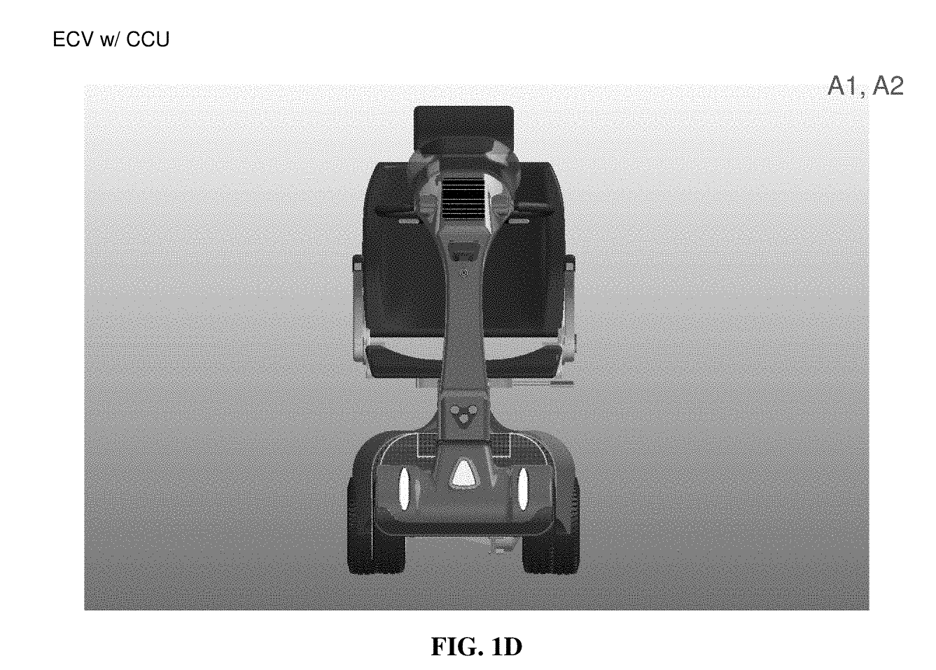

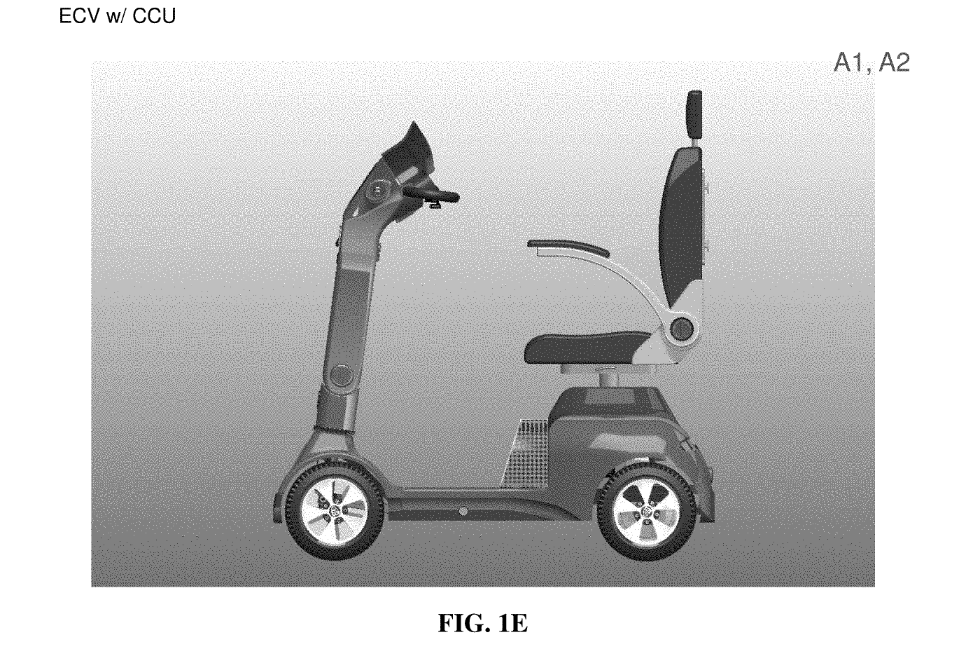

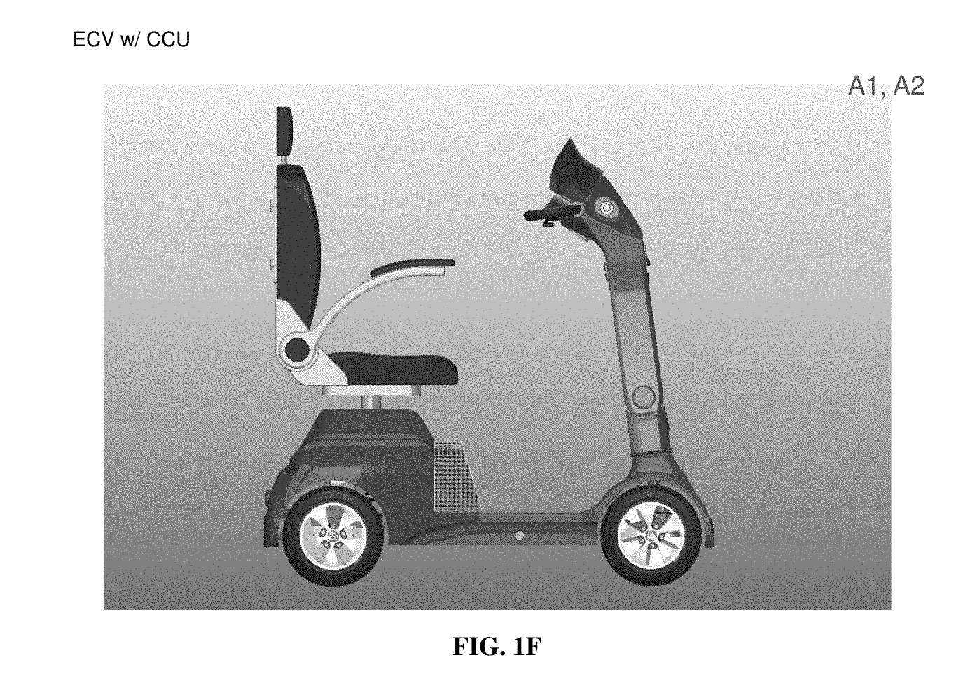

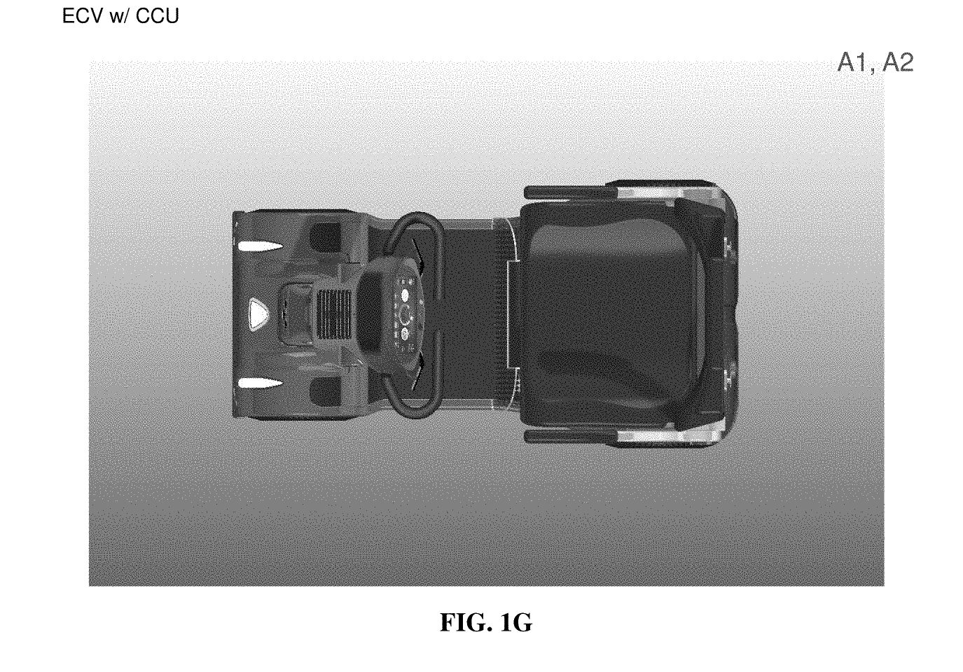

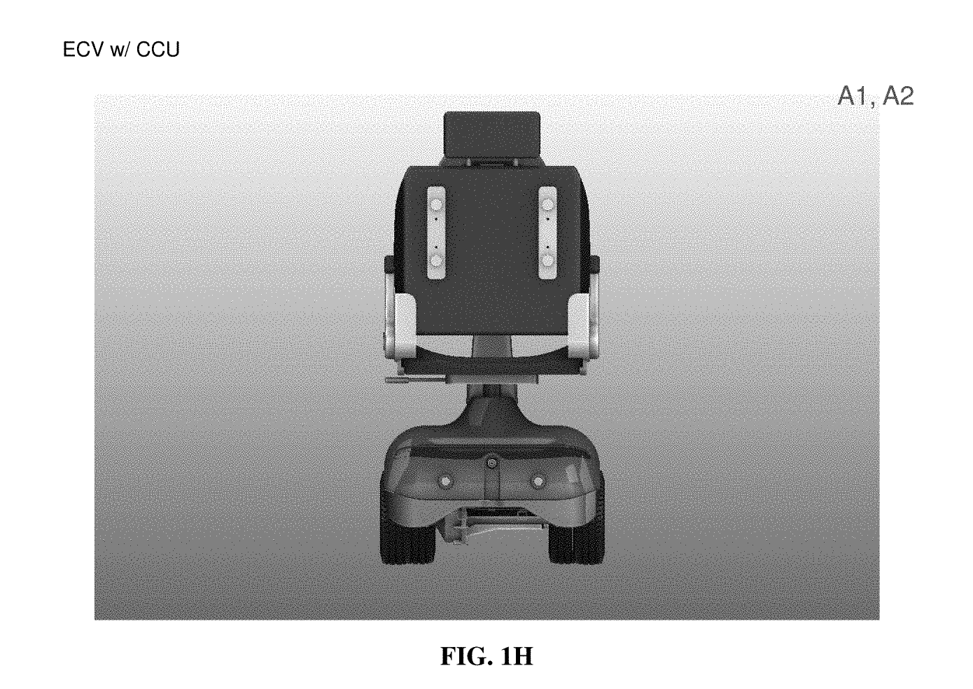

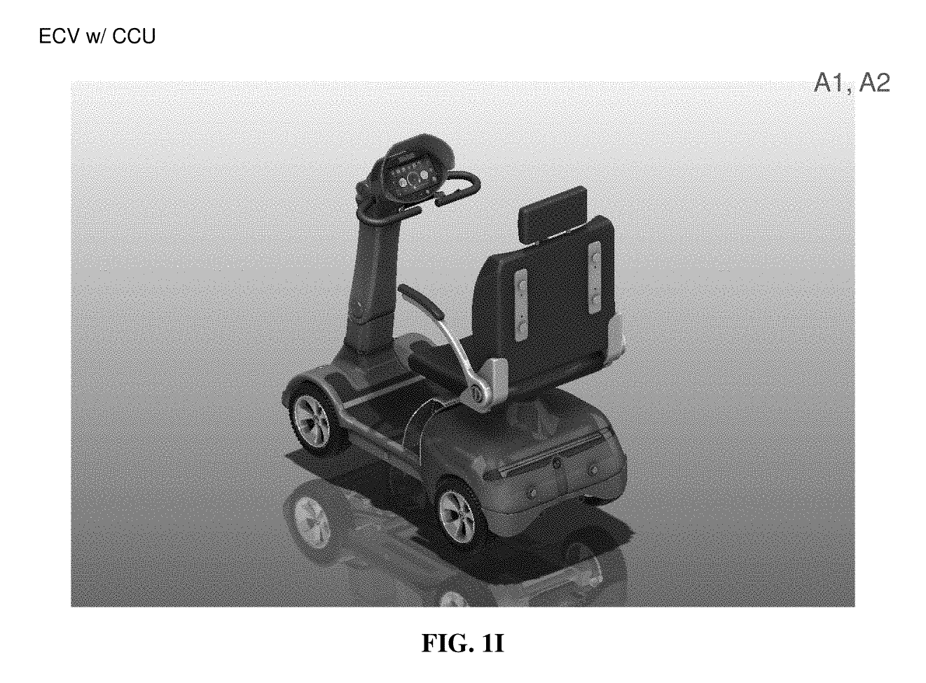

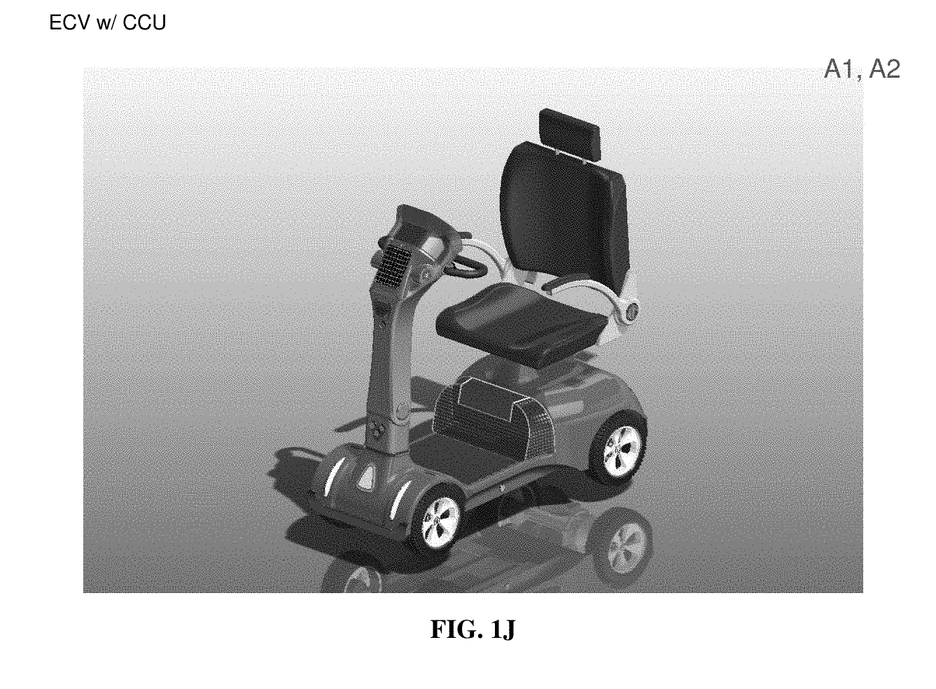

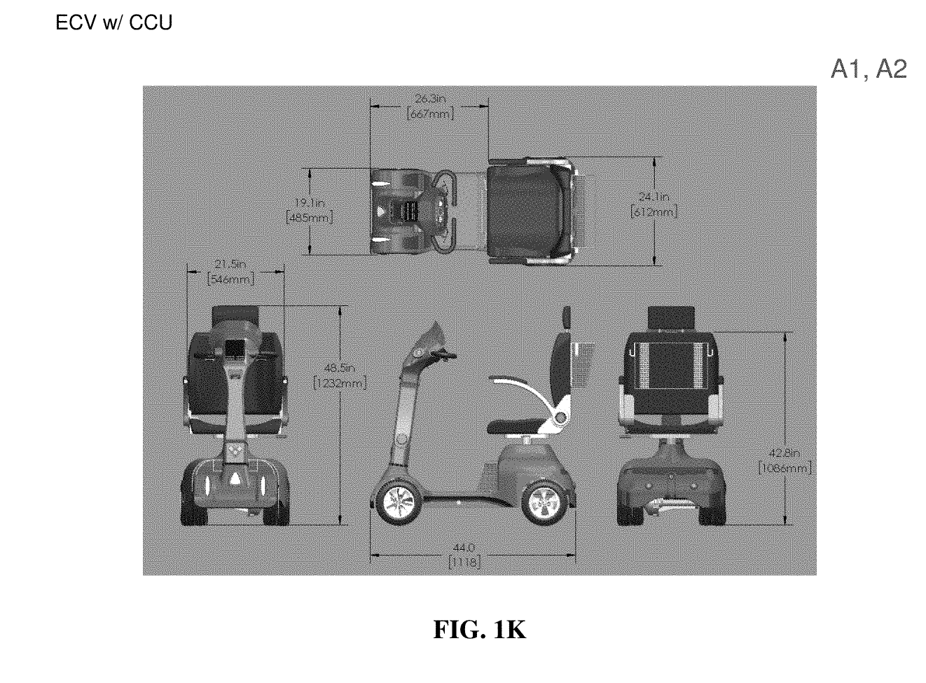

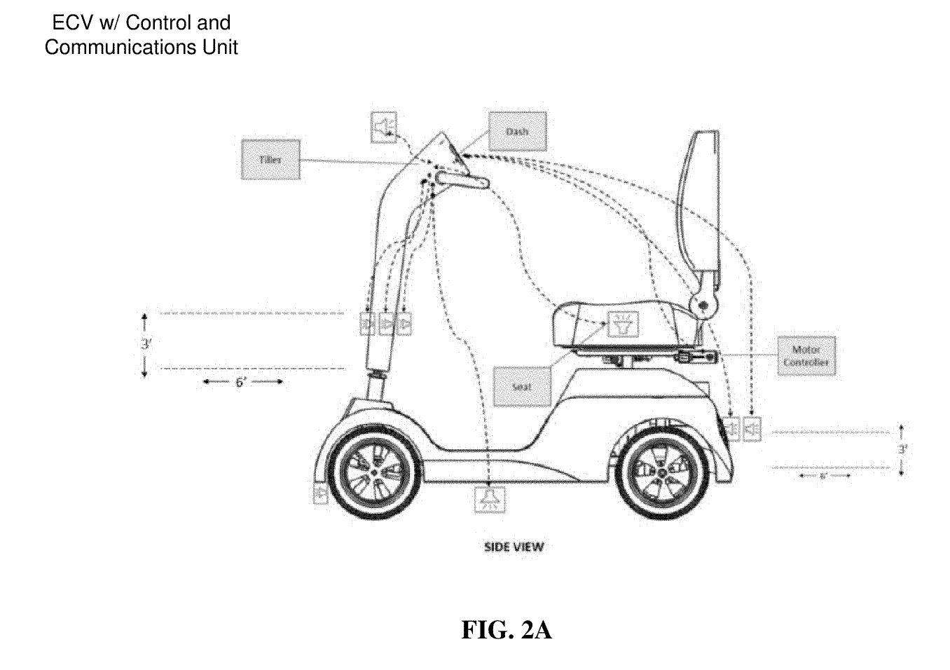

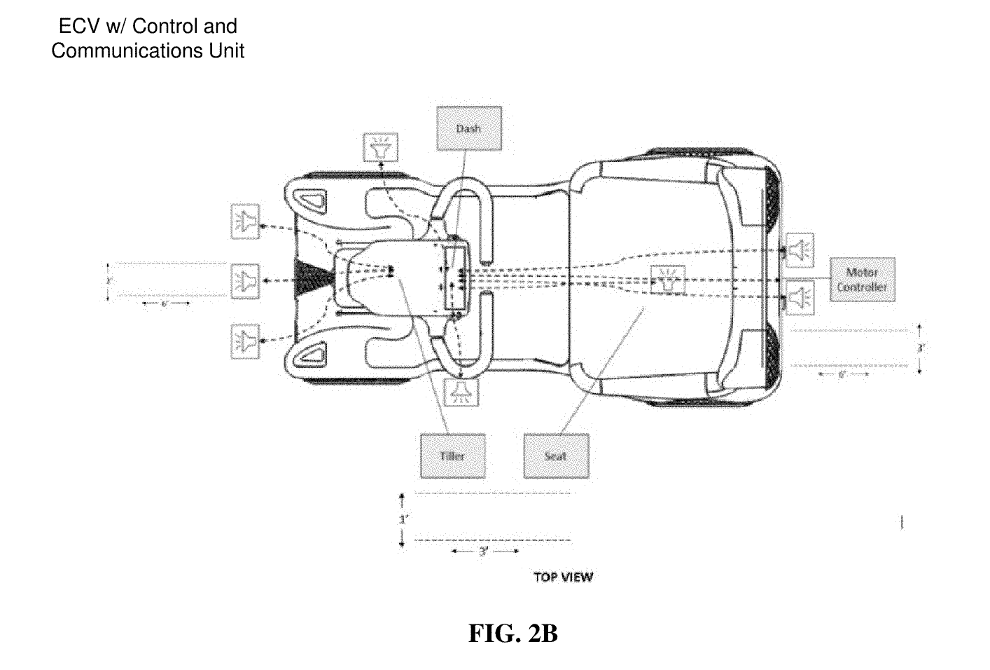

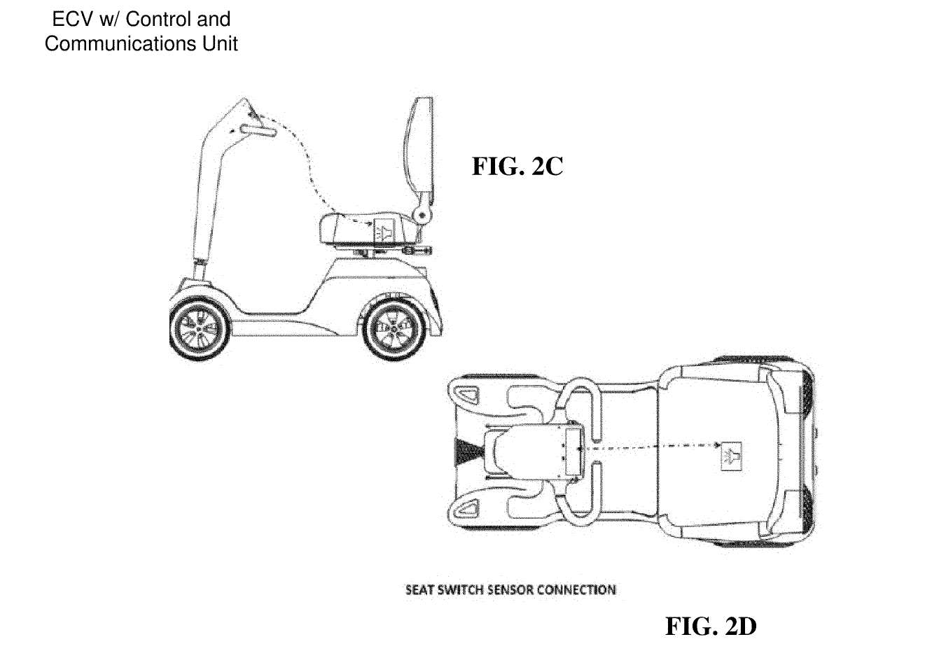

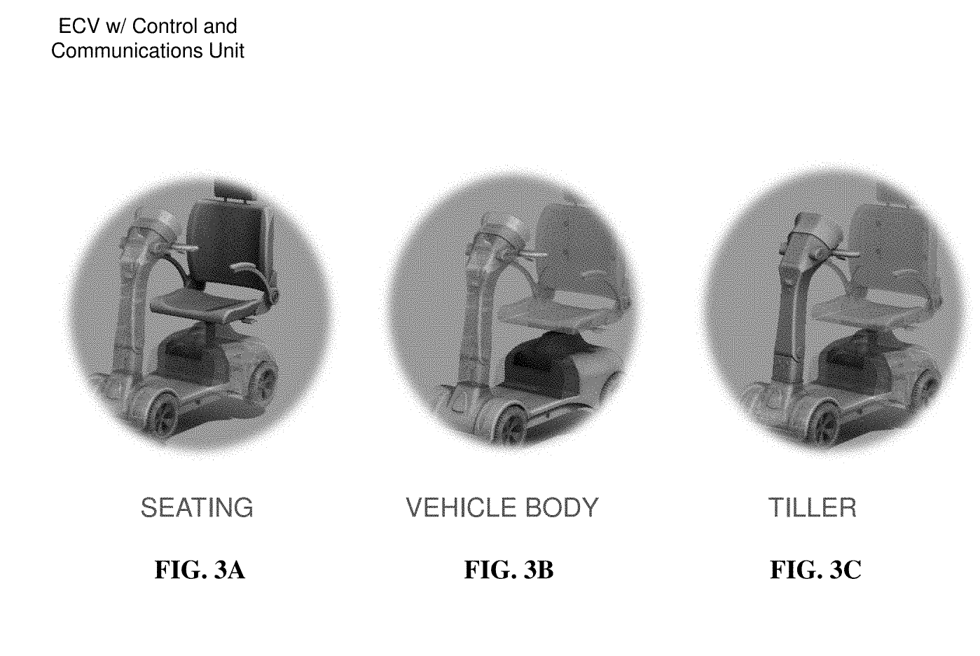

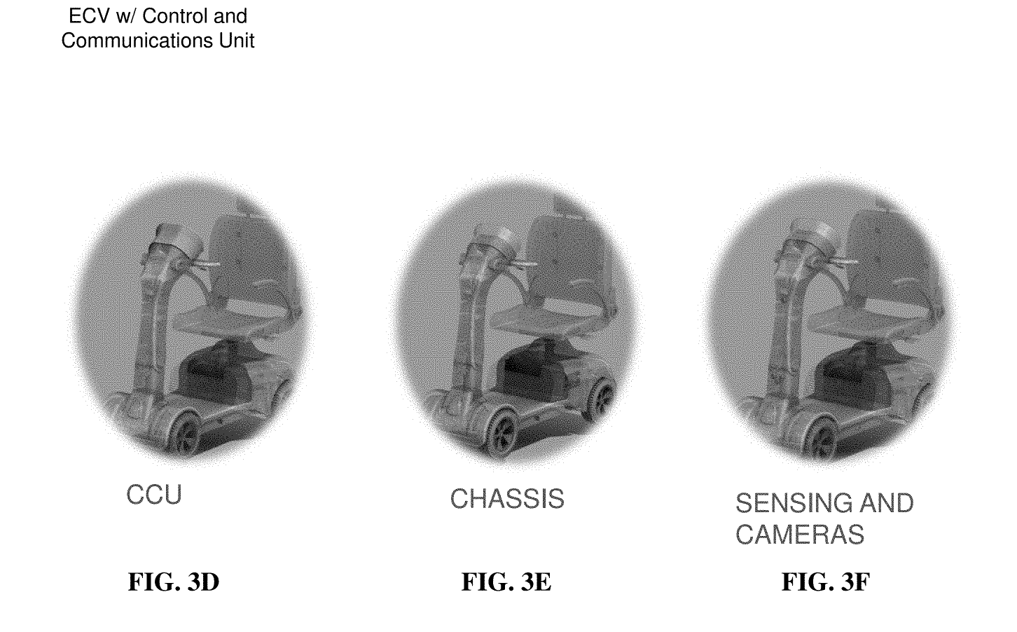

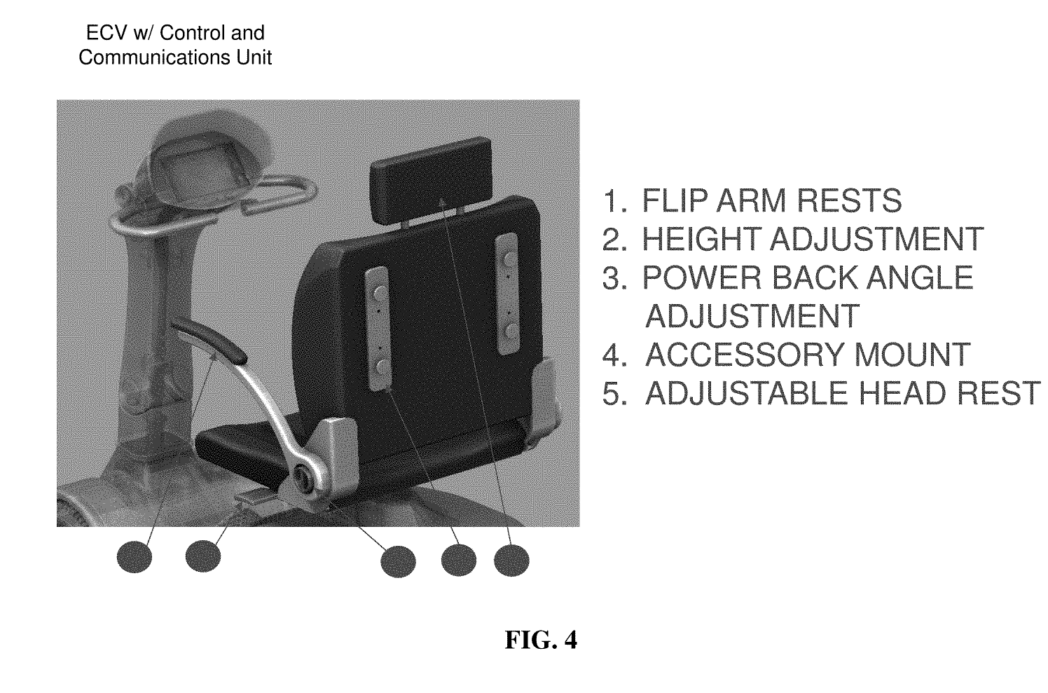

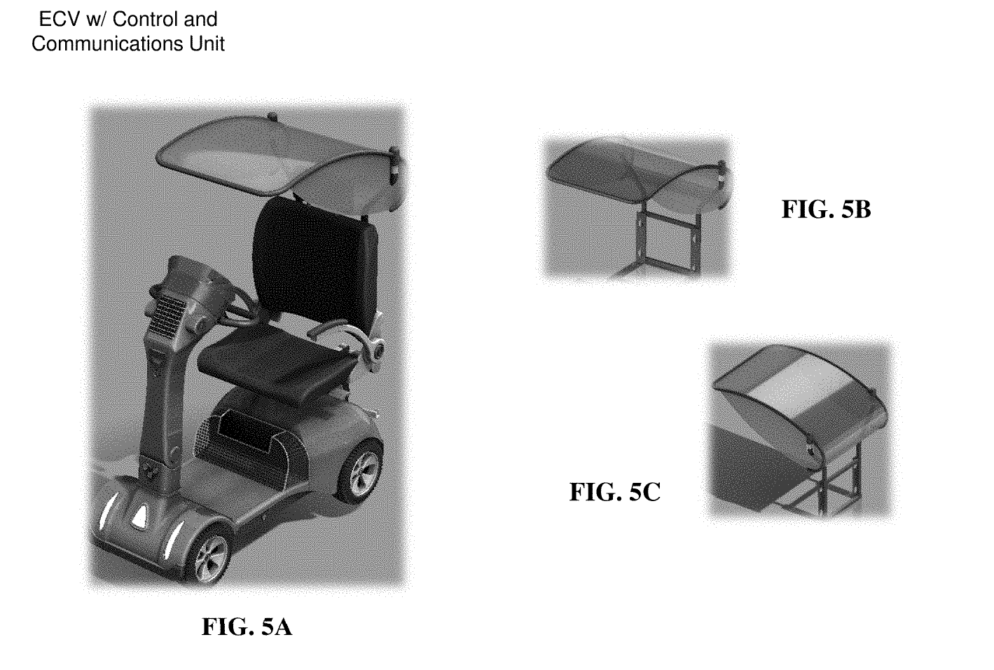

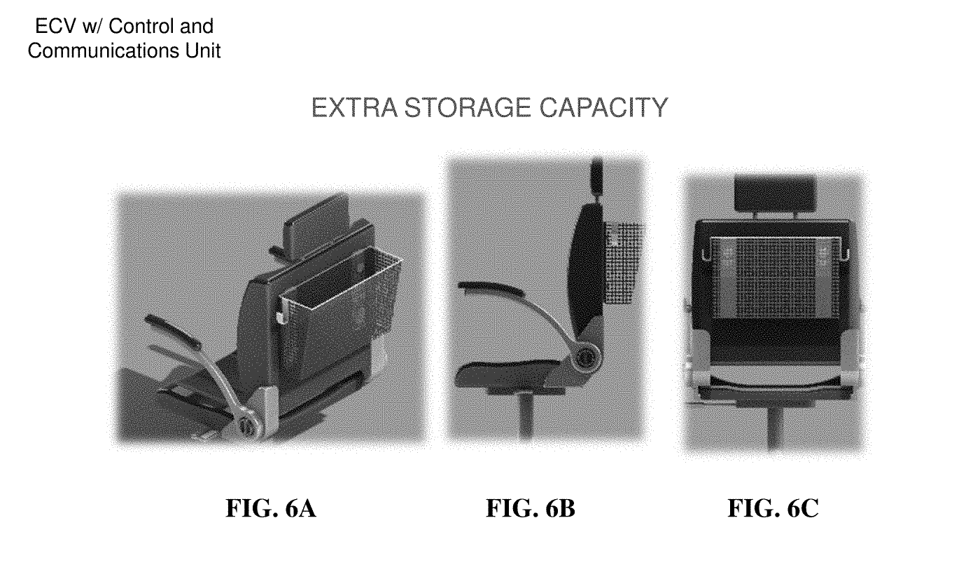

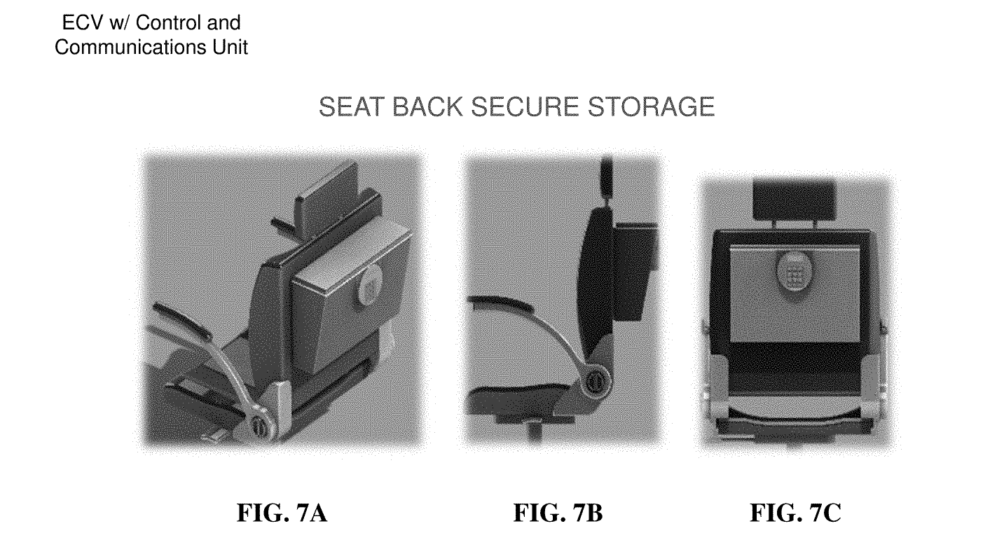

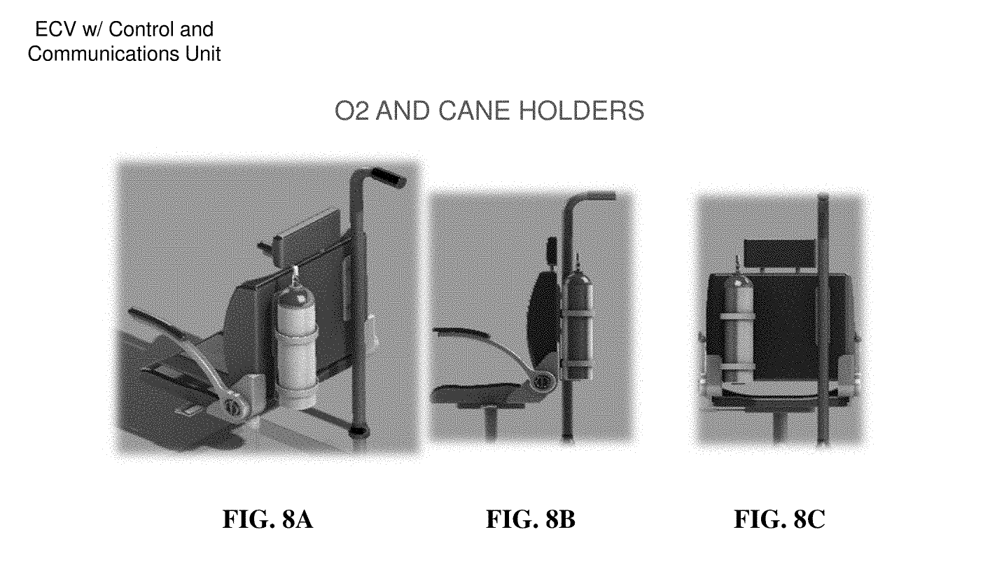

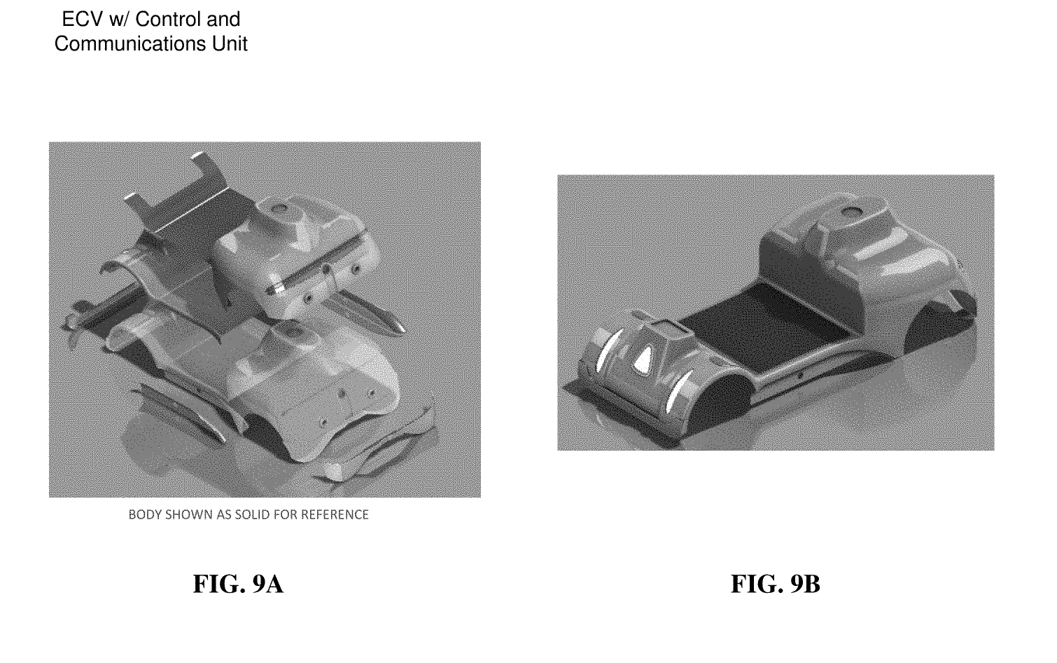

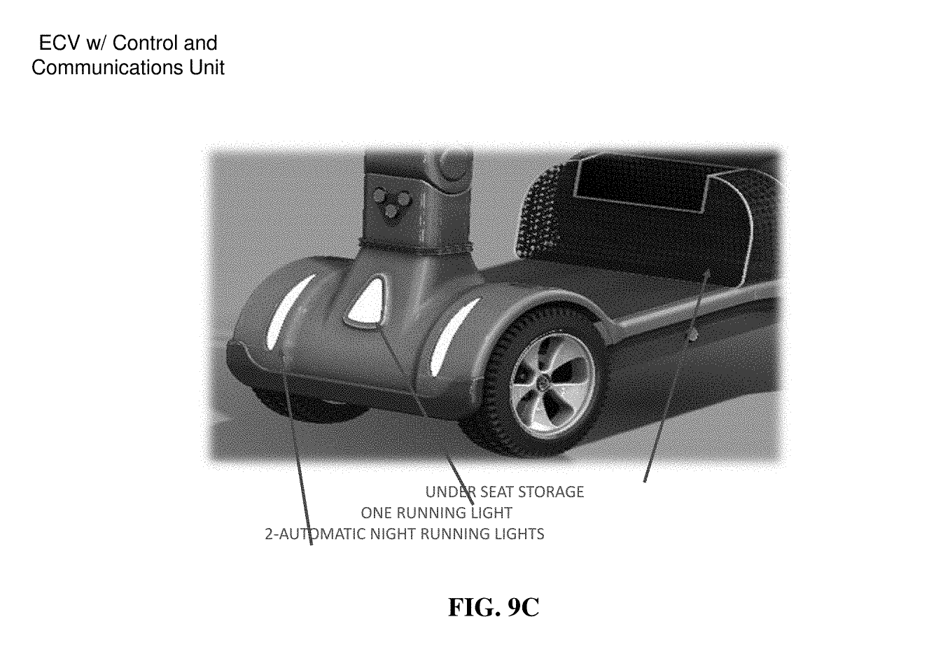

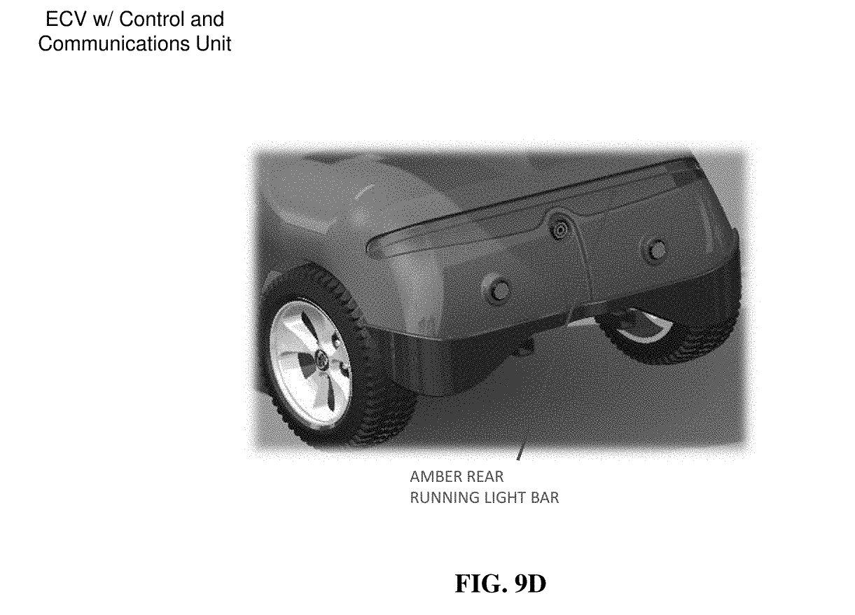

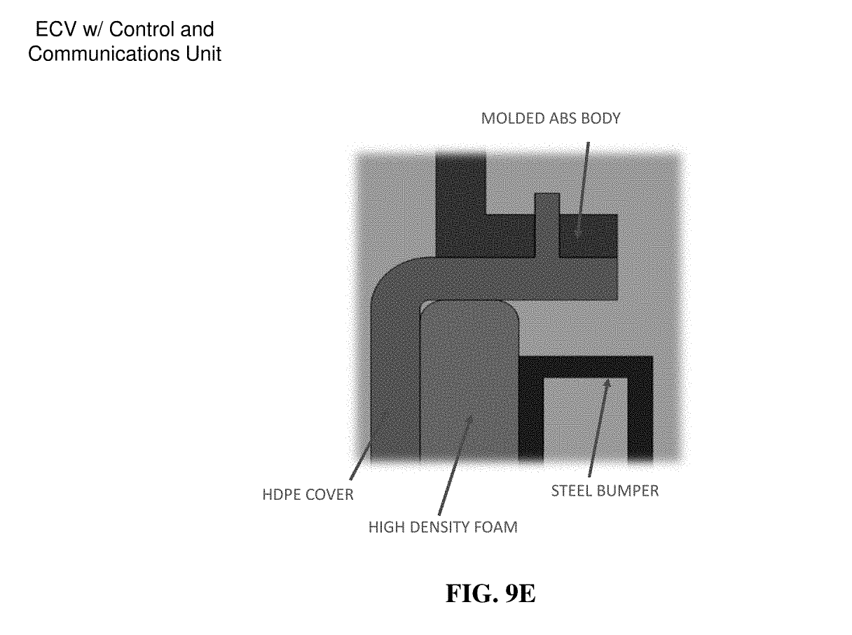

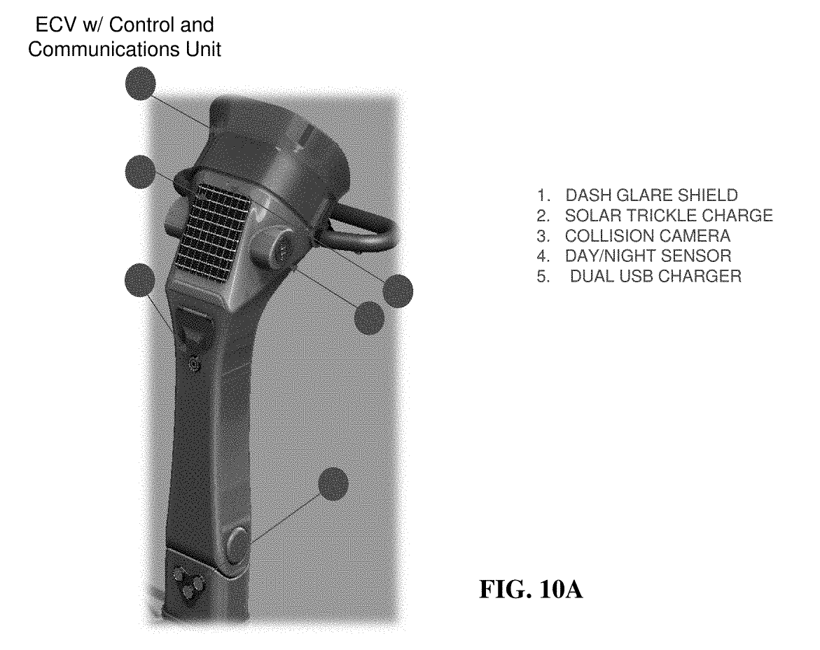

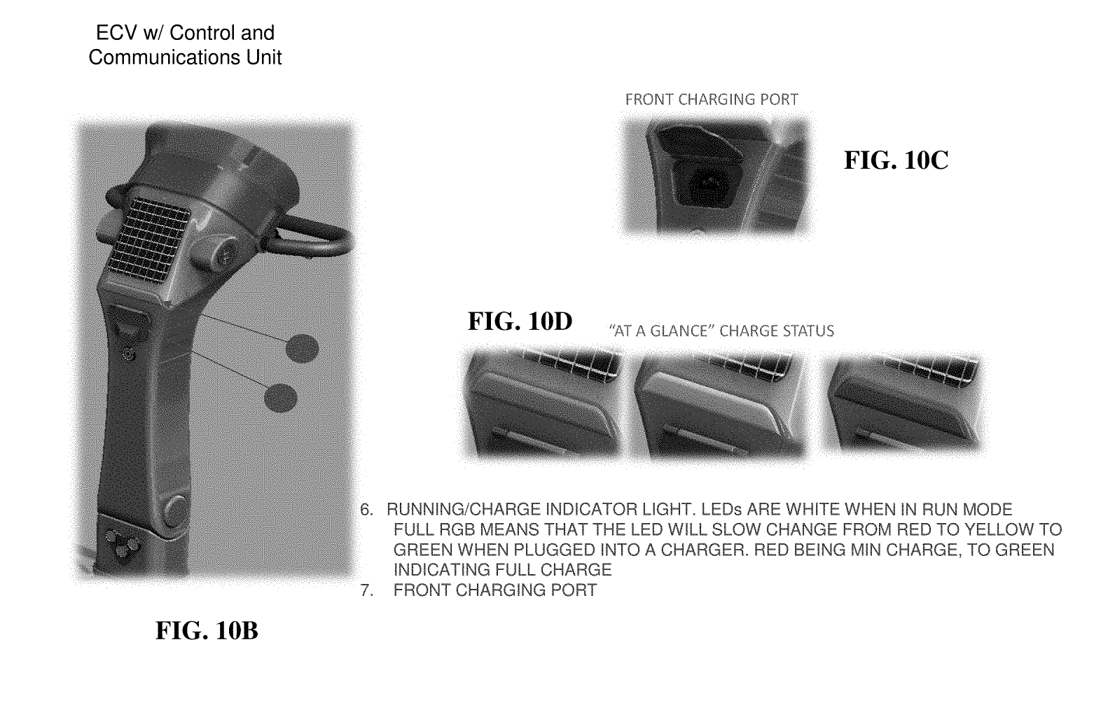

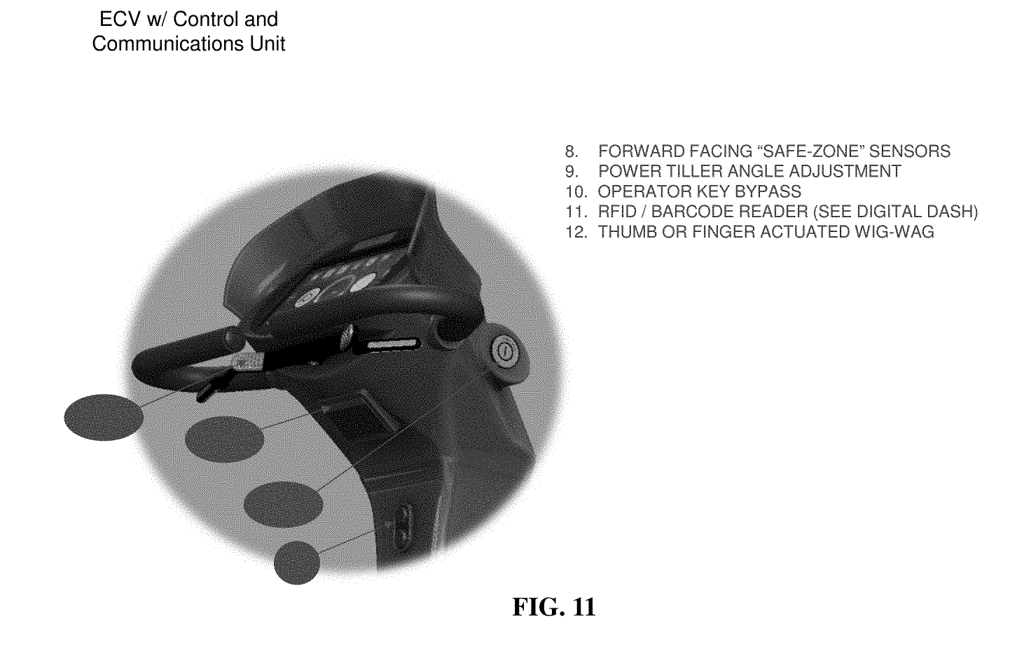

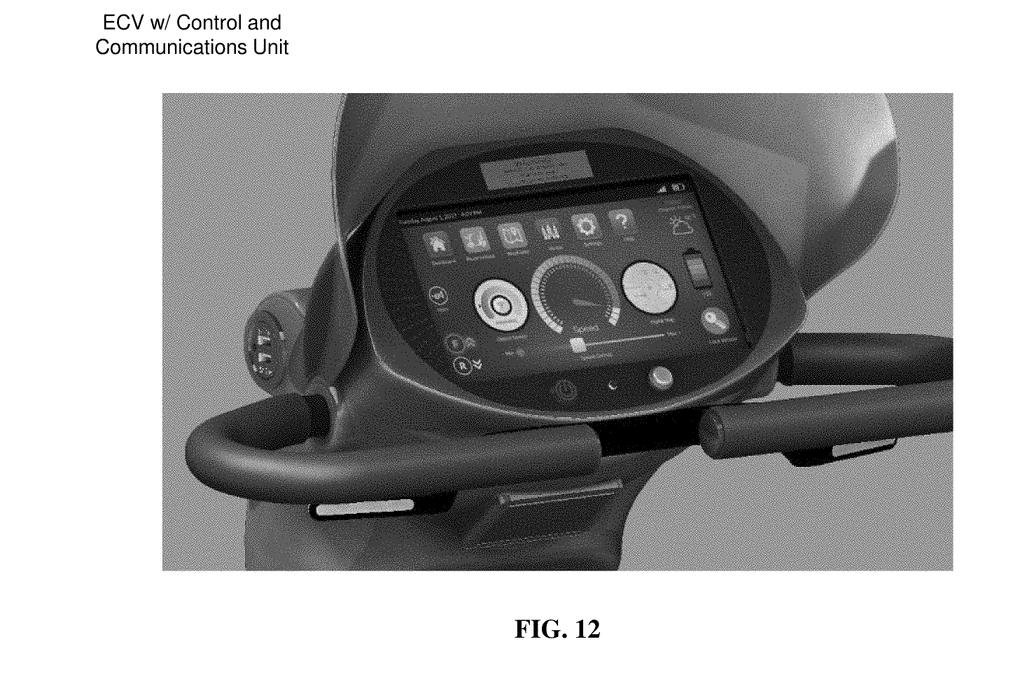

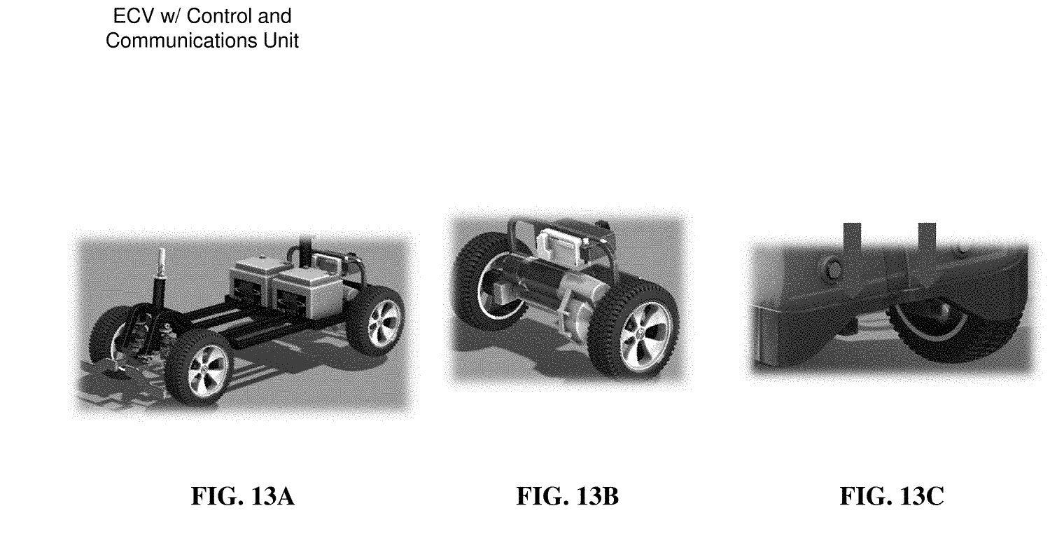

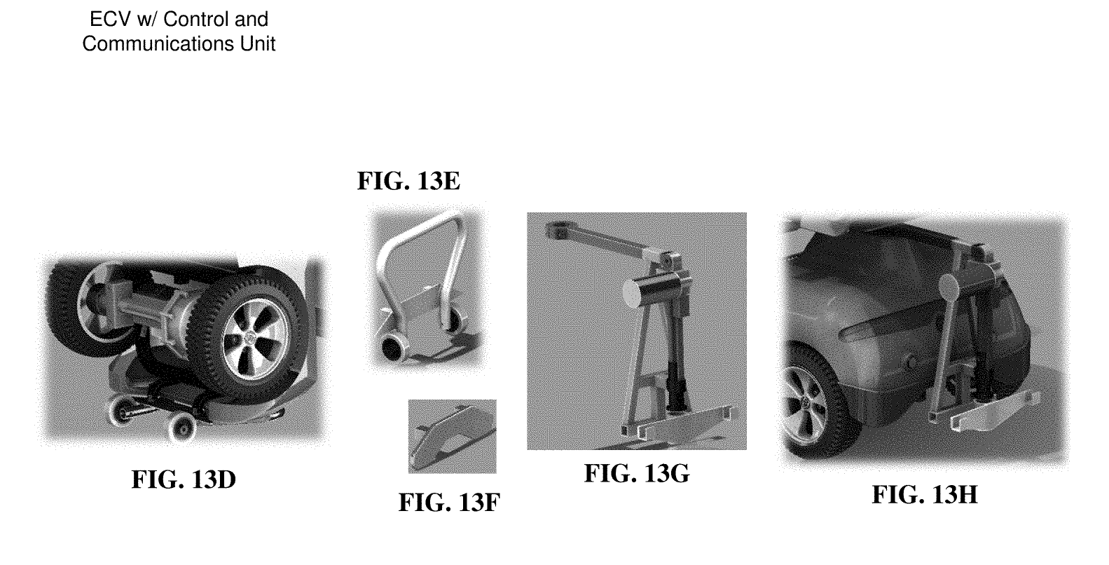

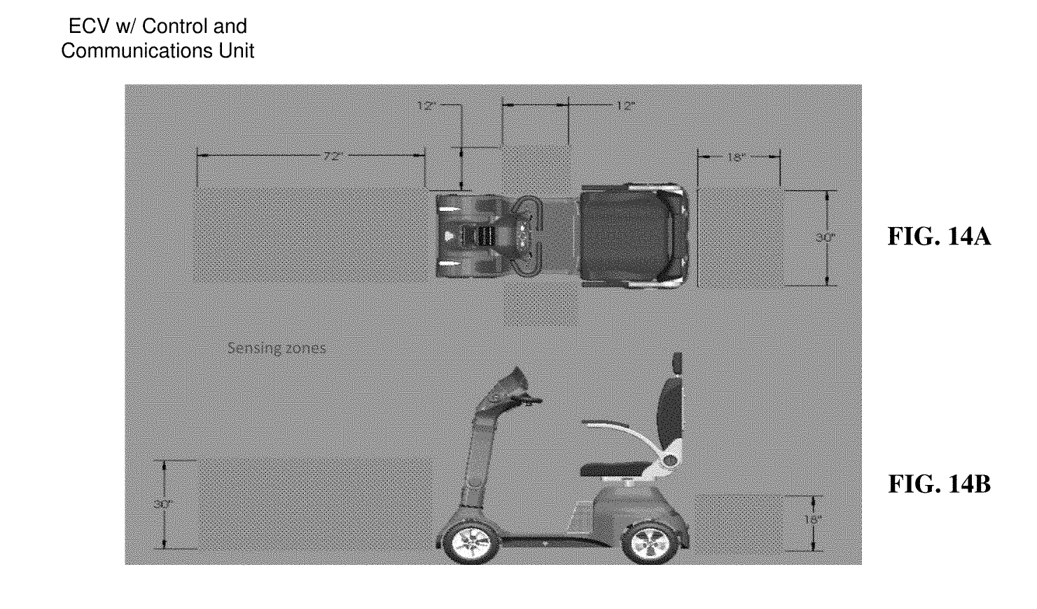

With regard to FIGS. 1A-1K, illustrations of an illustrative electronic convenience vehicle (ECV) that includes a control and communications unit (CCU), sensors configured to sense objects in front of the ECV, and other features that provide for safety and an improved user experience within a venue are shown. With regard to FIG. 1A, the ECV is shown to include wheels, chassis on which a body and chair are supported, a chair, in this case with armrests, and a steering mechanism. The steering mechanism includes handlebars that a user uses to control direction of motion of the ECV. The steering mechanism may also include a tiller that extends downwards from the handlebars to a body, and the tiller is configured to rotate in response to the user moving the handlebars that are attached to the tiller.

Mounted to the tiller, one more sensors are mounted. By mounting the sensors to the tiller, the sensors are able to sense objects in front of the direction of travel of the ECV. Moreover, as the sensors are mounted to the tiller that rotates, the sensors sense objects as a function of the angle of the tiller, which is different from sensors that may alternatively be mounted to a front bumper of the ECV, where bumper-mounted sensors would sense objects in front of the bumper of the ECV as opposed to an immediate directional change of the tiller that leads a directional change of the ECV.

With regard to FIG. 1B, a rear perspective view of the ECV is shown. In this view, the CCU disposed at a top portion of the tiller above the handlebars is shown. A visor partially encircling the CCU may be used to help reduce glare on the CCU. The CCU may include an electronic display on which a user interface for the user of the EVC to interact may display operational and non-operational information. The operational information may include speed of the ECV, remaining battery power, and other ECV operational information. Non-operational parameters may include venue-specific mapping information, venue-specific user information, rental information, and so forth, as further described herein.

On a rear portion of the body of the ECV, lights that indicate that the ECV is stopping to vehicles and people behind the ECV are shown. In an environment, one or more sensors, such as proximity sensors, may be positioned on the rear of the ECV. A camera may also be positioned on the rear of the ECV, thereby enabling a user to see behind the ECV when backing up by viewing video images received from the rear camera on the CCU, for example. FIGS. 1C-1K show alternative perspective and directional views of the ECV.
A1. Control and Communications Unit (CCU)
A2. Sensors (on tiller, on base, different types)
A3. Sensor Driven Locking System (to avoid shutoff of scooter)
A4. CCU On/Sleep Based on Sensor Control
A5. CCU with Multiple Control Algorithms Automatically Selected Based on Sensing Traffic Around Scooter
A6. Blackbox
A7. Autonomous ECV (Self-Queuing/Self-Stocking (Seat Sensor Enabled)
A8. Solar Recharging of Backup Battery
A9. Remote Turnoff
A10. Geographic Limitation of Operation
A11. Cross-Talk Avoidance (Different Frequencies, Modulations, Codes)
A12. Induction Charging
B. Communications
B1. Cloud Services/Messaging

Demonstrated Capability

Touchscreen display and integration 7 inch and 5 inch displays

GPS integration

WI-FI wireless functionality

EV hardware Inputs and outputs

Features

Front end is Web Browser—Easy to program and very versatile (video, audio, multimedia capability)

CCU may work with network connectivity or without networking.

Open source (free) software

External Web sites/database could be integrated (depending on web connection) easily with HTML. Can be easily integrated to custom web server over internet for additional capabilities.

Websockets and Apache web server has very good (SSL) security built in. Can be made secure.

Versatile interface allow either web browser from internet (to individual EV's) or websockets from back end servers

System can be scaled to large number of EV's

Hardware

The hardware for the proof-of-concept EDD is low cost computer board and touchscreen display, GPS and Wi-Fi adapters and a 12 to 24 volt switching converter to supply power to the computer and peripherals.

Software

The EDD software leverages the use of built-in functionality of the Linux system. The front end handles the display and user input. The back end interfaces between the hardware, networking layers (i.e. remote) and the local client (browser).

After powered, The software boots Linux and start the server processes and displays the initial screens. All software is stored on a mini SD card.

The front end EDD display:
Web Browser for dashboard display—Chrome browser
Custom developed HTML5/Java-script, for example, to communicate to backend server

Servers (running on EDD):
Web Server (e.g., Apache)
EV server (websockets interface)

Proof of concept Hardware block diagram

EV Server

Websockets interface:
Port 8901

4 protocols supported:

SB_Test—for testing allows commands to test

SB_GPS—sends GPS data real time from GPOS receiver

SB_EV—send EV hardware events, Occupancy (seat switch) and unlock/lock

SB_MSG—allows sending message top EV dashboard

B2. Venue Server Communications

C. User Interface

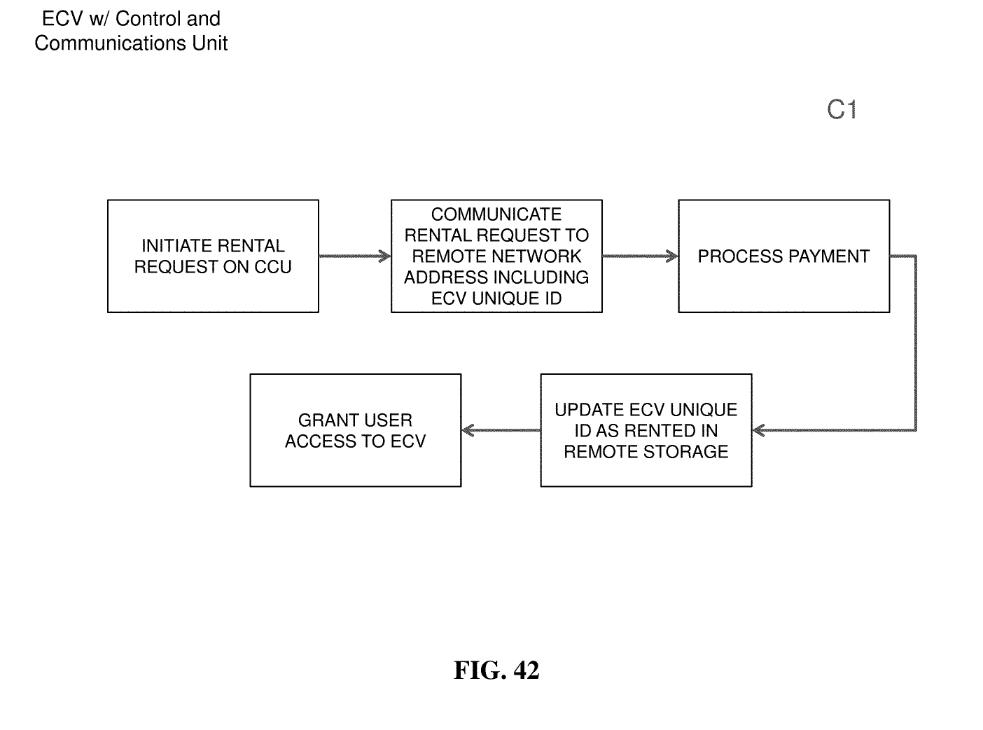

With regard to FIGS. 42-51, flow diagrams of processes operable by a CCU are shown. The CCU may disposed on an ECV and configured to interface with a user. The CCU may include a display for interfacing with the user. The CCU may include a processor inclusive of memory.

In one embodiment, the processor may be referred to as a central processor unit (CPU). The processor may be implemented as one or more CPU chips, one or more cores (e.g., a multi-core processor), or may be part of one or more application specific integrated circuits (ASICs) and/or digital signal processors (DSPs). The processor may be configured to implement any of the processes described herein, such as the processes of FIGS. 42-51, and may be implemented using hardware, software, firmware, or combinations thereof.

The display may be configured to be electronically communicative with the processor. The display may be configured to display representations of data to the user. The display may display in color or monochrome and may be equipped with a touch sensor based resistive and/or capacitive technologies. The display may be further configured to be an input device that may allow the user to input commands to the processor. One of ordinary skill in the art will appreciate that a variety of methods for communicating between the user and the machine.

C1. Rental/Reservations on CCU

With regard to FIG. 42, an illustration of a flow diagram of a process operable by a CCU on an ECV that manages a rental management system that is configured to allow a user to rent the ECV is shown.

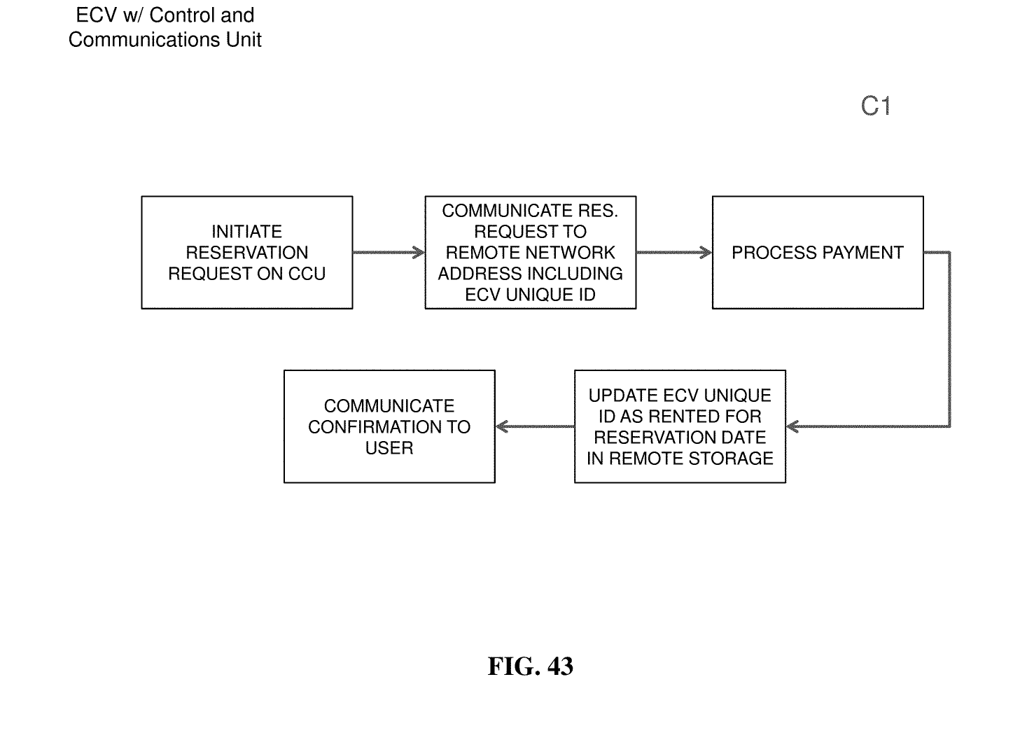

With regard to FIG. 43, an illustration of a flow diagram of a process operable by a CCU on an ECV that manages a rental management system that is configured to allow a user to make a future reservation of the ECV or a different ECV is shown.

C2. Wayfinder

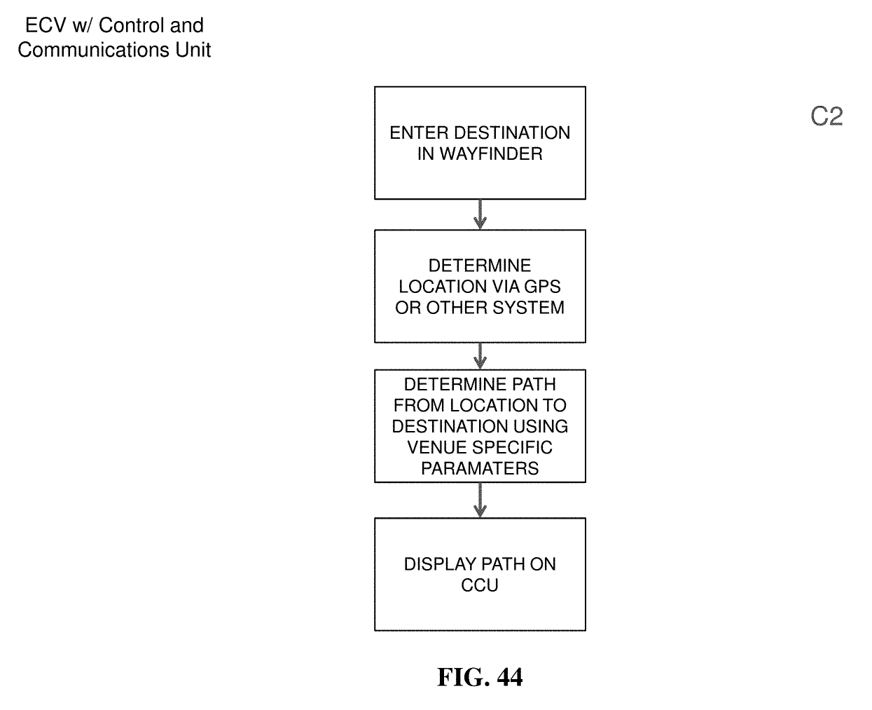

With regard to FIG. 44, an illustration of a flow diagram of a process operable by a machine that displays a location of an ECV relative to surrounding geography on a map on a display of a CCU disposed on the ECV and is configured to navigate a user to a location using the map is shown.

C3. Character Messaging

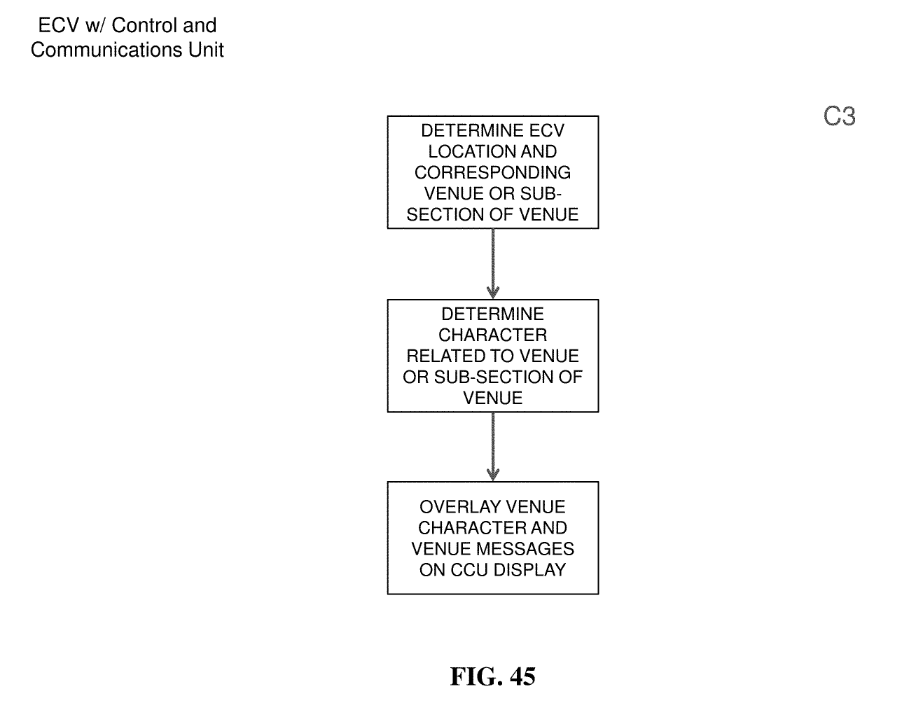

With regard to FIG. 45, an illustration of a flow diagram of a process operable by a machine that communicates messages to a user through a display of a CCU disposed on an ECV that is configured to overlay the messages with venue specific character is shown.

C4. Venue-Centric Compass

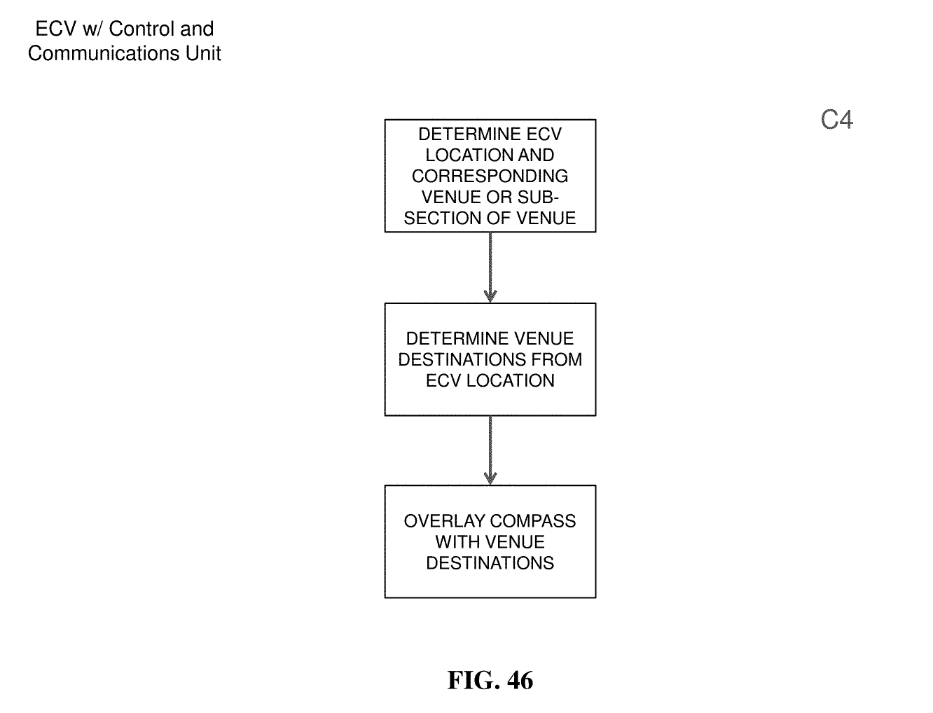

With regard to FIG. 46, an illustration of a flow diagram of a process operable by a machine that displays at least one of a miniature map and compass on a display of a CCU disposed on an ECV that is configured to overlay a perimeter of the miniature map or compass with venue-centric destinations is shown.

C5. Time Lapse Video with User Generated Content (UGC) Integration

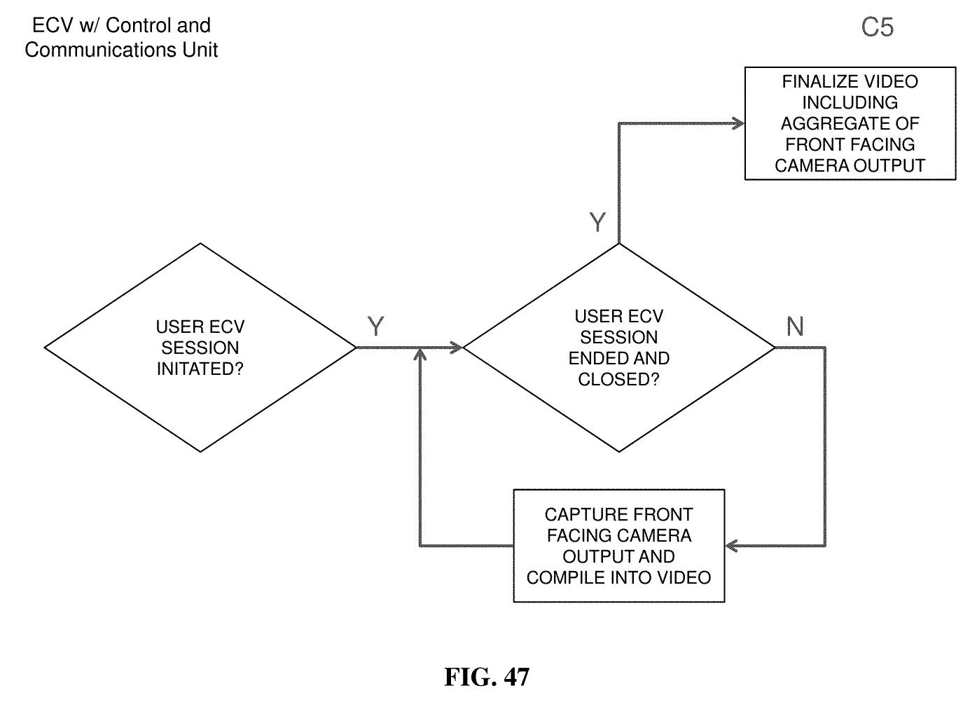

With regard to FIG. 47, an illustration of a flow diagram of a process operable by a machine that compiles an output of a camera disposed on a front end of a tiller of an ECV into a transferable format beginning in response to a user initiating a user session on the ECV through a CCU disposed on the ECV is shown.

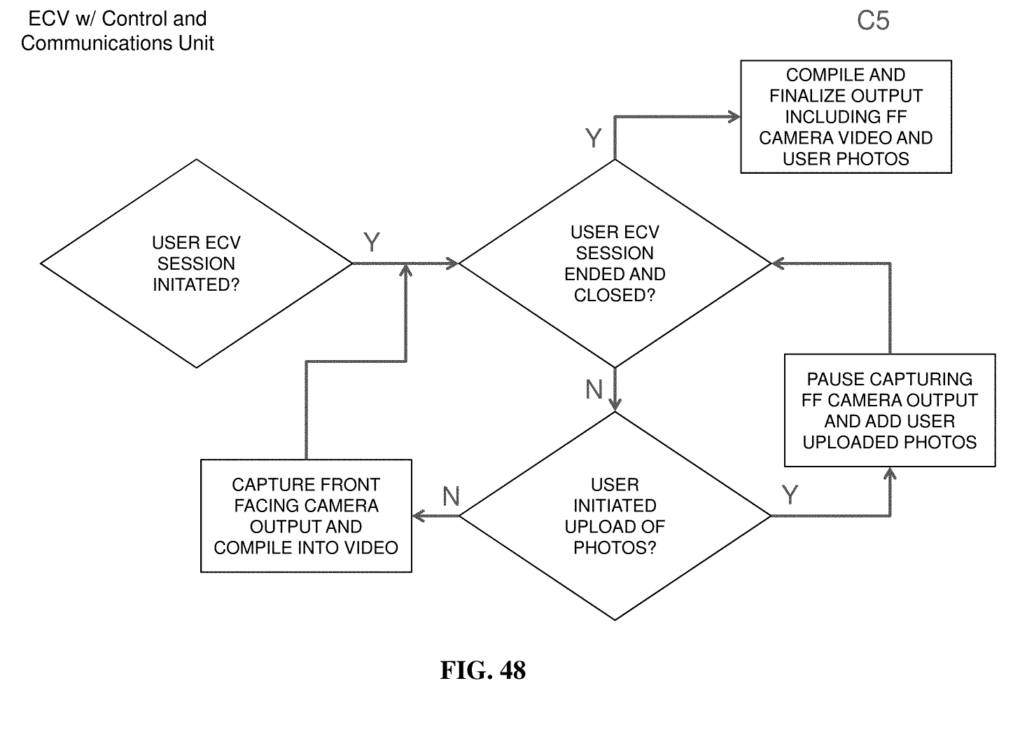

With regard to FIG. 48, an illustration of a flow diagram of a process operable by a machine that compiles an output of a camera disposed on a front end of a tiller of an ECV and uploaded user photos into a transferable format in response to a user initiating a user session on the ECV through a CCU disposed on the ECV is shown.

C6. Venue-Specific User Information

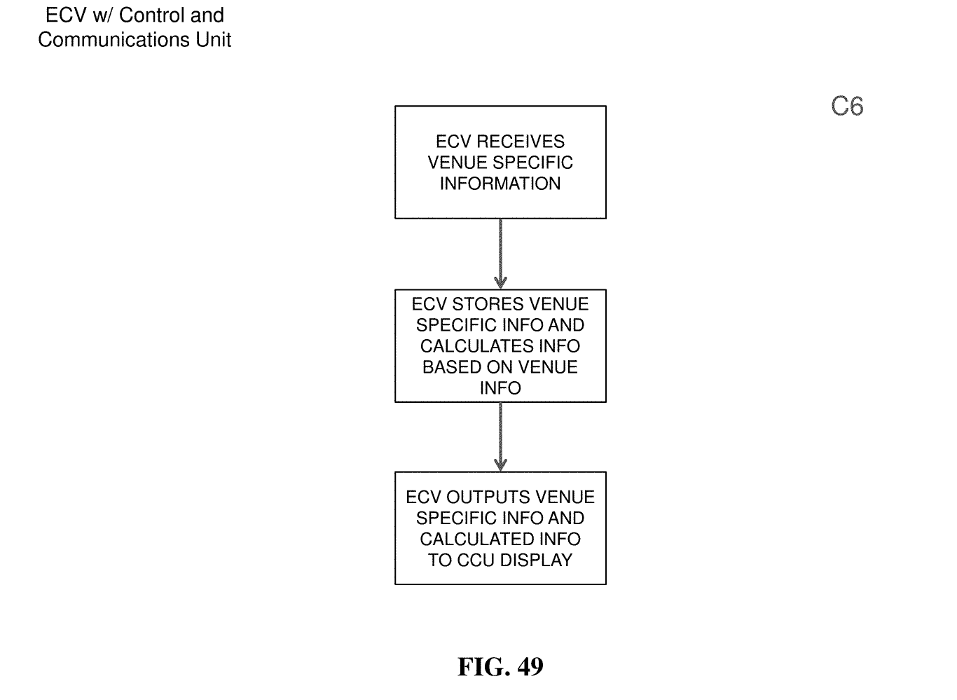

With regard to FIG. 49, an illustration of a flow diagram of a process operable by a machine that integrates user specific information received from a venue in which an ECV is operated into information utilized by a CCU disposed on the ECV is shown.

C7. Messaging (Notices, Park Closing)

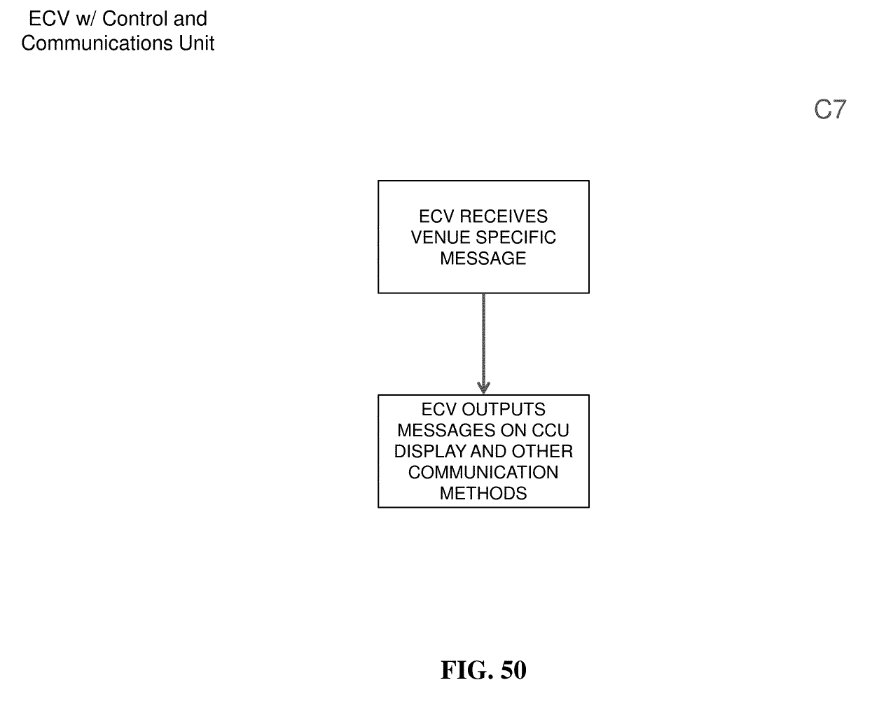

With regard to FIG. 50, an illustration of a flow diagram of a process operable by a machine that communicates information from a venue to a user of an ECV on a display of a CCU disposed on the ECV is shown.

C8. Lock/Unlock of Lockbox on Scooter

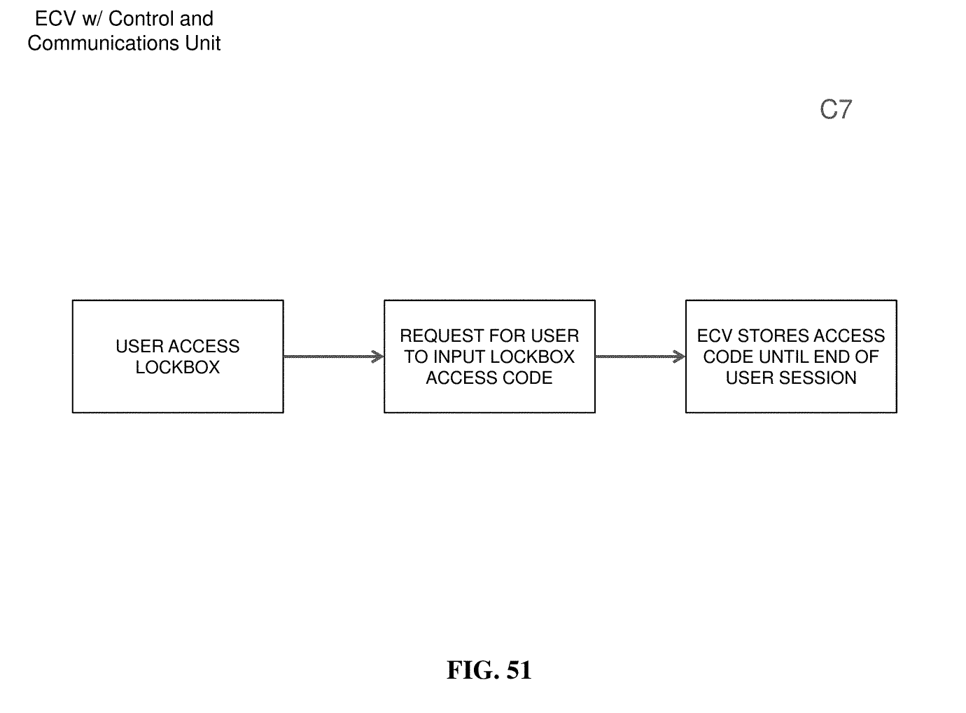

With regard to FIG. 51, an illustration of a flow diagram of a process operable by a machine that allows a user to lock and unlock a compartment disposed on an ECV is shown.

The Electronic Convenience Vehicle (ECV) mobility scooter—the EDD system—is currently in development and will be designed, equipped and programmed with smart technology. This mobility equipment will serve guests and visitors at any venues with a control center and mapping device. See Table 1 for the EDD system's smart features and functionality.

TABLE 1
EDD System: Features and Function
ECV MOBILITY: THE EDD SYSTEM

| Feature | Function |
|---|---|
| Dual USB Power Charging Ports | Capability to charge the ECV or mobility |
| | scooter, EDD |
| Electronic Proximity Sensor System | Integrated with the electronics & drive |
| | mechanics of the ECV to slow or stop the ECV if |
| | objects are detected within defined distances |
| | of the sensor placed on the vehicle. |
| | Improves the safety of driver, pedestrians & |
| | surrounding objects |
| Sensors w/Specialized Housings | Ultrasonic, electromagnetic or radar sensors |
| | to detect people & surrounding objects |
| Sound Mechanism | Sound alert with a series of beeps that |
| | escalate as the ECV gets closer to an object |
| LED Alert Display | Signals with proximity identification & |
| | flashes with intensity as ECV approaches a |
| | person or an object |
| Custom PCB Boards w/Wiring Harness & | Enhances power & vehicle controller |
| Specialized Housings | Helps to isolate from hazards & |
| | environmental issues |
| Specialized Brackets & Hardware | Attach & secure components |
| Programming Firmware & Integration | Helps create parameters of the system |
| | operations |
| | Integrated to a vehicle controller |
| Reverse Backup Camera | Equipped with a rear-facing camera & |
| | activates when the ECV is positioned in reverse |
| | The view behind the ECV is displayed on the |
| | EDD. |
| Electronic Digital Dashboard (EDD): | A touchscreen mobile display device is |
| Touchscreen | integrated into the dashboard of the ECV & |
| WiFi | interfaces with users |
| Bluetooth | Interface serves as a user control & |
| GPS | information center & is linked to the |
| Android-based system | ScooterBug ™ Cloud-based information |
| Weather proof | system for rental, service, security, vehicle |
| | performance, tracking& other integrated |
| | management of the ECV |
| | User interface of the EDD is similar an |
| | automobile digital display or that of a |
| | Smartphone or tablet device with a display of |
| | icons |
| Touch Screen to Begin | When the ECV dashboard is in sleep |
| | mode, a screensaver will appear |
| | displaying Touch Screen to Begin. |
| | User will touch screen and will see |
| | the Pre-Loader screen. |
| Pre-Loader Screen | User will see this screen as it loads |
| | the EDD Welcome screen. |
| EDD Welcome Screen | A menu display with respective icon |
| | buttons for functional screen selection |
| | & movement |
| | Rent or Retrieve button and Run |
| | Vehicle button: |
| | Capability to make a reservation, |
| | rent, or pick up prior online |
| | reservation of mobility equipment at a |
| | venue of choice via a link to the |
| | Reservation Management System |
| | (RMS) express process |
| | Guest selects Run Vehicle button for |
| | those sites that have managed rental |
| | and payment services. |
| | Guest will acquire keycode assigned |
| | to a unit for access & startup at a |
| | managed venue. (NOTE: Guest will |
| | establish their own keycode access at a |
| | self-vending environment.) |
| | START Button w/key image: |
| | Digital keypad pops up for guest to |
| | enter keycode to start/stop |
| | Once a code is entered, a Systems |
| | Notification window pops up and |
| | states, “Always Remember Your |
| | Keycode” with the keycode dislayed. |
| | Displays battery level indicator |
| | Communicates voltage status |
| EDD Home Screen (Dashboard) | Opens when vehicle starts up after |
| | the Systems Notification appears |
| | reminding the user to remember their |
| | keycode |
| | A display of icon buttons for |
| | functional screen selection & |
| | movement (i.e., Dashboard, |
| | Rent/Return, Wayfinder, Venue, |
| | Settings and Help) |
| | Displays battery level indicator |
| | Speed control display of a slider to |
| | show how fast/slow the ECV is going |
| | Displays the Horn button |
| | Displays the forward/reverse |
| | indicator |
| | Displays the key icon to prompt user |
| | with the “stop” or Lock Vehicle button |
| | when the ECV is not in motion |
| | Displays the Backup Camera screen |
| | when the ECV is going in reverse |
| | Displays the Settings page (i.e., |
| | volume, brightness, language, |
| | maintenance, etc.) |
| | Displays the object Sensor icon or |
| | indicator |
| | Displays local weather |
| | Displays date and time at the top, |
| | including WiFi and battery life |
| Mapping (e.g., Wayfinder) Screen | A menu display with respective icon |
| | buttons for functional screen selection |
| | & movement |
| | Displays a map of the location's |
| | facility or venue |

Displays the Wayfinder icon w/list of locations or keypad search via a mapping system & a voice guide
Displays key icon to lock vehicle (lower right)
Displays sensor icon for object sensing (lower left)
Displays Horn button (upper left)

| | |
|---|---|
| Venue Screen | A menu display with respective icon buttons for functional screen |
| | selection & movement |
| | Various information is posted about the venue |
| | Displays the venue info icon w/link to the venue's Website & |
| | specific visitor/guest functional tools |
| | Displays offers & sales |
| | Video Entertainment (i.e., possible venue-specific videos) |
| Rent/Return Screen | Mobility equipment rental process capability as described in the |
| | Welcome screen |
| | Displays the RMS Web rental/reservation link |
| Help Screen | Provides guests with a training, video tutorial on how to use the |
| | ECV |
| | Provides guests with a list of additional “How To's” accompanied |
| | with video tutorials, including instructions & illustrations |
| | Contact Assistance is available & linked to a support line: |
| | Phone number |
| | Text icon |
| Settings Screen | Language, volume, brightness |
| | Administrator keycode access to various information & data from |
| | controller (i.e., control of the ECV, inventory availability, etc.) |
| | Maintenance - Links to vehicle data & database in the |
| | ScooterBug ™ ERP system, X3 |

Mobility Equipment: Initial Start-Up

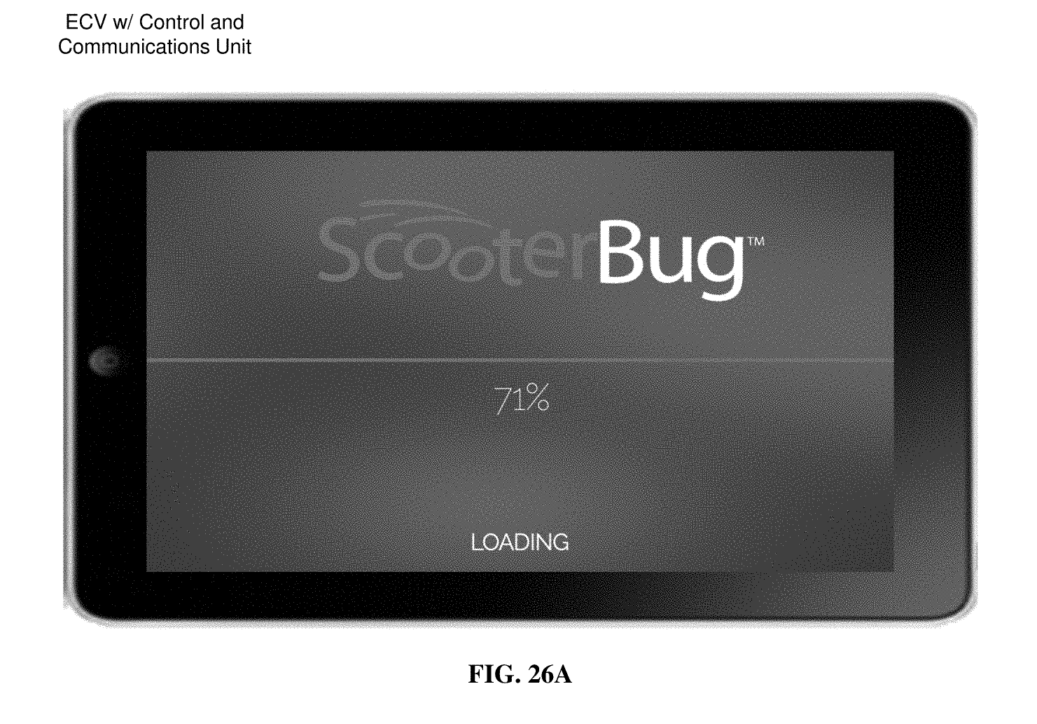

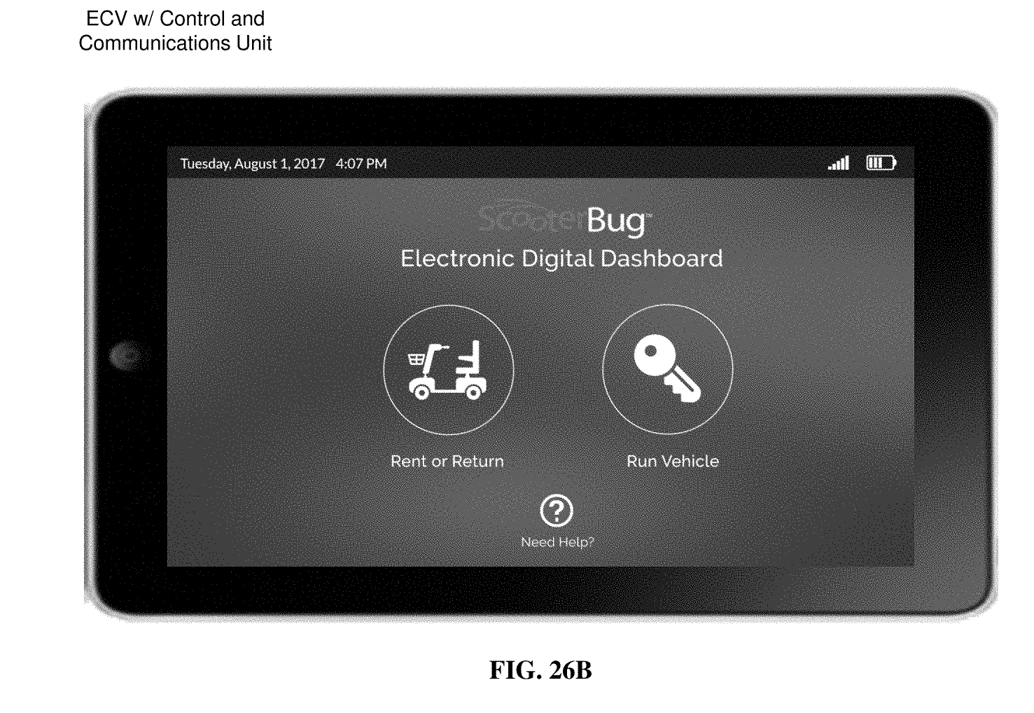

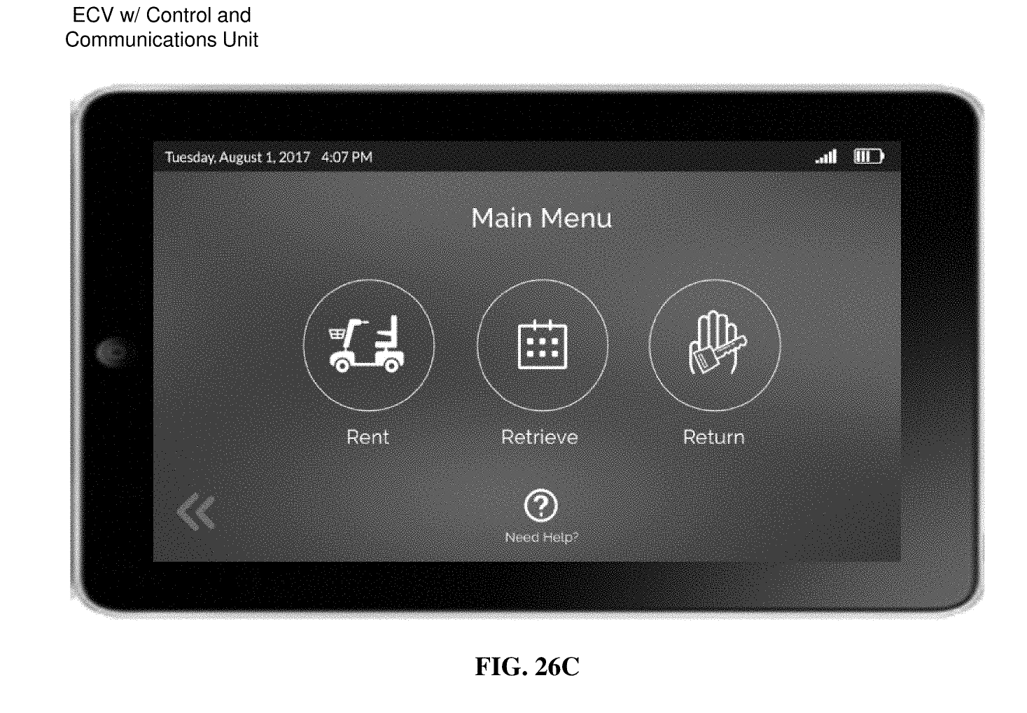

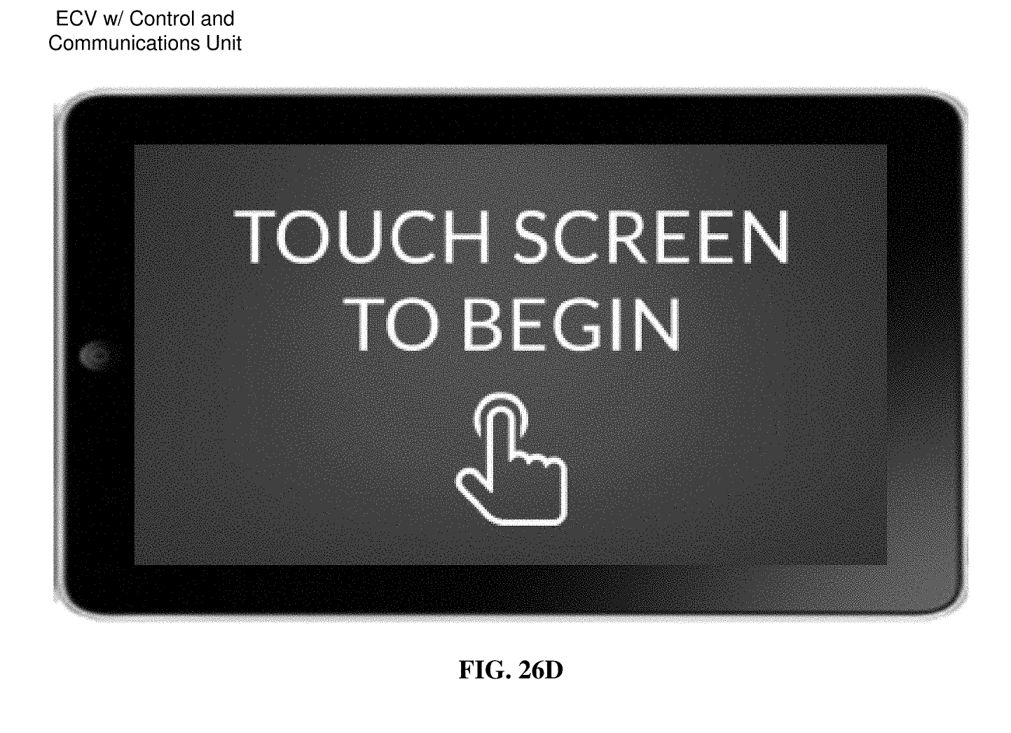

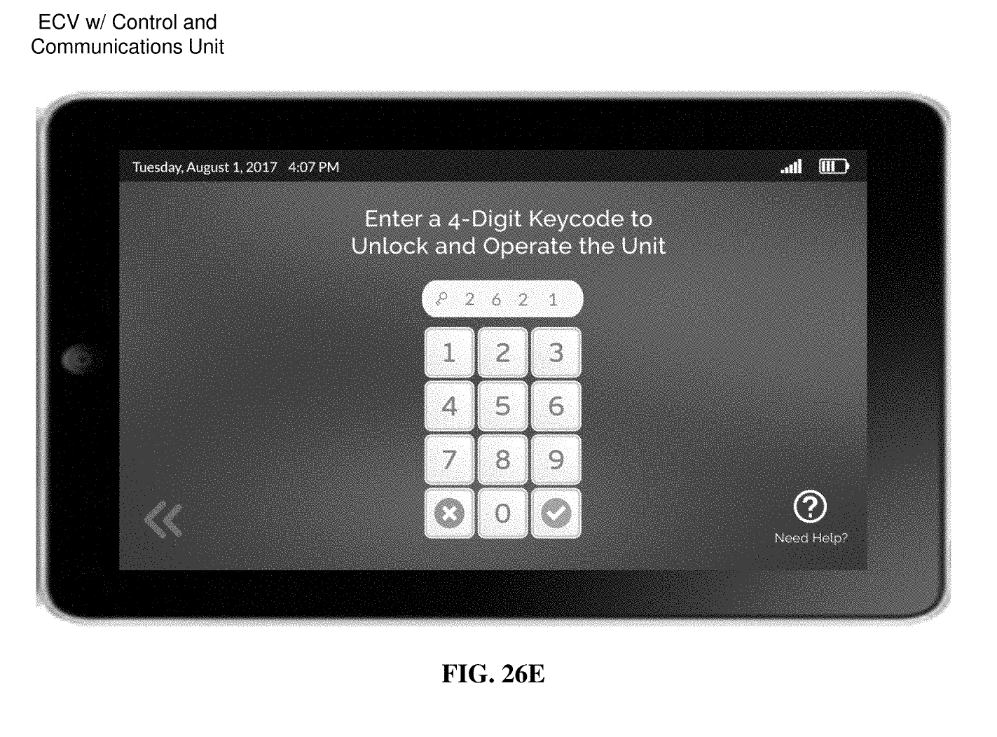

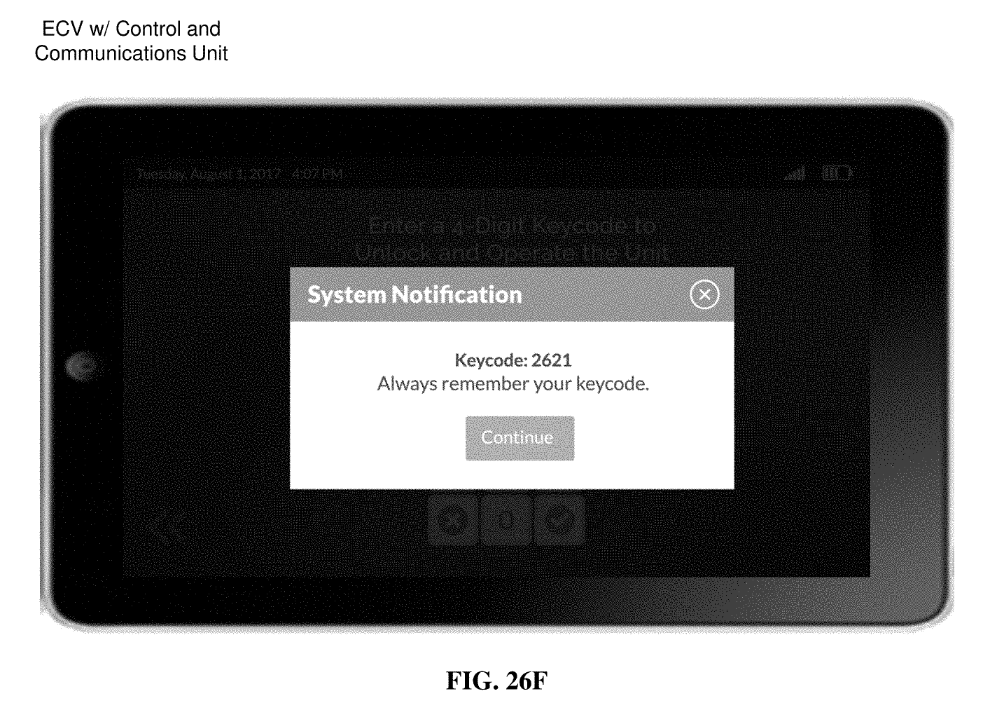

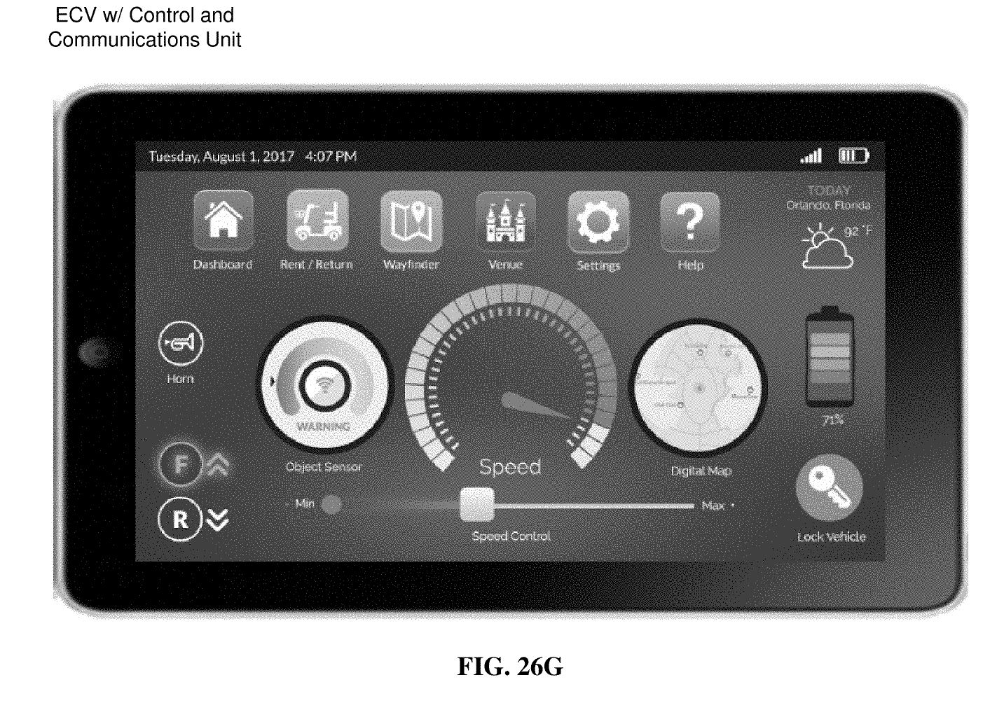

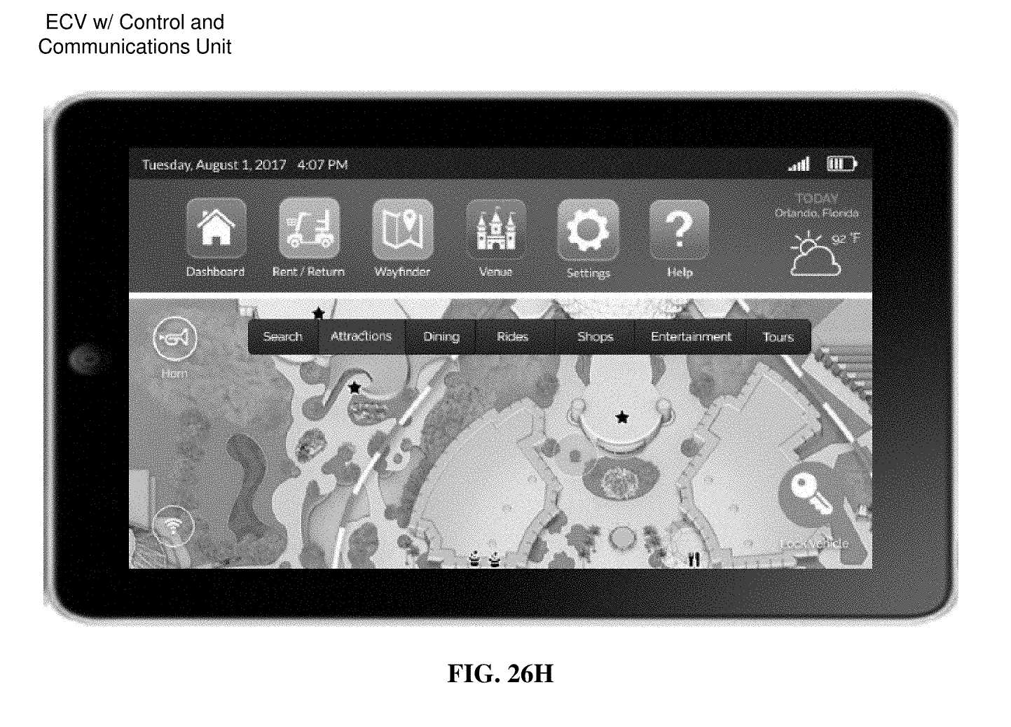

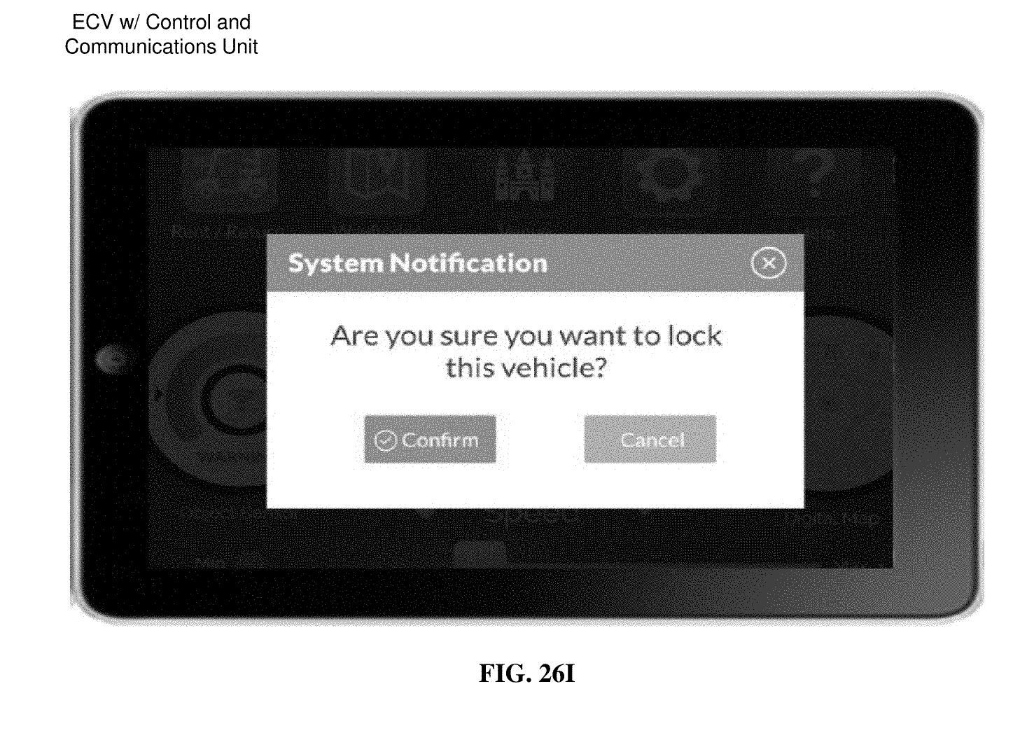

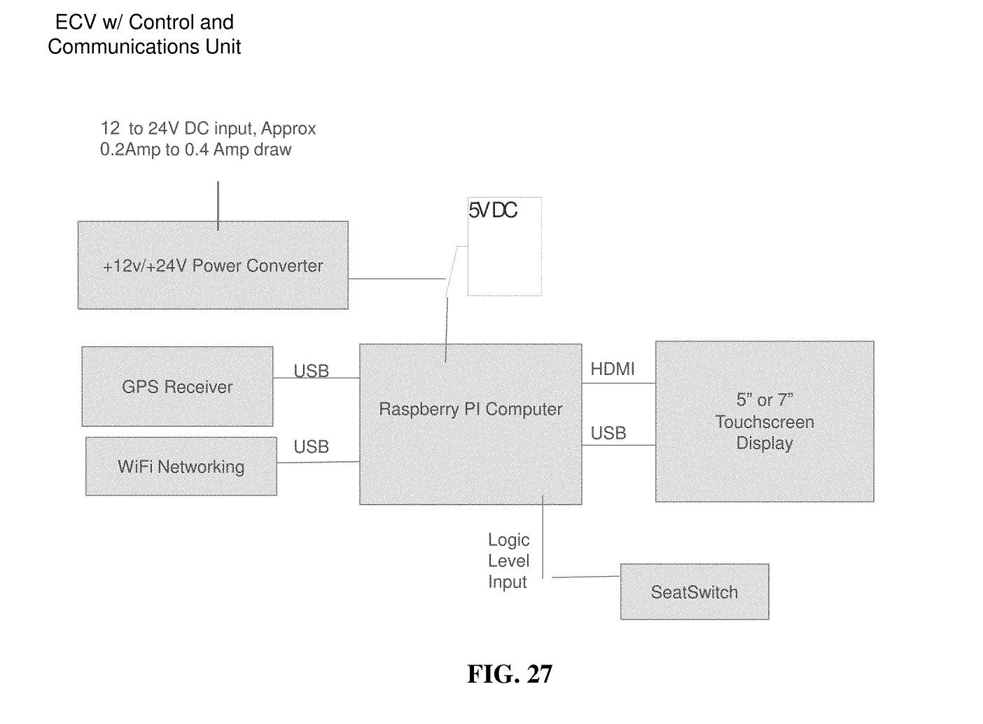

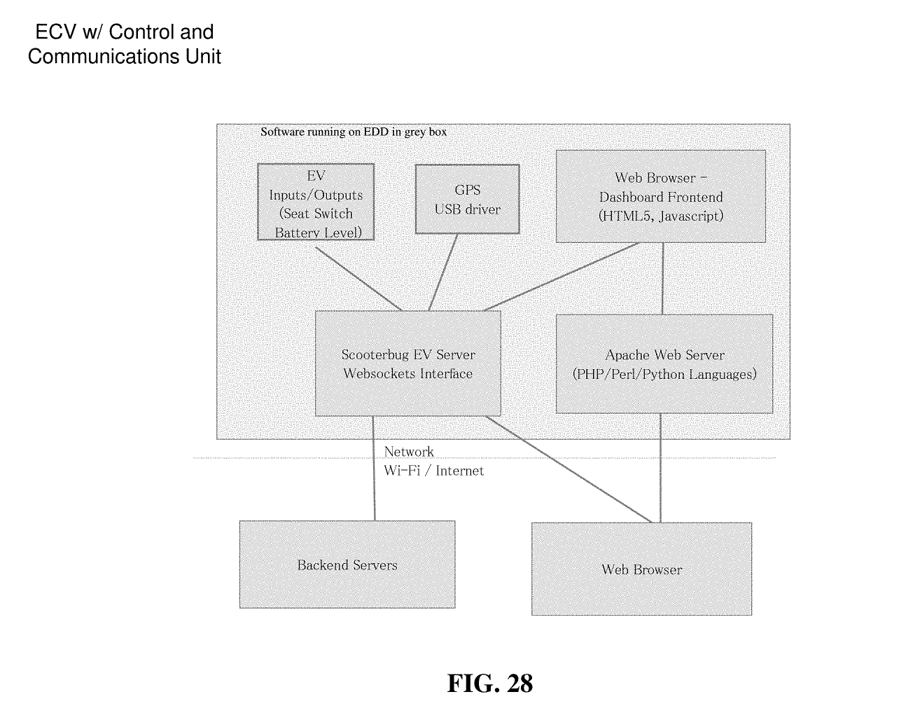

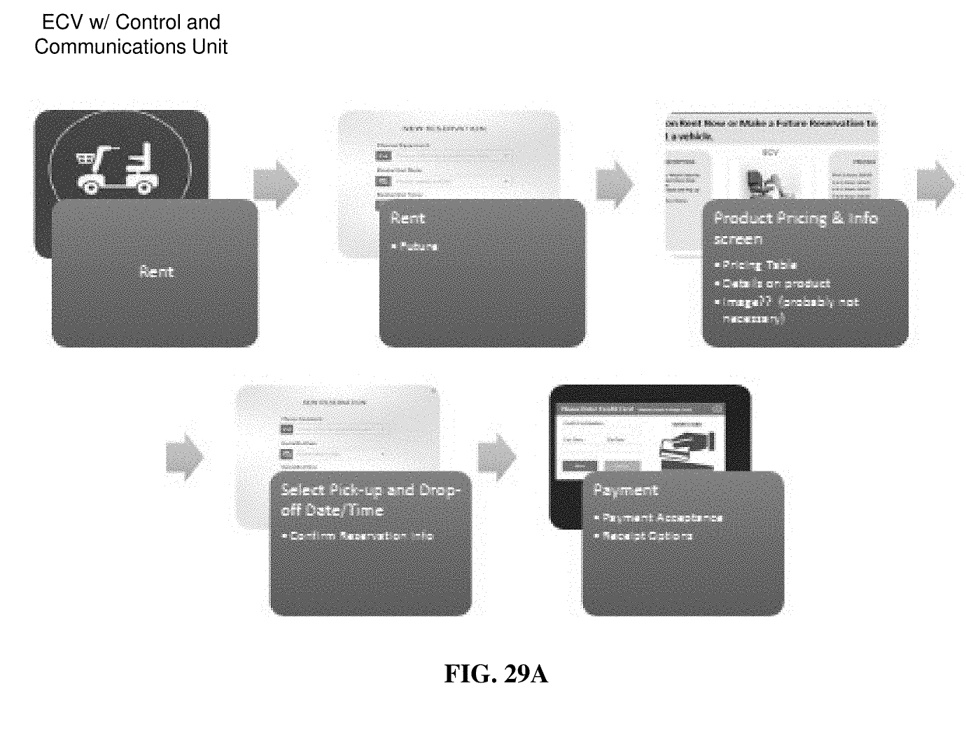

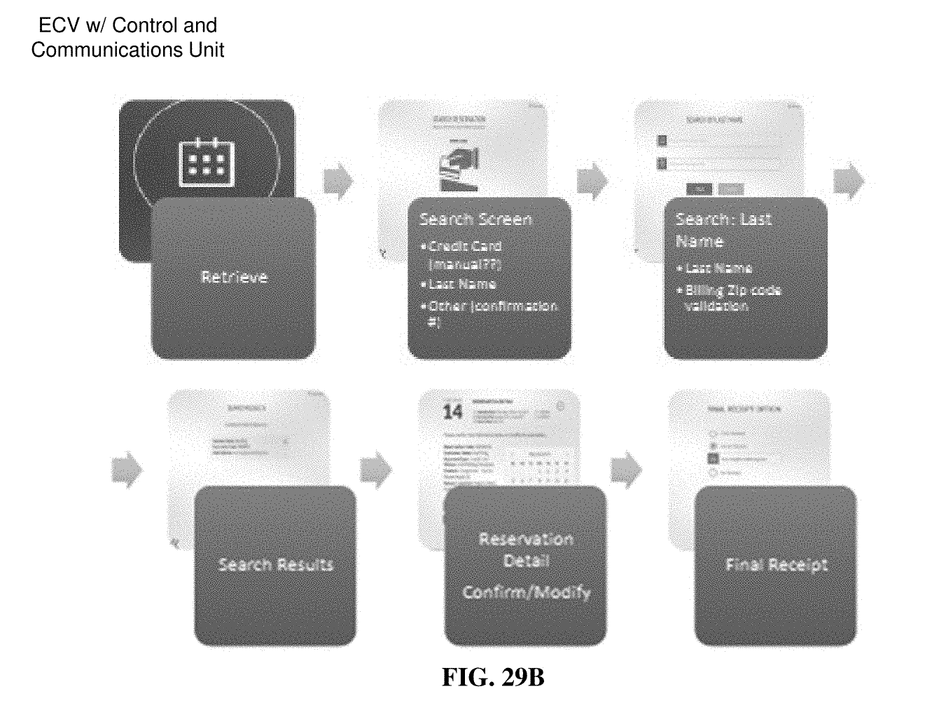

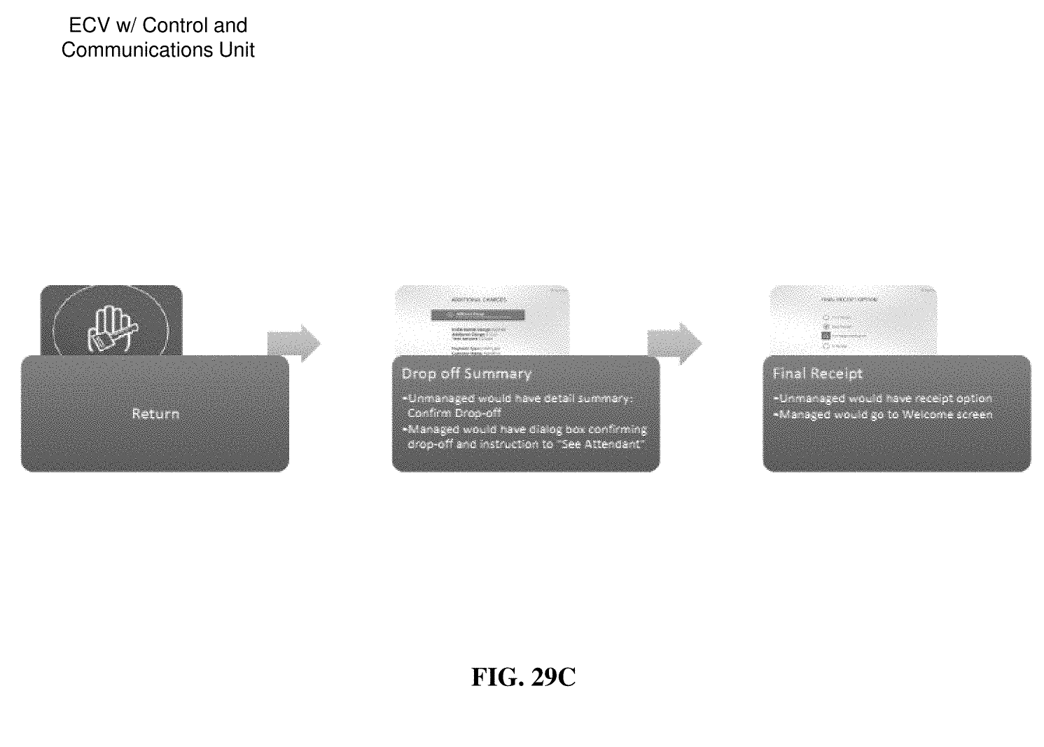

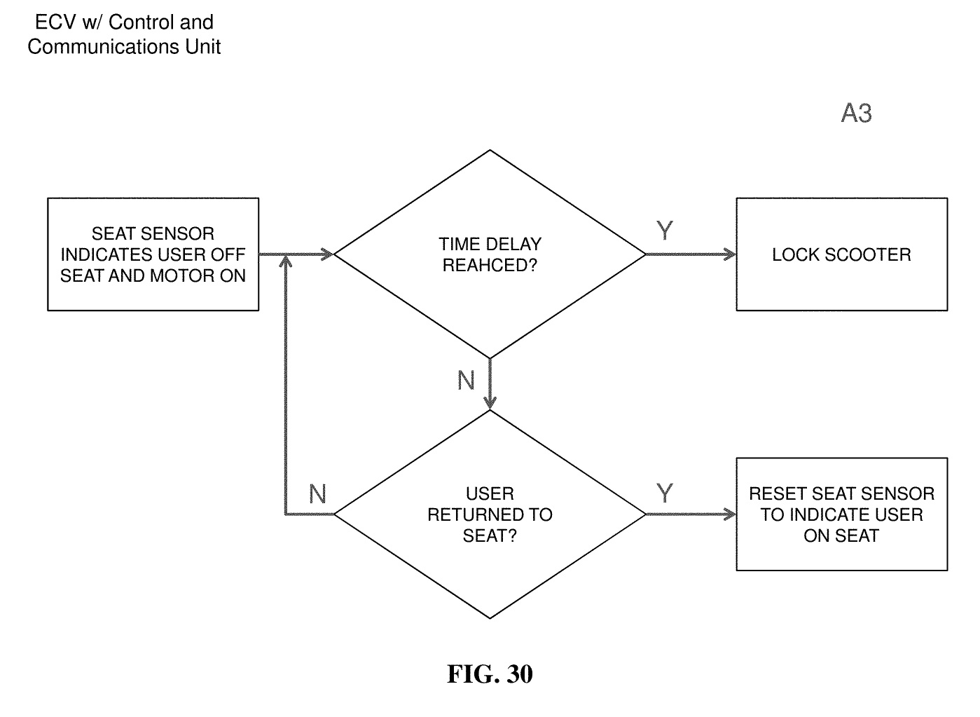

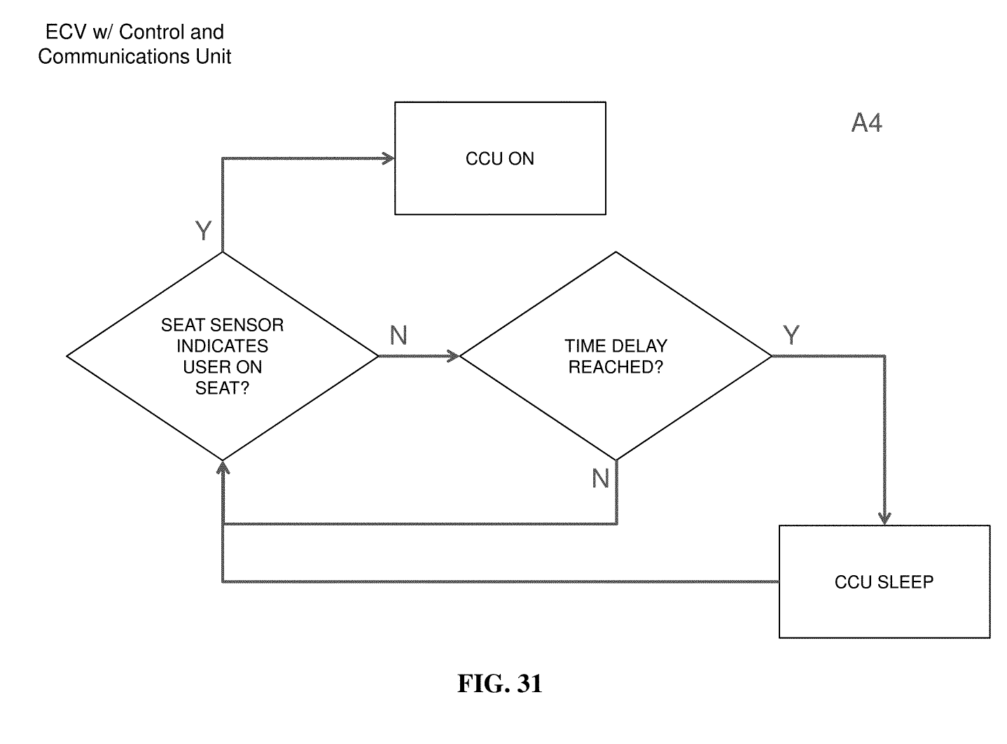

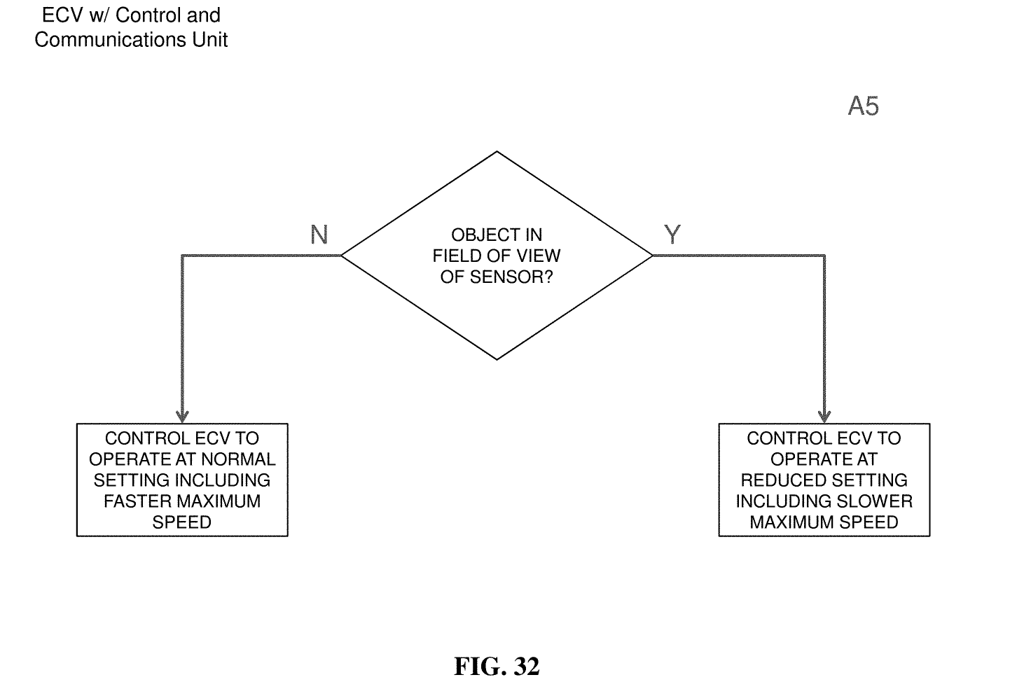

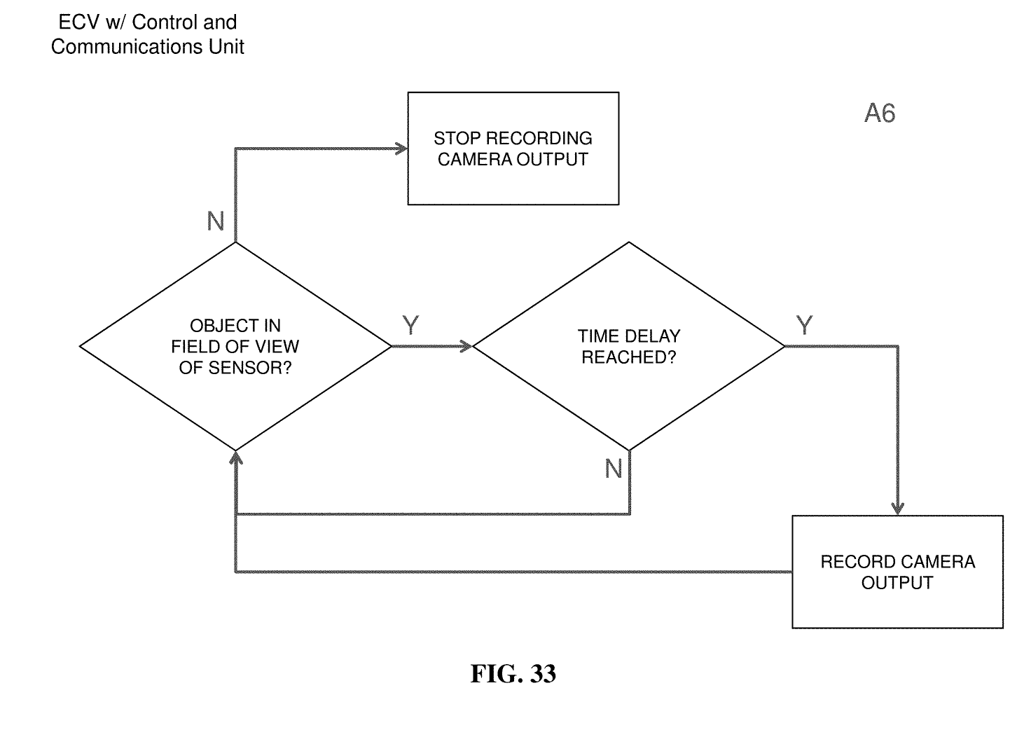

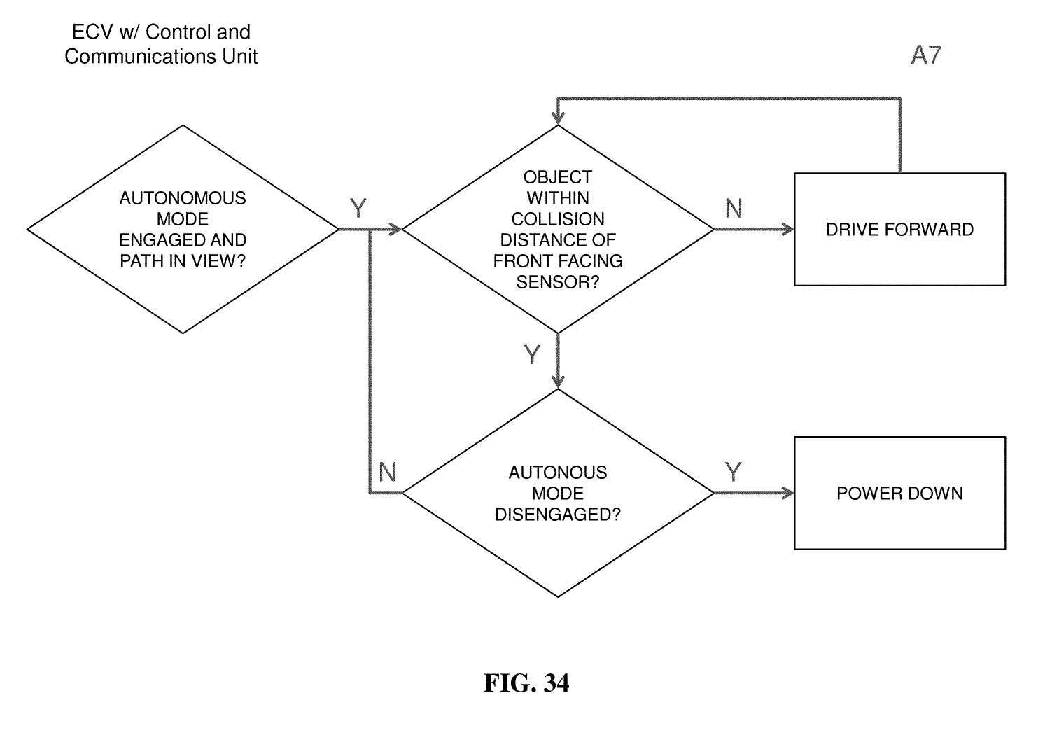

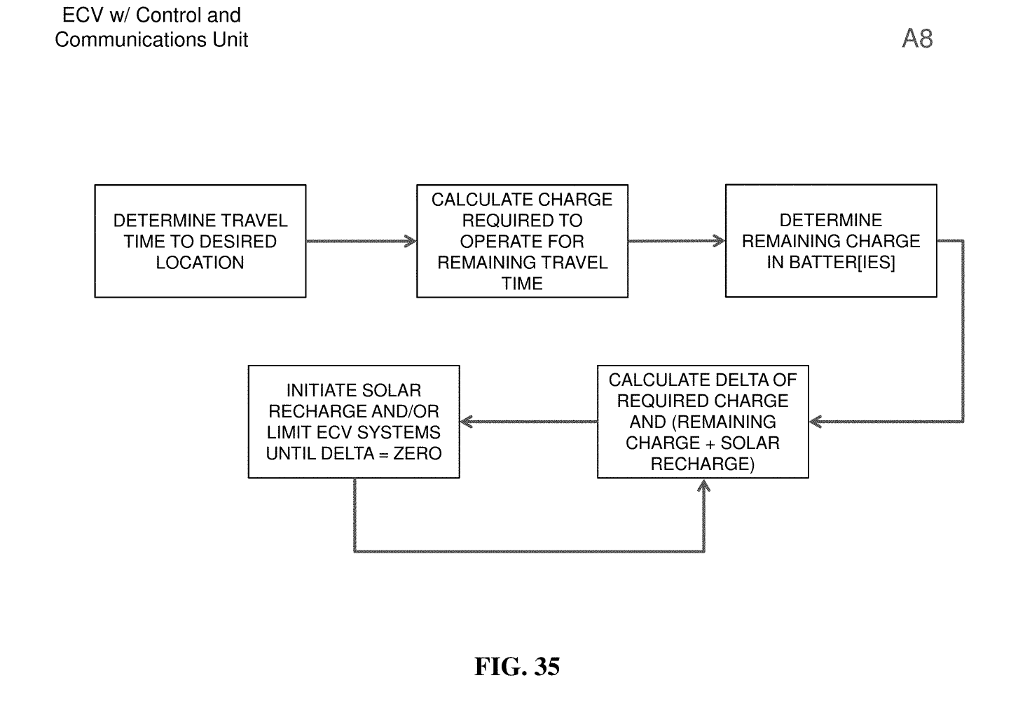

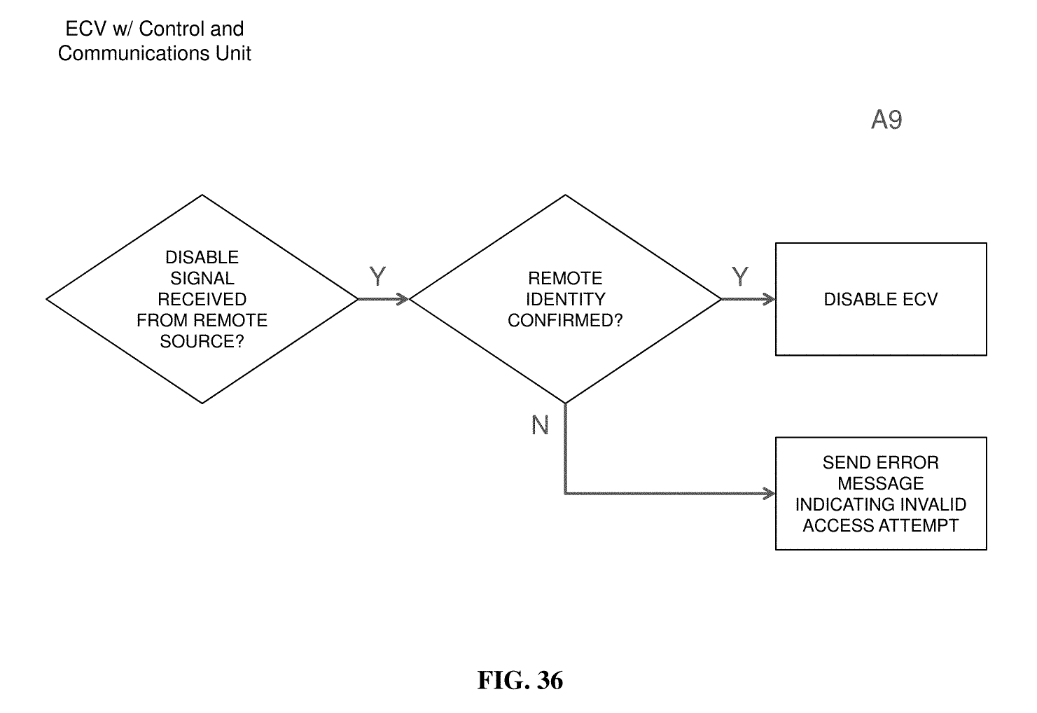

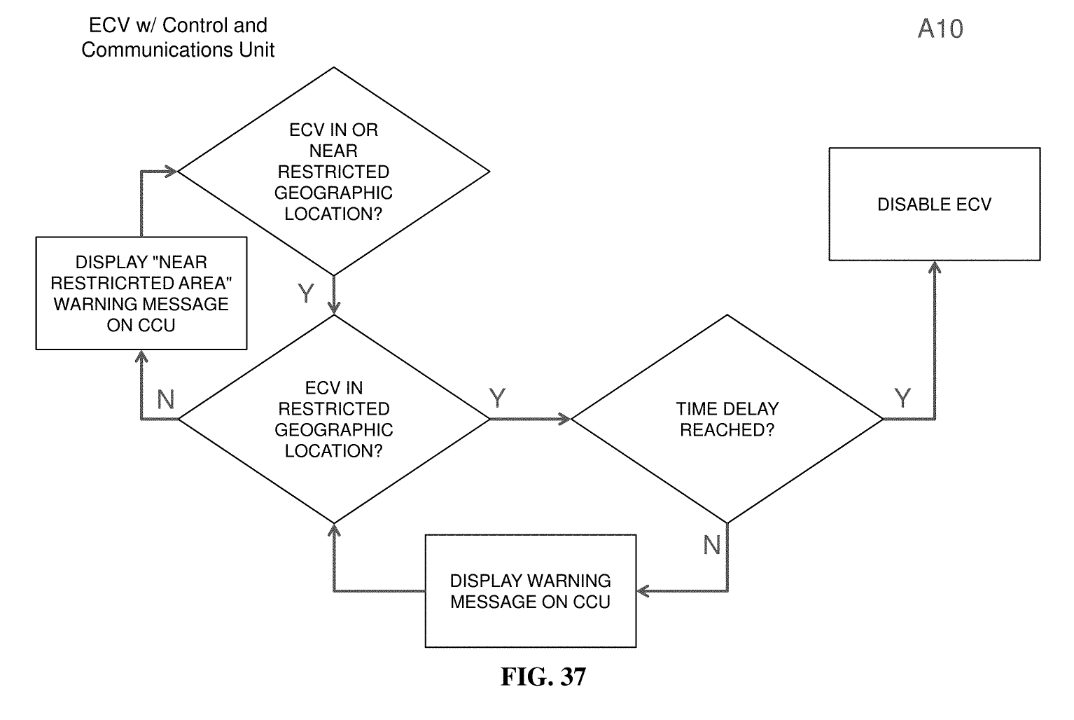

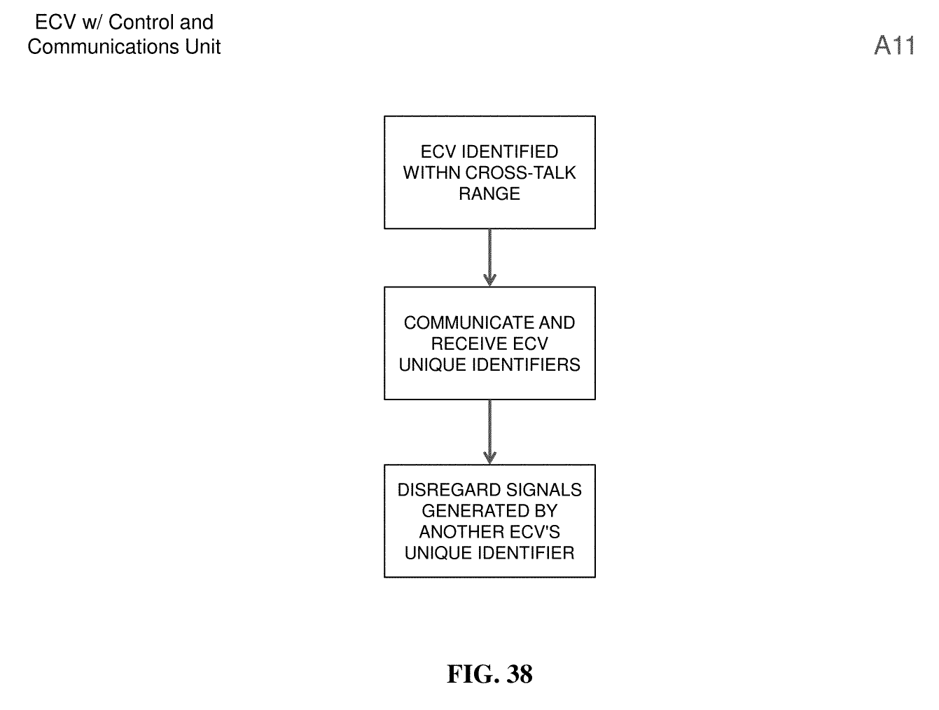

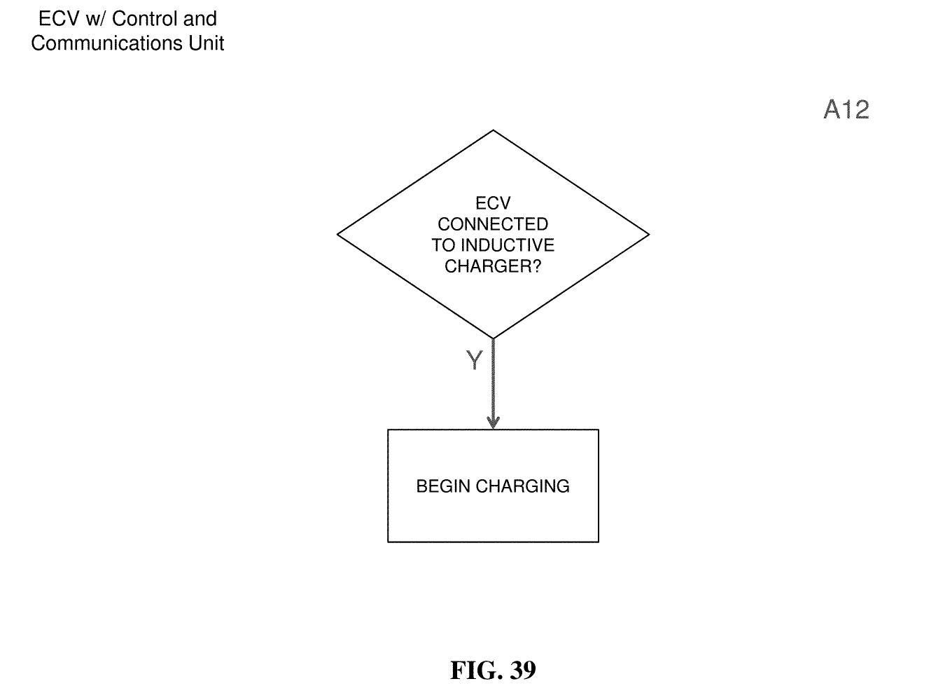

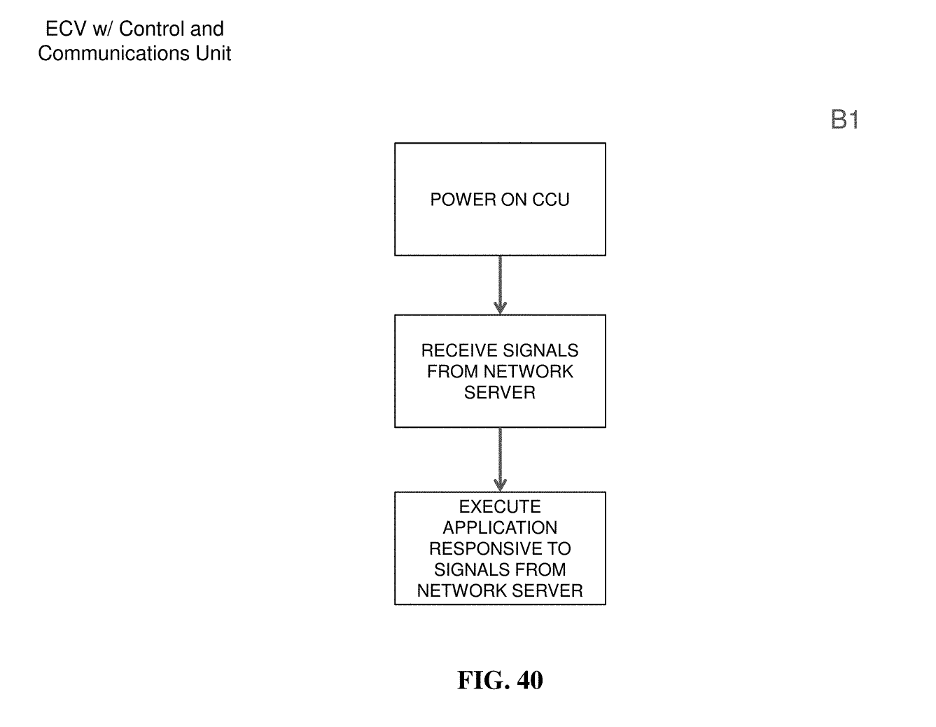

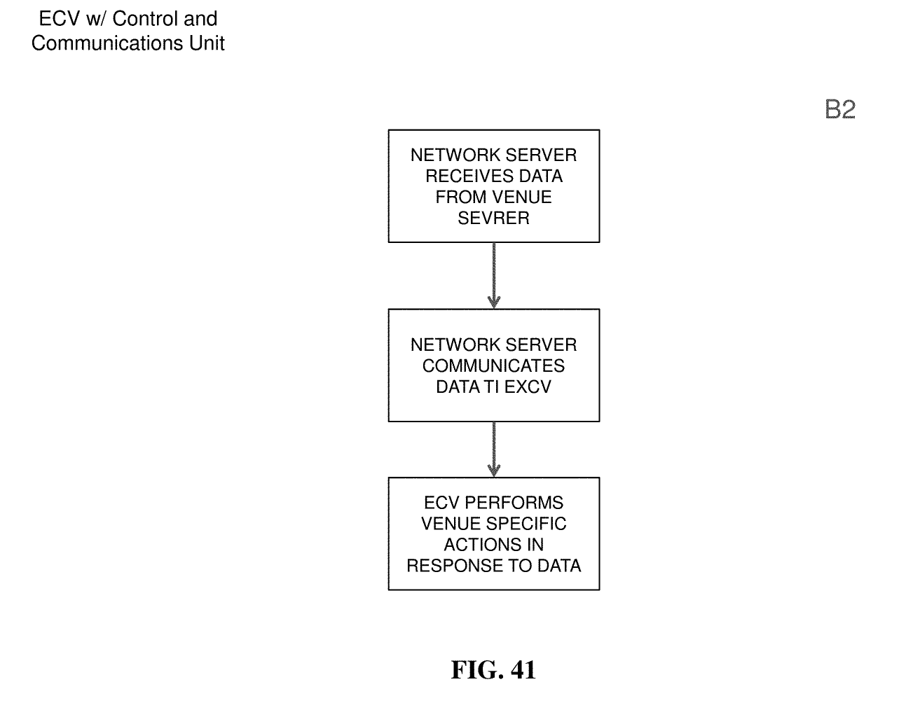

At the initial startup of the EDD, as the user interface loads, the ScooterBug™ branding appears on the screen. See FIG. 26A.

Welcome Screen Navigation

The Welcome screen introduces the ECV or the mobility scooter entitled, the Electronic Digital Dashboard (EDD), and displays features to Rent or Return and to Run Vehicle. See FIG. 26B.
Rent or Return button: ∘ Retrieve a Reservation
Rent the ECV Equipment Now
Run Vehicle button: ∘ Used for managed venues where rental and payment is completed before using the ECV
Enter a 4-digit keycode to: □□ Unlock.
Operate.

Reservation Management System (RMS) Main Menu

When an Administrator or a user selects the Rent or Return button, the RMS Main Menu appears as illustrated in FIG. 26C to rent, retrieve or return a vehicle:
Rent button: ∘ Make a Reservation (NOTE: This may be grayed out.)
Rent Mobility Equipment
Enter a 4-digit keycode to: □□ Unlock.
   Operate.
Retrieve button: ∘ Pick up a Rental
Enter a 4-digit keycode to: □□ Unlock.
   Operate.
Return button: ∘ Return mobility equipment (NOTE: This may be grayed out.)

In a self-vending, rental environment, the user would press the Rent or Retrieve buttons on the RMS Main Menu screen.

If the user is in a managed environment, once the user pays the Attendant to rent a vehicle, the user will simply press the Run Vehicle button on the RMS Main Menu screen.

When the ECV is not in Operation: Sleep Mode

When the vehicle is not in operation and goes into sleep mode, the screensaver as shown in FIG. 26D will appear until a user touches the screen to enter either the Welcome screen or if the ECV has an active rental underway, a keypad opens to enter the active keycode to operate the vehicle.

Keycode Access to Unlock & Operate the ECV

Once the user selects the Run Vehicle button from the Welcome screen or touches the screensaver (See FIG. 26D.) when in active mode (See FIG. 26B.), the keypad screen appears for the user to unlock and operate the ECV as shown in FIG. 26E, accessible to the EDD system's user interface. Enter a 4-digit keycode to unlock and operate the unit

User will have to establish a 4-digit keycode at initial use of the EDD and then remember it to access and operate it throughout the entire rental period.

Once the user submits their 4-digit keycode, a system notification as displayed in FIG. 26F will appear reminding the user to remember their keycode.

Home Screen (Dashboard)

After the user enters their 4-digit keycode to run and operate the ECV, the Home screen (e.g., Dashboard) displays the user interface of the EDD with its respective icons as shown in FIG. 26G. See each icon on the dashboard closely to identify its correlating feature.

Users may navigate the EDD via the Home or Dashboard, Rent/Return, Wayfinder, Venue, Settings (i.e., user audio/visual preferences, Administrator Maintenance, etc.) or Help buttons. These features, including the date and time (top, left), WiFi and battery indicators (top, right), sensor (center, left), horn (bottom, left) and the “stop” or the Lock Vehicle button (bottom, right), will appear on every screen for easy use and navigation.

Mapping (e.g., Wayfinder) Screen

FIG. 26H showcases the Wayfinder (e.g., Mapping) screen. Users can activate the Wayfinder feature as a guide to and from their desired destinations, points of interest and tour management at their venue location.

The example in this illustration displays the map of a sample theme park.

Rent/Return Screen

The RMS Main Menu above in FIG. 26C features all three—Rent, Retrieve and Return—buttons as active; however, the Retrieve button would only be available to the user to see prior reservations. The user cannot use it during an active, rental session.

Lock Vehicle Button

When the user engages the Lock Vehicle button, the keypad window opens for the user to enter their keycode to lock the vehicle. Before the vehicle locks, a System Notification as illustrated in FIG. 26I appears and asks the user, “Are you sure you want to lock this vehicle?” The user selects Confirm or Cancel.

TABLE 2

| | |
|---|---|
| Single Person | 500 lbs (204 Kgs) |
| Total Weight of the | 225 lbs (102 Kgs), 600 lbs static “proof load” |
| ECV with batteries | without permanent deformation or |
| | component failure |
| Transaxle and DC | 24 V, 3.5 A |
| motor | |
| Output | 400 W |
| Brake | Manual brake/freewheel lever easily |
| | accessible |
| Battery | Gel Cel 30, 35, 40, 45 and 50 amp hour |
| Dual Brake Systen | Parking in slope of 1 in 12 and remains |
| | stationary |
| Brake | Manual brake/freewheel lever easily |
| | accessible |
| Tire | Front and Rear 10″ PU Solid (Width: 3.5″) |
| On-board charger | 5 A - 12 V. Input source can be set to |
| | 120~130 V or 220~240 V |
| external solar charger | 18 v 5 amp |
| | 4 ft/sec to 1.5 ft/sec/sec modulated |
| Acceleration | smoothly by speed control from rest to |
| | maximum speed @ GVW |
| Max Speed in park | 3.2 mph/4.693 ft/sec - (programmable up |
| | to 7 mph) |
| Maximum Stopping | 35″ (90 cm) |
| Distance | |
| | 78″ maximum from outside corner to outside |
| Turning Radius (4 | corner when the vehicle is turned 180 |
| wheel) | degrees. Measurement take at widest points |
| | during turn (current spec is 92″) |

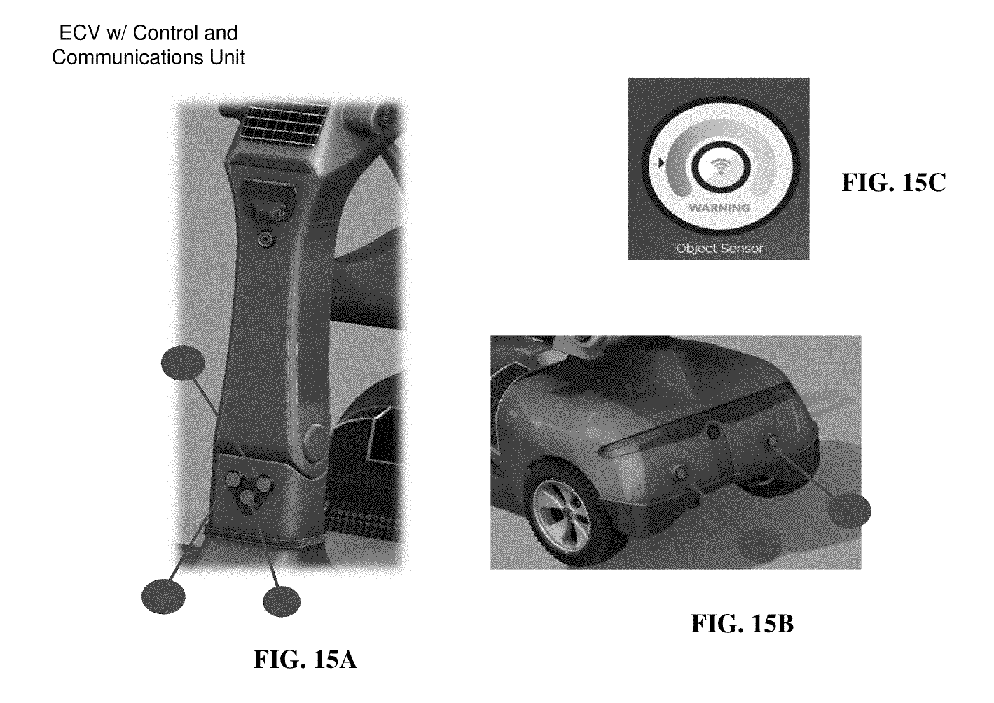

With regards to FIGS. 15A and 15B, A may be sensors described as following “SENSING.”

SENSING:

1) IF A STATIONARY OR MOVING OBJECT IS DETECTED BY THE ULTRASONIC SENSORS, THE DASH INDICATOR ACTIVATES AND THE VEHICLE PERFORMANCE CURVE IS REDUCED UNTIL THE ZONE IS CLEAR.

2) 3 FORWARD FACING SENSORS AND 2 REAR SENSORS

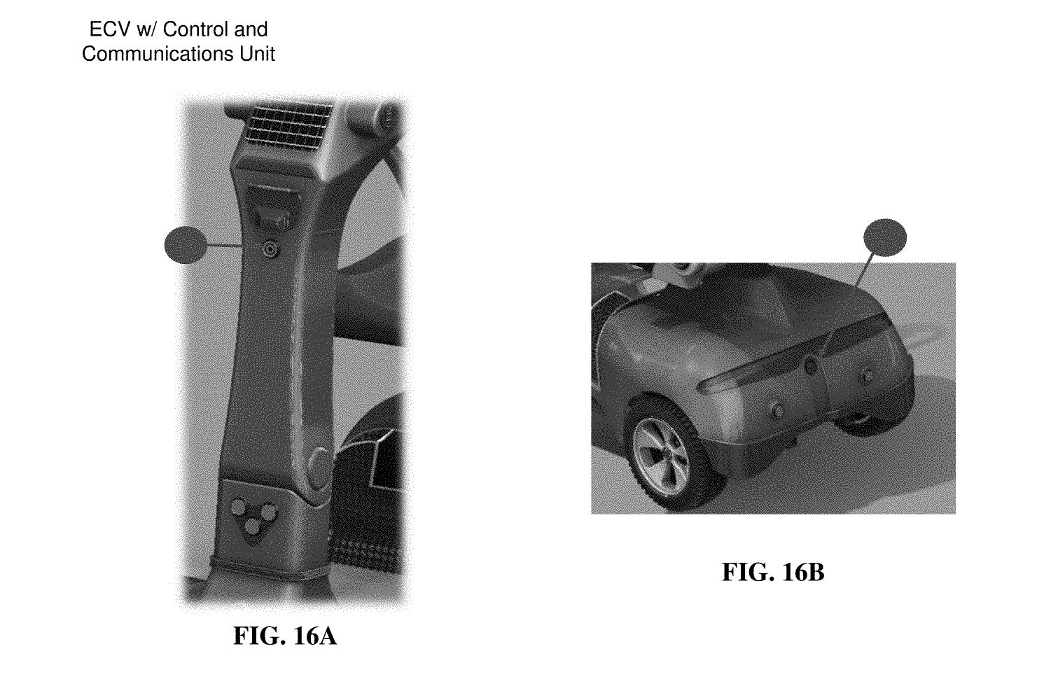

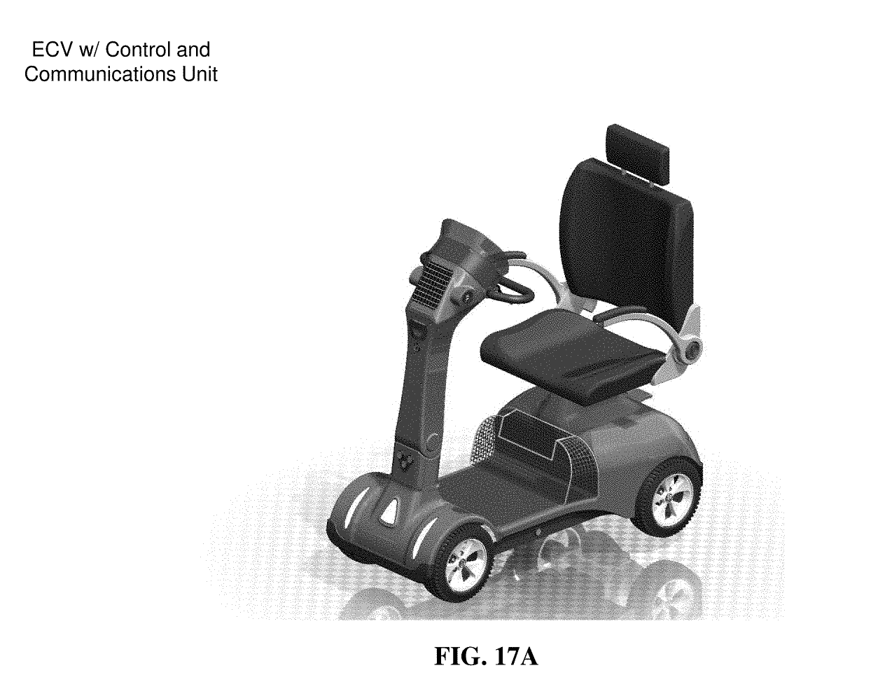

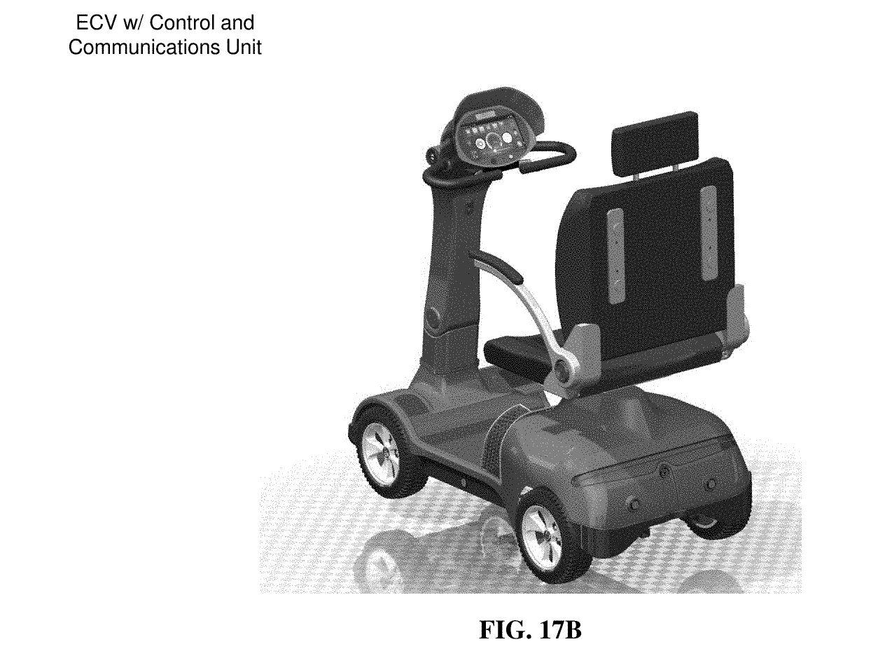

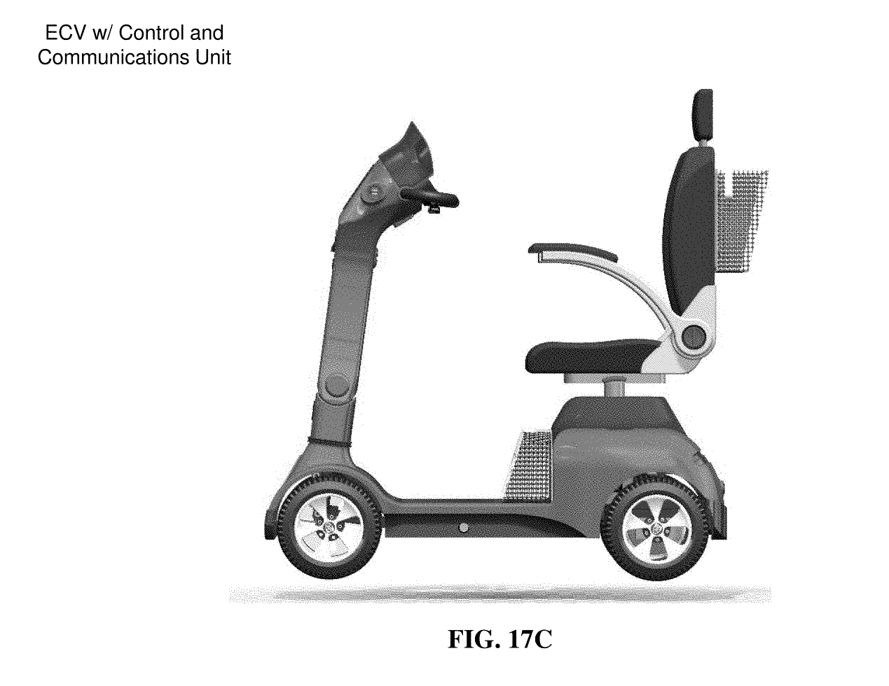

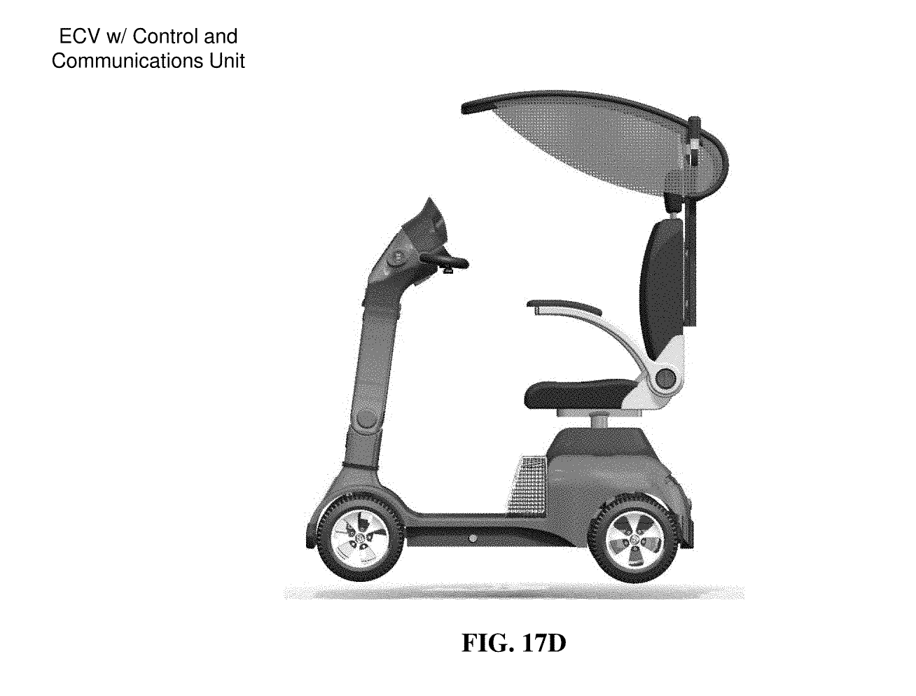

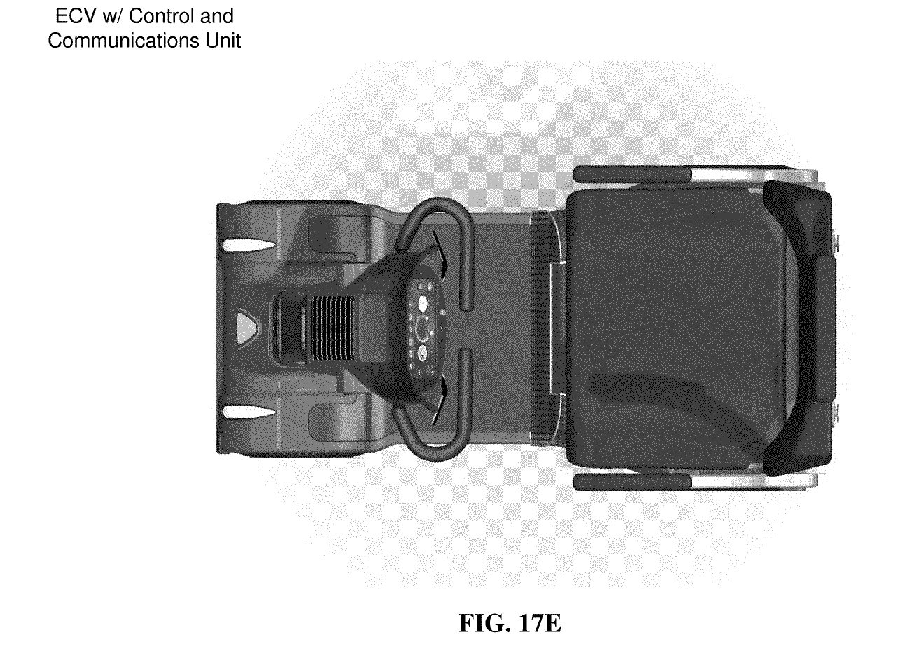

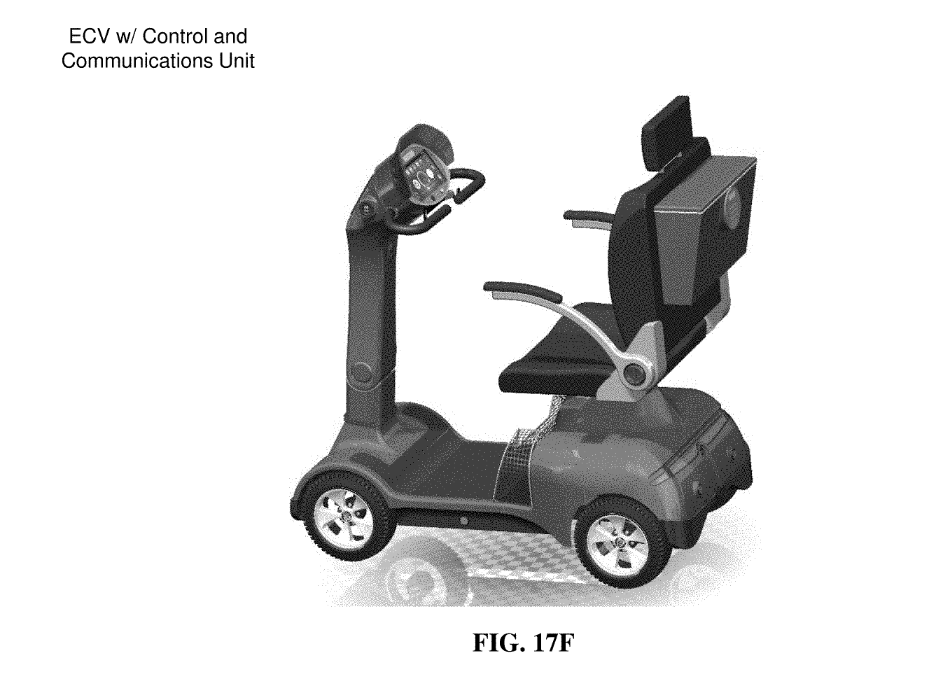

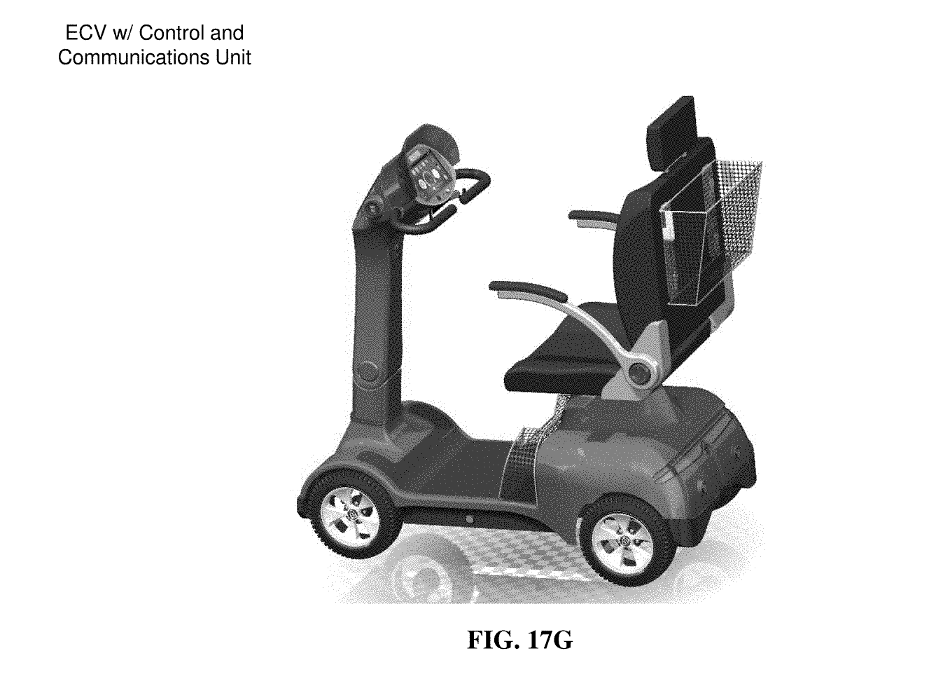

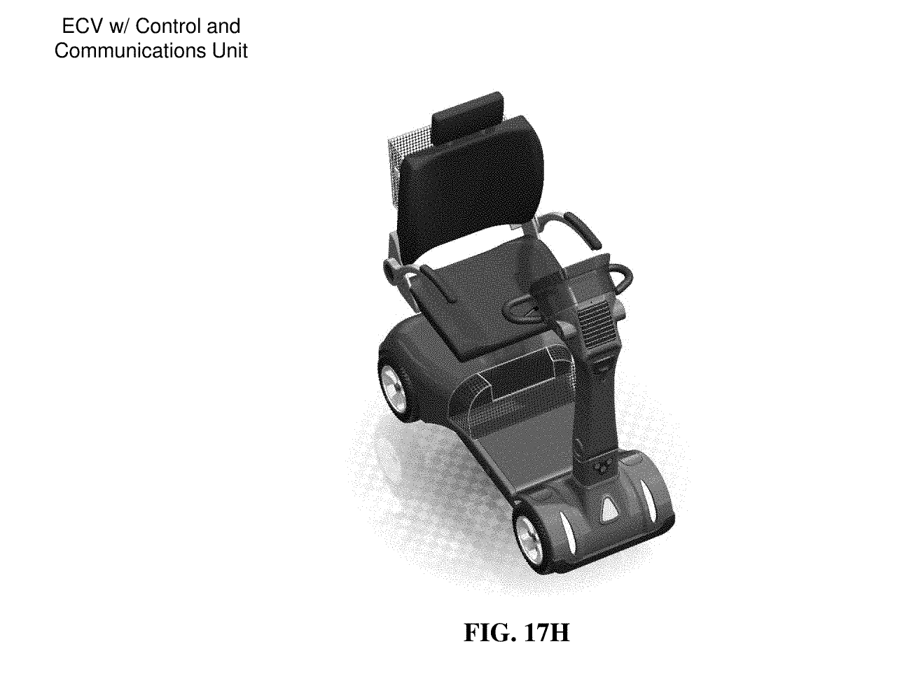

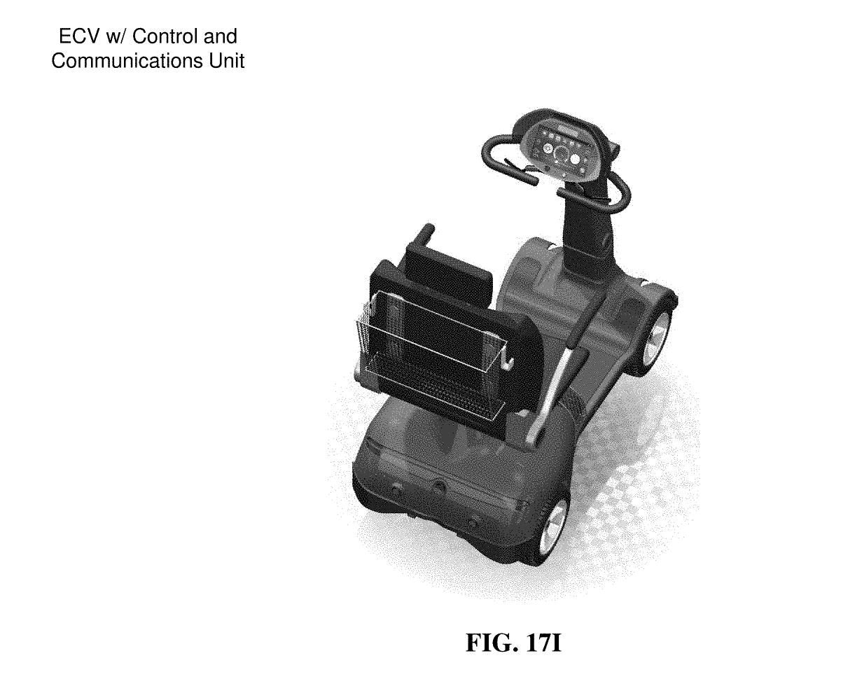

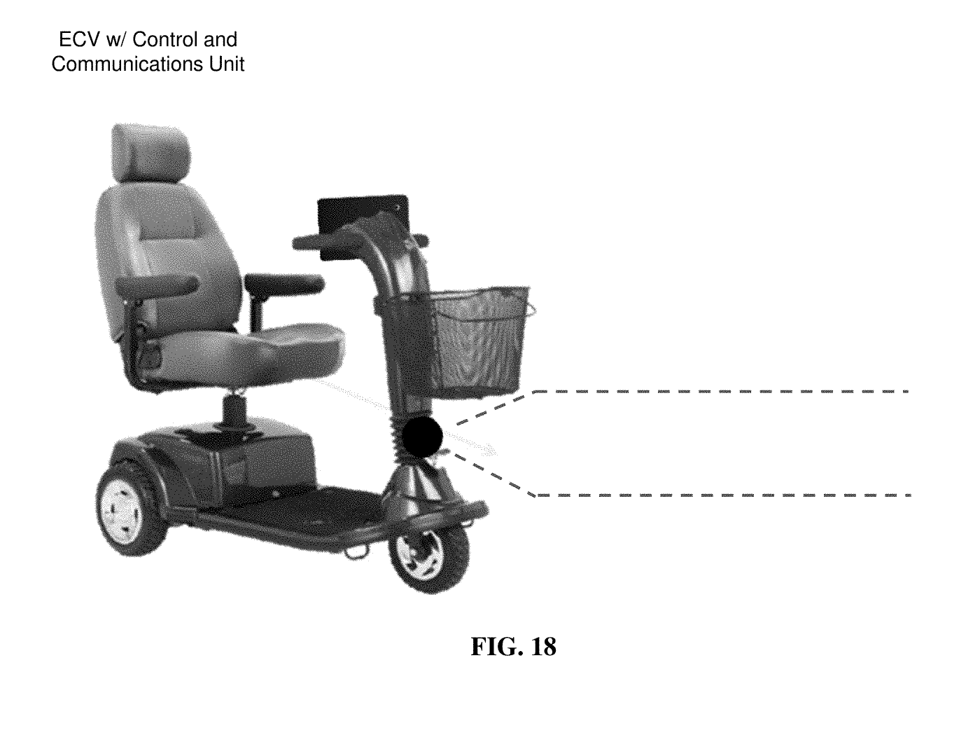

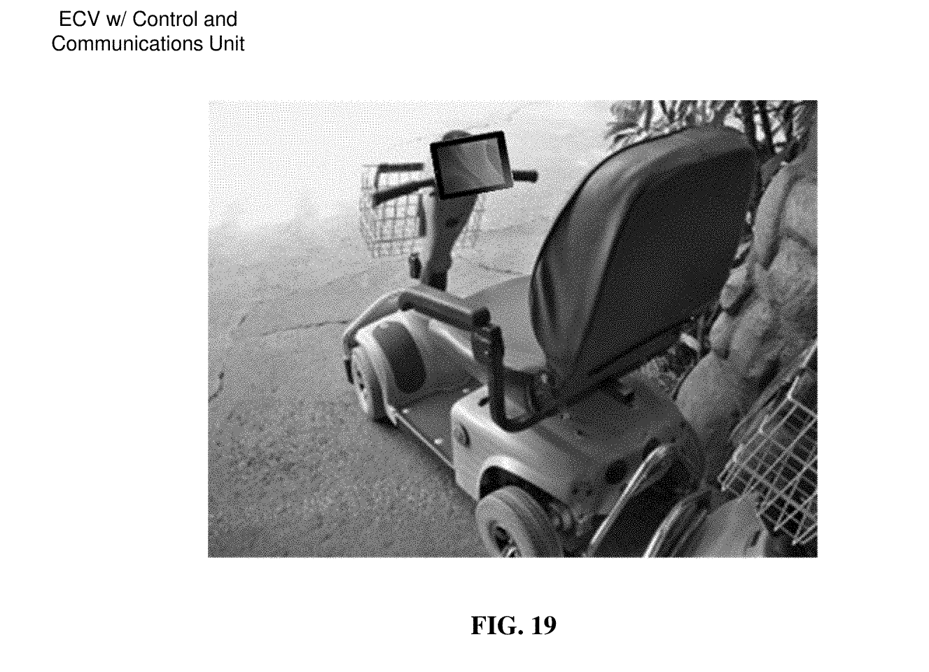

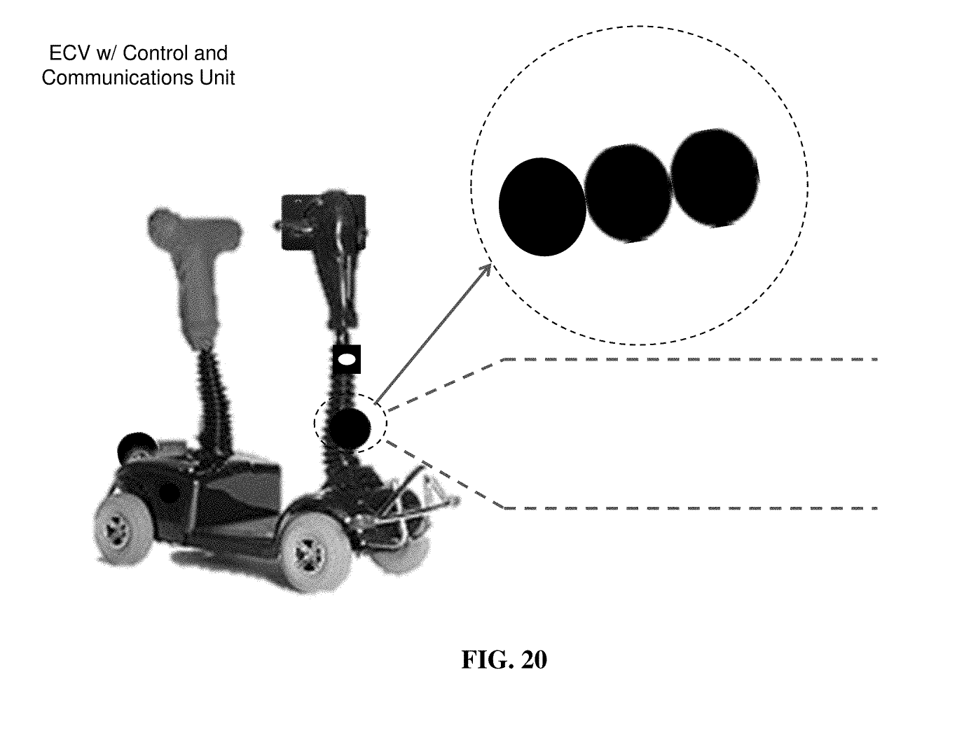

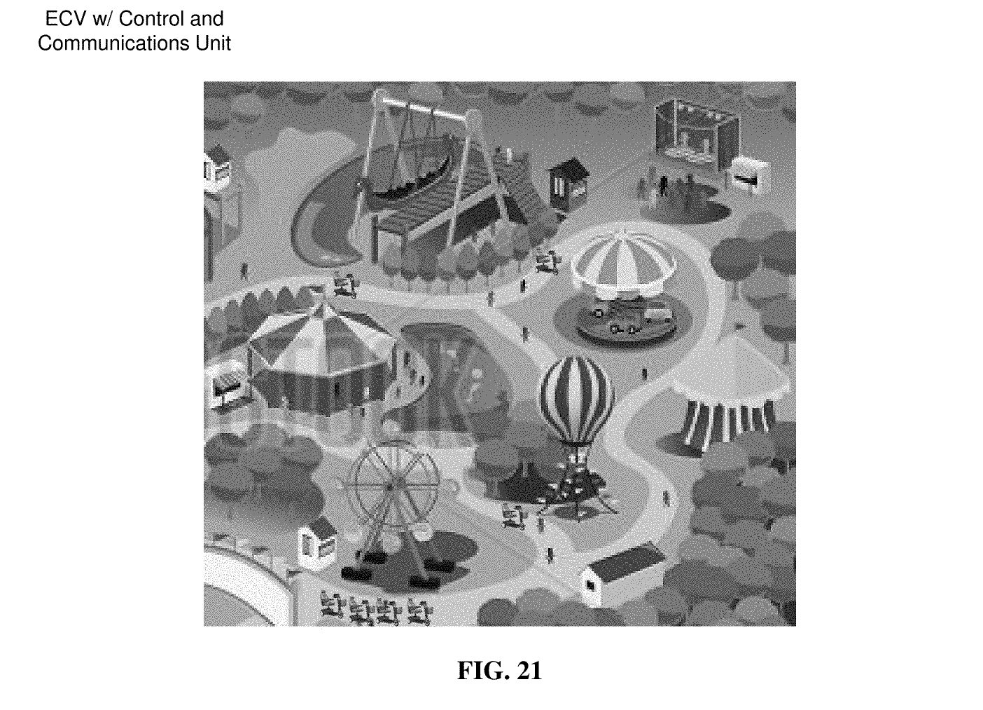

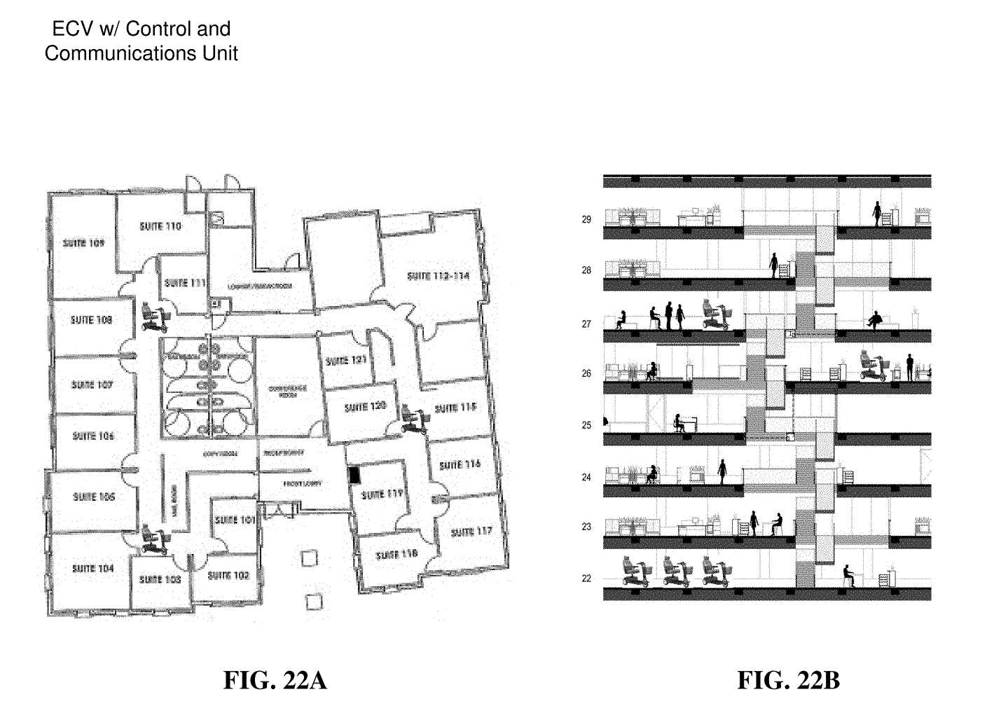

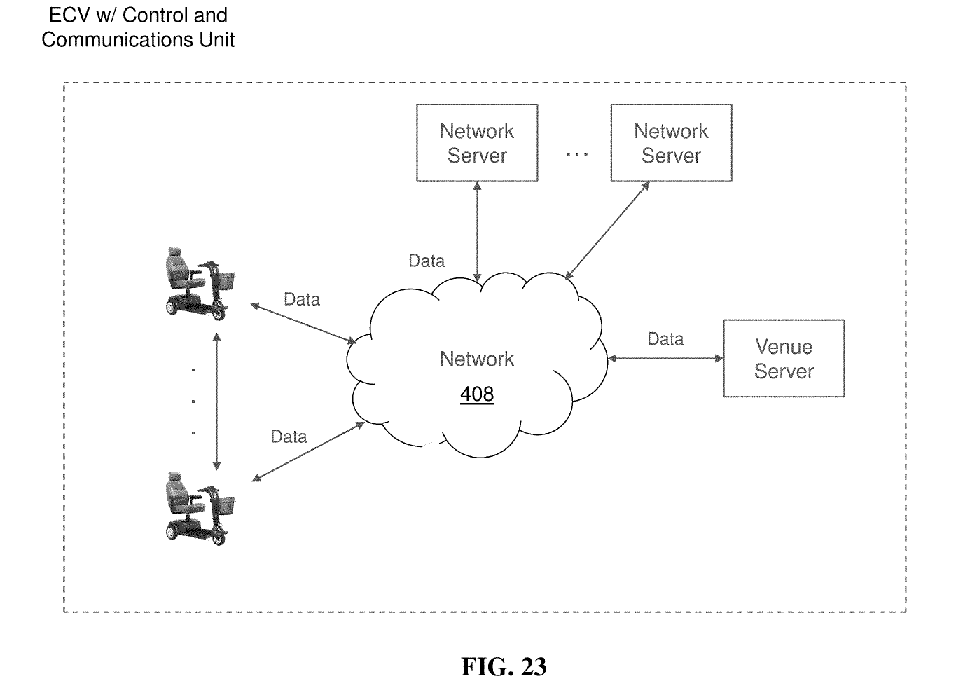

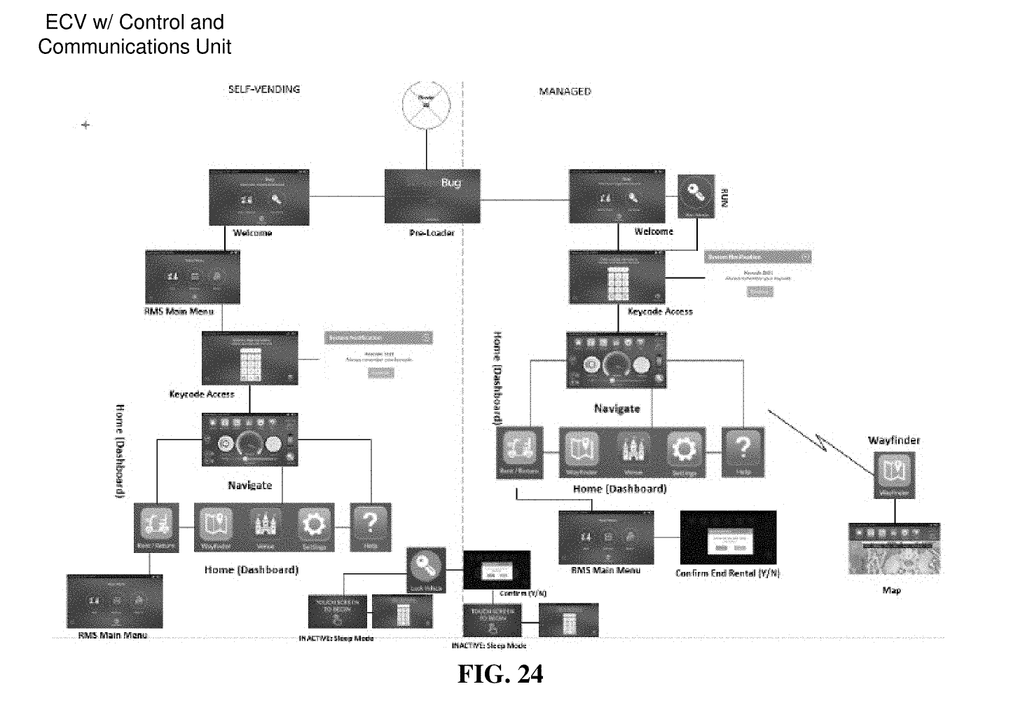

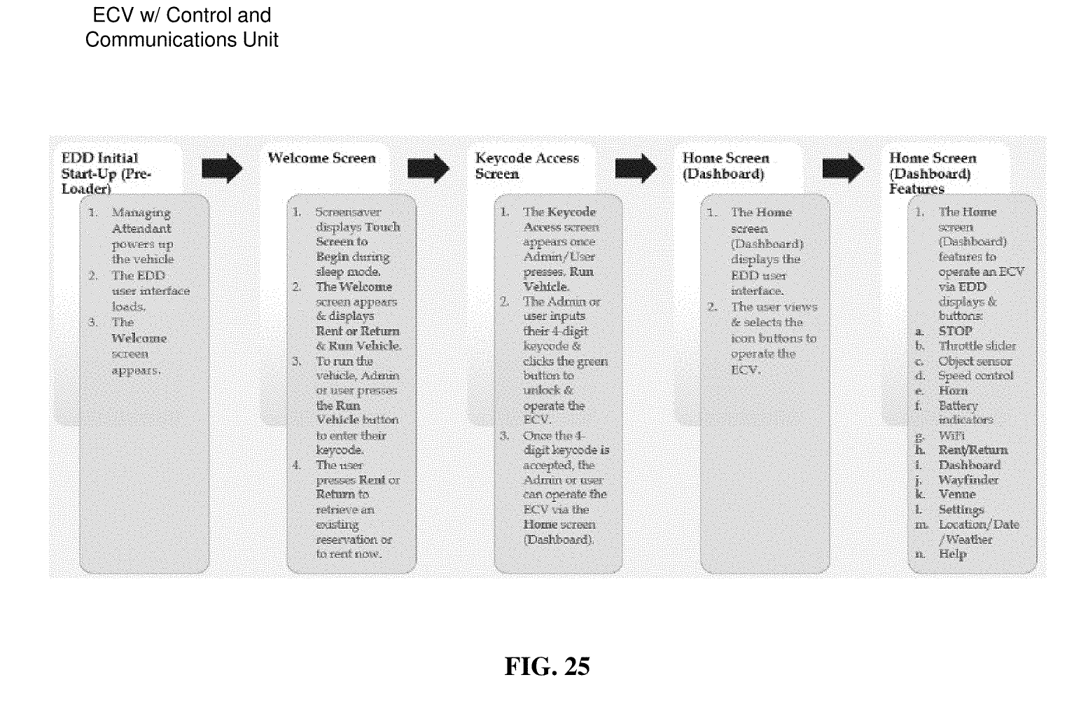

With regards to FIGS. 16A and 16B, B may be cameras described as following “CAMERAS.”

CAMERAS:

1) FRONT TILLER MOUNTED CAMERA IS ACTIVATED WHEN THE SAFE-ZONE IS ACTIVE. LOW-RES VIDEO IS STORED DAILY TO PROVIDE BACKUP VIDEO FOR POTENTIAL ACCIDENT CLAIMS.

2) BACKUP CAMERA ACTIVATES WHEN THE VEHICLE IS IN REVERSE TO AVOID COLLISION WITH LOW UNSEEN OBSTACLES.

The foregoing method descriptions and the process flow diagrams are provided merely as illustrative examples and are not intended to require or imply that the steps of the various embodiments must be performed in the order presented. As will be appreciated by one of skill in the art, the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations may be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed here may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to and/or in communication with another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description here.

When implemented in software, the functions may be stored as one or more instructions or code on a non-transitory computer-readable or processor-readable storage medium. The steps of a method or algorithm disclosed here may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used here, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The previous description is of a preferred embodiment for implementing the invention, and the scope of the invention should not necessarily be limited by this description. The scope of the present invention is instead defined by the following claims.

1. An electronics convenience vehicle (ECV), comprising:
a frame;
a plurality of wheels configured to support and move, the frame;
a seat supported by said frame;
a steering mechanism disposed toward a front portion of the ECV, and configured to enable a user to rotate direction of at least one wheel to control direction of movement of the ECV;
a motor configured to cause at least one wheel to be propelled forward, propelled backward, or to remain in a fixed position;
a throttle, when activated in a first position, causes said motor to propel said at least one wheel in a forward direction, when activated in a second position, causes said motor to propel said at least one wheel in a reverse direction, and when in a third position, causes said motor to maintain said at least one wheel in a fixed position;
at least one sensor directed to detect objects in front of a direction of travel of the ECV, and configured generate sense signals indicative of an object being sensed by said at least one sensor;
a control and communications unit (CCU) disposed in front of said seat, and configured to receive said sense signals and to control operations of said motor, said CCU further configured to communicate over a communications network.

2. The ECV according to claim 1, wherein said CCU includes a processing unit, a non-transitory memory, electronic display configured to display operational and non-operational data of the ECV, and an input/output unit configured to communicate with the communications network, said processing unit configured to execute an ECV control module having a first mode when no objects are detected by said sensors, and a second mode when an object is detected by said sensors as determined by said processing unit based on the object sensed signals.

3. The ECV according to claim 2, wherein the operational data includes speed of the ECV, and wherein non-operational data includes information associated with a venue in which the ECV is operating.

4. The ECV according to claim 3, wherein non-operational data includes venue-centric directional information.

5. The ECV according to claim 4, wherein the venue-centric directional information is arranged as a compass with geographic indicia of the venue positioned thereon to provide navigational guidance to the user.

6. The ECV according to claim 5, further comprising enabling the user to select different levels of geographic information to be displayed.

7. The ECV according to claim 2, wherein the first mode enables set motor to operate at a first maximum speed, and the second mode limits said motor to operate a second, slower maximum speed than the first maximum speed.

8. The ECV according to claim 1, further comprising a tiller attached to said steering mechanism on which said at least one sensor is affixed and oriented to face in front of a front face of said tiller, wherein said tiller is configured to rotate in response to the user rotating said steering mechanism, thereby causing said at least one sensor to rotate along with the front face of said tiller.

9. The ECV according to claim 8, wherein said steering mechanism includes a pair of handlebars connected to said tiller.

10. The ECV according to claim 1, wherein said seat includes a seat sensor that senses when the user is sitting on said seat, and wherein said CCU is further configured to:
sense that the motor is on and the seat sensor senses that the user transitions from sitting on the seat to not sitting on the seat; and
generate a delay to establish a time period during which a determination as to whether the seat sensor senses that the user returns to sitting on the seat within the time period before enabling the motor to turn off.

11. The ECV according to claim 1, wherein said seat includes a sensor that senses when the user is sitting on the seat, and wherein said CCU is an able to enter a sleep mode in response to the sensor not sensing that the user is sitting on the seat, and prevented from entering the sleep mode in response to the seat sensor sensing that the user is sitting on the seat.

12. The ECV according to claim 1, further comprising a camera oriented to face forward of the ECV, and, responsive to said sensors sensing an object within sensing proximity of the sensors, initiate recording of images captured by said camera, and responsive to the object no longer being sensed within the sensor proximity of sensors, initiating stopping recording of images by said camera.

13. The ECV according to claim 1, further comprising a ground-facing sensor configured to sense one or more markings positioned on the ground, and wherein said CCU is configured to cause the ECV to automatically traverse the one or more markings at a predetermined speed.

14. The ECV according to claim 13, wherein said CCU is further configured to determine distance from an object in front of the ECV and cause the ECV to move forward in response to the object moving forward, thereby maintaining a predetermined distance from the object.

15. The ECV according to claim 14, wherein the object is a person.

16. The ECV according to claim 13, wherein the one or more markings includes paint painted on a ground surface.

17. The ECV according to claim 1, further comprising a solar panel configured to generate electricity, and in electrical communication with a backup battery and/or main battery, and said CCU being configured to maintain a charge in the backup battery and/or main battery to maintain a sufficient charge to return the ECV to a return location at a venue.

18. The ECV according to claim 1, wherein said CCU is further configured to stop or disable the ECV in response to receiving a disable signal via a communications network.

19. The ECV according to claim 1, wherein said processing unit is further configured to stop said motor in response to receiving an out-of-bounds message or determining that the ECV is out-of-bounds as defined by a venue for ECVs.

20. The ECV according to claim 19, wherein said processing unit is further configured to generate an indication signal to notify the user that the ECV is close to being out out-of-bounds in response to determining that the ECV is a predetermined distance away from the out-of-bounds that causes said processing unit to stop said motor.

21-50. (canceled)
